(19) United States
(12) Patent Application Publication
(10) Pub. No.: US 2014/0007742 A1
(43) Pub. Date: Jan. 9, 2014

(54) SCREW FASTENING DEVICE AND METHOD OF MANUFACTURING SCREW-FASTENED OBJECT

(71) Applicant: Fuji Xerox Co., Ltd., Tokyo (JP)

(72) Inventor: Osamu TOCHIBORI, Kashiwazaki-shi (JP)

(73) Assignee: FUJI XEROX CO., LTD., Tokyo (JP)

(21) Appl. No.: 13/890,665

(22) Filed: May 9, 2013

(30) Foreign Application Priority Data
Jul. 3, 2012 (JP) 2012-149615

(51) Int. Cl. B25B 23/04; B23P 19/00

(52) U.S. Cl. CPC B25B 23/04; B23P 19/006
USPC 81/57.37; 29/525.02

(57) ABSTRACT

A screw fastening device includes: a supply target member which extends in one direction and to which male screws are to be supplied; a first magnet that positions the male screw supplied to the supply target member by a magnetic force so that the male screw extends in the one direction and makes a head portion of the male screw face one side; a holding member that is movable relative to the supply target member in the one direction, includes a second magnet as defined herein, and holds the male screw as defined herein; and an applying member that applies torque to the male screw held by the holding member.

### CROSS-REFERENCE TO RELATED APPLICATIONS

This application is based on and claims priority under 35 USC 119 from Japanese Patent Application No. 2012-149615 filed on Jul. 3, 2012.

### BACKGROUND

### Technical Field

The present invention relates to a screw fastening device and a method of manufacturing a screw-fastened object.

### SUMMARY

According to an aspect of the invention, there is provided a screw fastening device including: a supply target member which extends in one direction and to which male screws are to be supplied; a first magnet that positions the male screw supplied to the supply target member by a magnetic force so that the male screw extends in the one direction and makes a head portion of the male screw face one side; a holding member that is movable relative to the supply target member in the one direction, includes a second magnet applying a magnetic force, which is larger than a magnetic force of the first magnet, to the male screw that is supplied to the supply target member and disposed so as to extend in the one direction when the holding member moves relative to the supply target member in the one direction so as to be close to the male screw, and holds the male screw by coming into contact with the head portion of the male screw, which is attracted by the magnetic force of the second magnet, while moving relative to the supply target member; and an applying member that applies torque to the male screw held by the holding member.

### BRIEF DESCRIPTION OF THE DRAWINGS

FIG. 1 is an enlarged perspective view of a screw fastening device according to a first exemplary embodiment of the invention.

FIG. 2 is an enlarged perspective view of the screw fastening device according to the first exemplary embodiment of the invention.

FIG. 3 is a perspective view of the screw fastening device according to the first exemplary embodiment of the invention.

FIG. 4 is an enlarged perspective view of the screw fastening device according to the first exemplary embodiment of the invention.

FIG. 5 is a perspective view of the screw fastening device according to the first exemplary embodiment of the invention.

FIG. 6 is an enlarged perspective view of the screw fastening device according to the first exemplary embodiment of the invention.

FIG. 7 is a perspective view of the screw fastening device according to the first exemplary embodiment of the invention.

FIG. 8 is an enlarged perspective view of the screw fastening device according to the first exemplary embodiment of the invention.

FIG. 9 is a perspective view of the screw fastening device according to the first exemplary embodiment of the invention.

FIG. 10 is an enlarged perspective view of the screw fastening device according to the first exemplary embodiment of the invention.

FIG. 11 is a perspective view of the screw fastening device according to the first exemplary embodiment of the invention.

FIG. 12 is a cross-sectional view of a supply target member of the screw fastening device according to the first exemplary embodiment of the invention.

FIGS. 13A and 13B are cross-sectional views of a guide member of the screw fastening device according to the first exemplary embodiment of the invention.

FIG. 14 is a cross-sectional view showing the vicinity of the supply target member of the screw fastening device according to the first exemplary embodiment of the invention.

FIG. 15 is a cross-sectional view showing the vicinity of the supply target member of the screw fastening device according to the first exemplary embodiment of the invention.

FIG. 16 is a cross-sectional view showing the vicinity of the supply target member of the screw fastening device according to the first exemplary embodiment of the invention.

FIG. 17 is a cross-sectional view showing the vicinity of the supply target member of the screw fastening device according to the first exemplary embodiment of the invention and a screw-fastened object.

FIG. 18 is a perspective view of the screw fastening device according to the first exemplary embodiment of the invention and a screw supply device.

FIG. 19 is an enlarged perspective view of a screw fastening device according to a second exemplary embodiment of the invention.

FIG. 20 is an enlarged perspective view of the screw fastening device according to the second exemplary embodiment of the invention.

FIG. 21 is a cross-sectional view showing the vicinity of a supply unit of the screw fastening device according to the second exemplary embodiment of the invention.

FIG. 22 is a cross-sectional view showing the vicinity of the supply unit of the screw fastening device according to the second exemplary embodiment of the invention.

FIG. 23 is a cross-sectional view showing the vicinity of the supply unit of the screw fastening device according to the second exemplary embodiment of the invention.

FIG. 24 is a cross-sectional view showing the vicinity of the supply unit of the screw fastening device according to the second exemplary embodiment of the invention.

FIG. 25 is a cross-sectional view showing the vicinity of the supply unit of the screw fastening device according to the second exemplary embodiment of the invention.

FIG. 26 is a cross-sectional view showing the vicinity of the supply unit of the screw fastening device according to the second exemplary embodiment of the invention.

FIG. 27 is a cross-sectional view showing the vicinity of the supply unit of the screw fastening device according to the second exemplary embodiment of the invention.

FIG. 28 is an enlarged perspective view of the screw fastening device according to the second exemplary embodiment of the invention.

FIG. 29 is an enlarged perspective view of the screw fastening device according to the second exemplary embodiment of the invention.

FIG. 30 is an enlarged perspective view of the screw fastening device according to the second exemplary embodiment of the invention.

FIG. 31 is a side view showing the vicinity of a mounting unit of the screw fastening device according to the second exemplary embodiment of the invention.

FIG. 32 is a side view showing the vicinity of the mounting unit of the screw fastening device according to the second exemplary embodiment of the invention.

FIG. 33 is a perspective view of the screw fastening device according to the second exemplary embodiment of the invention.

FIG. 34 is an enlarged perspective view of the screw fastening device according to the second exemplary embodiment of the invention and a screw supply device.

FIG. 35 is a cross-sectional view showing the vicinity of a supply unit of a screw fastening device according to a third exemplary embodiment of the invention.

FIG. 36 is a cross-sectional view showing the vicinity of the supply unit of the screw fastening device according to the third exemplary embodiment of the invention.

FIG. 37 is a cross-sectional view showing the vicinity of the supply unit of the screw fastening device according to the third exemplary embodiment of the invention.

FIG. 38 is a cross-sectional view showing the vicinity of the supply unit of the screw fastening device according to the third exemplary embodiment of the invention.

FIG. 39 is a cross-sectional view showing the vicinity of the supply unit of the screw fastening device according to the third exemplary embodiment of the invention.

FIG. 40 is a perspective view of the screw fastening device according to the third exemplary embodiment of the invention.

FIG. 41 is a perspective view of the screw fastening device according to the third exemplary embodiment of the invention.

FIG. 42 is a perspective view of the screw fastening device according to the third exemplary embodiment of the invention.

FIG. 43 is a perspective view of the screw fastening device according to the third exemplary embodiment of the invention.

FIG. 44 is a perspective view of the screw fastening device according to the third exemplary embodiment of the invention.

FIG. 45 is a cross-sectional view of an operating unit of the screw fastening device according to the third exemplary embodiment of the invention.

FIGS. 46A and 46B are cross-sectional views of the operating unit of the screw fastening device according to the third exemplary embodiment of the invention.

FIGS. 47A and 47B are cross-sectional views of the operating unit of the screw fastening device according to the third exemplary embodiment of the invention.

FIGS. 48A, 48B and 48C are cross-sectional views of the supply target member of the screw fastening device according to the first exemplary embodiment of the invention and a supply target member of a screw fastening device according to a modification of the first exemplary embodiment.

FIG. 49 is a perspective view of a screw fastening device according to a fourth exemplary embodiment of the invention.

FIG. 50 is an enlarged perspective view of the screw fastening device according to the fourth exemplary embodiment of the invention.

FIG. 51 is an enlarged perspective view of the screw fastening device according to the fourth exemplary embodiment of the invention.

FIG. 52 is an enlarged perspective view of the screw fastening device according to the fourth exemplary embodiment of the invention.

FIG. 53 is an enlarged perspective view of the screw fastening device according to the fourth exemplary embodiment of the invention.

FIG. 54 is an enlarged perspective view of the screw fastening device according to the fourth exemplary embodiment of the invention.

FIG. 55 is an enlarged perspective view of the screw fastening device according to the fourth exemplary embodiment of the invention.

FIG. 56 is an enlarged perspective view of the screw fastening device according to the fourth exemplary embodiment of the invention.

FIG. 57 is an enlarged perspective view of the screw fastening device according to the fourth exemplary embodiment of the invention.

FIG. 58 is an enlarged perspective view of the screw fastening device according to the fourth exemplary embodiment of the invention.

FIG. 59 is an enlarged perspective view of the screw fastening device according to the fourth exemplary embodiment of the invention.

FIG. 60 is an enlarged perspective view of the screw fastening device according to the fourth exemplary embodiment of the invention.

FIG. 61 is an enlarged perspective view of the screw fastening device according to the fourth exemplary embodiment of the invention.

FIG. 62 is a perspective view of a screw fastening device according to a fifth exemplary embodiment of the invention.

FIG. 63 is a perspective view of the screw fastening device according to the fifth exemplary embodiment of the invention.

FIG. 64 is a perspective view of the screw fastening device according to the fifth exemplary embodiment of the invention.

FIG. 65 is a perspective view of the screw fastening device according to the fifth exemplary embodiment of the invention.

FIG. 66 is a cross-sectional view of a modification of the screw fastening device according to the fifth exemplary embodiment of the invention.

### DESCRIPTION OF REFERENCE NUMERALS AND SIGNS

10: screw fastening device
20: grip (an example of grip portion)
26: bit guide (an example of holding member)
28: bit (an example of applying member)
34: magnet (an example of second magnet)
36: first member
38: second member
38A: through hole
48: supply target member
48A: base portion (an example of wall portion)
56: receiving portion
58: magnet (an example of first magnet)
60: guide member
60C: guide passage
66: moving member
100: screw fastening device
126: supply target member
126C: receiving portion
126D: wall portion
132C: moving member
136: magnet (an example of first magnet)
140: guide member
184: first member
186: second member
186A: through hole
200: screw fastening device
206: bit guide (an example of holding member)
216B: moving member
222: guide member
230: supply target member
230B: receiving portion
230C: wall portion
270: first member
272: second member
272A: through hole
300: screw fastening device
306: operating unit (an example of operating member)
318: supply target member
318A: receiving opening (an example of receiving portion)
318B: wall portion
332: magnet (an example of first magnet)
400: screw fastening device
430: supply target member
430B: receiving portion
430C: wall portion

### DETAILED DESCRIPTION

### First Exemplary Embodiment

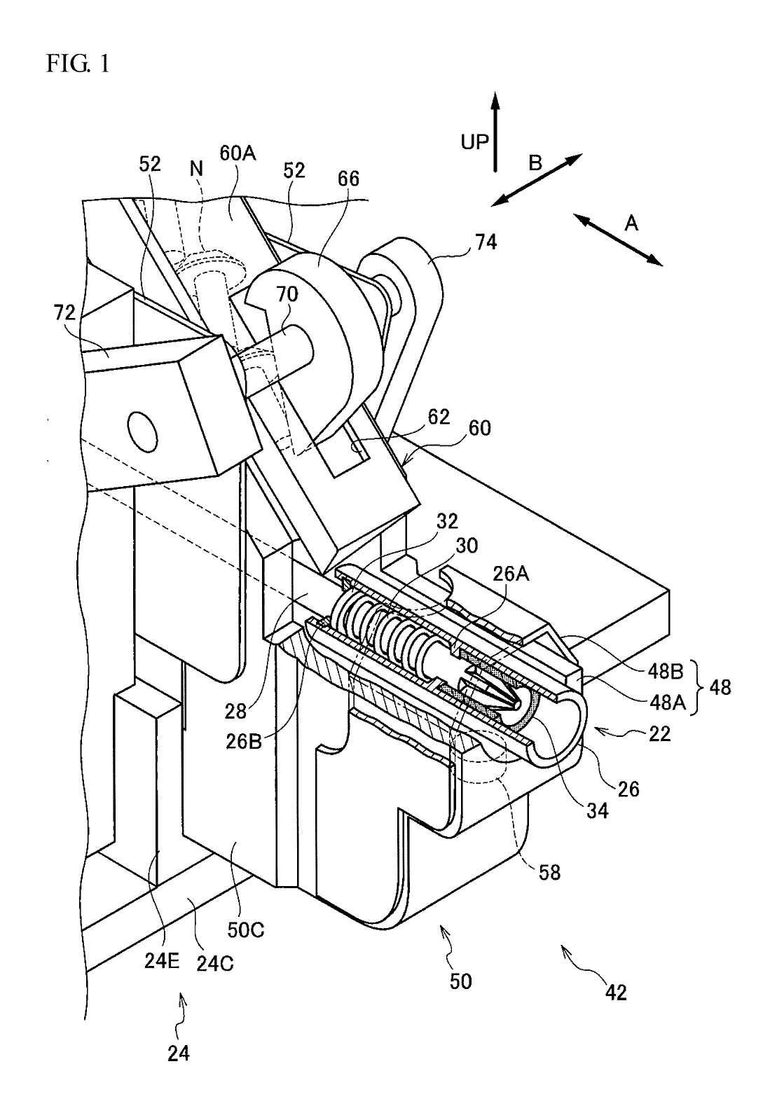

Examples of a screw fastening device and a method of manufacturing a screw-fastened object according to a first exemplary embodiment of the invention will be described with reference to FIGS. 1 to 18. Meanwhile, an arrow UP in the drawings represents the upper side in a vertical direction.

Entire Structure

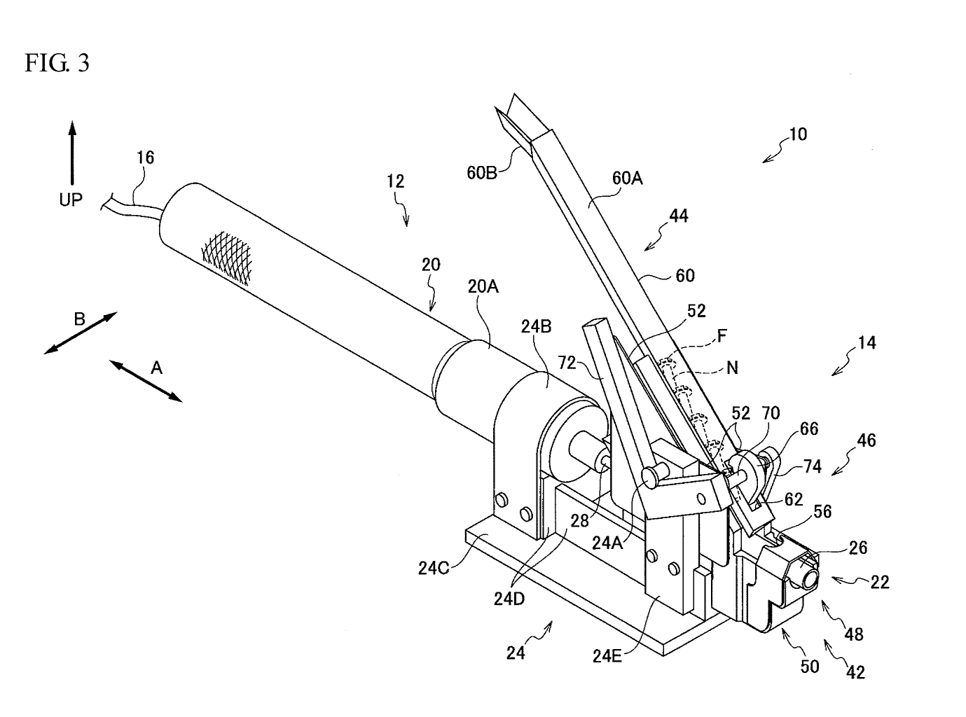

A screw fastening device 10 is a device that is used to screw a male screw N into a target in a horizontal direction. As shown in FIG. 3, the screw fastening device 10 includes a device body 12 to which an end portion of a power supply cord 16 is fixed, and a moving section 14 that is supported so as to be movable relative to the device body 12 in the horizontal direction. Meanwhile, the head portion of the male screw N, which is used in this exemplary embodiment, includes a flange F and is formed in a hexagonal shape. A cross recess into which a tip portion of a so-called phillips screwdriver is inserted is formed on the head portion that is formed in the hexagonal shape.

Device Body Section

The device body 12 includes a columnar grip 20 of which one end portion is fixed to an end portion of a power supply cord 16 and which is held by a worker, an operating unit 22 that includes a bit 28 as an example of an applying member protruding so as to extend from the other end portion of the grip 20 in one direction (which is a horizontal direction in this example and a direction of an arrow A in the drawings) and applying torque to the male screw N, and a connection unit 24 of which one end is fixed to the grip 20 and where a contact pin 24A coming into contact with an L-shaped member 72 (to be described below) of the moving section 14 is disposed at the other end.

Operating Unit

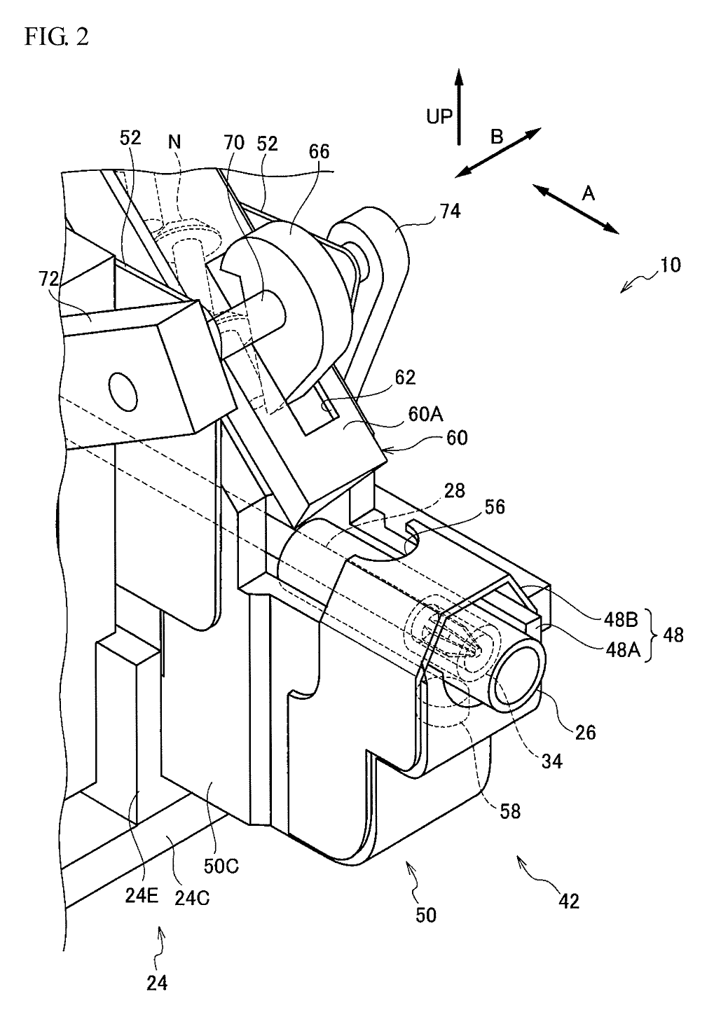

As shown in FIGS. 1 and 2, a tip portion of the bit 28 extending in one direction is formed in a cross shape and can be inserted into the cross recess that is formed on the head portion of the male screw N.

In addition, a cylindrical bit guide 26 as an example of a holding member, which is formed so as to surround the bit 28, is provided at the tip portion of the bit 28. The bit guide 26 is disposed so as to extend in one direction, and is supported by the bit 28 so as to be movable relative to the bit 28 in one direction.

A coil spring 30, which biases the bit guide 26 to a side where the bit guide 26 protrudes from the tip portion of the bit 28 (hereinafter, referred to as a “tip side in one direction”), is provided between the bit 28 and the bit guide 26. A base end of the coil spring 30 comes into contact with a ring member 32 that is fixed to the outer peripheral surface of the bit 28. Further, a tip of the coil spring 30 comes into contact with a protruding portion 26A that is integrally formed on the inner peripheral surface of the bit guide 26 and protrudes inward in the radial direction of the bit guide 26. Furthermore, a ring-shaped stopper 26B is fixed to a base end portion of the bit guide 26 (a portion of the bit guide 26 close to the grip 20 (see FIG. 3)). The stopper 26B of the bit guide 26, which is biased to the tip side in one direction by the coil spring 30, comes into contact with the ring member 32 fixed to the bit 28, so that the bit guide 26 is positioned relative to the bit 28.

Moreover, a cylindrical magnet 34 as an example of a second magnet is provided along the inner peripheral surface of the bit guide 26 on the side, which faces the tip, of the protruding portion 26A of the bit guide 26 so as not to protrude from the tip portion of the bit guide 26.

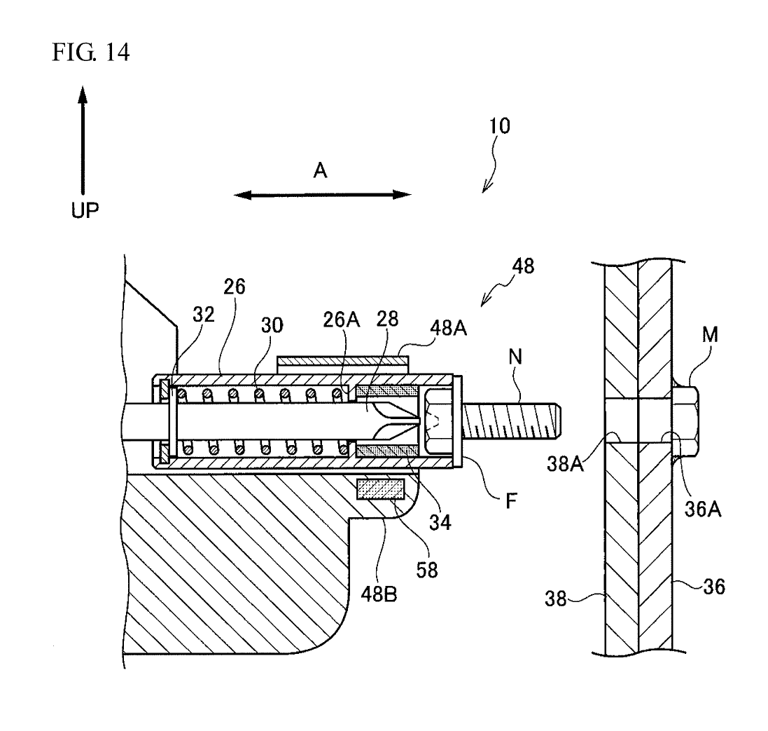

When the male screw N is attracted toward the magnet 34 by the magnetic force of the magnet 34, the flange F formed at the head portion of the male screw N comes into contact with the annular end face of the bit guide 26 as shown in FIG. 14 so that the male screw N faces one direction. Further, the head portion of the male screw N, the bit 28, and the magnet 34 are separated from each other in this state.

Meanwhile, a female screw M is welded to a plate-like first member 36 so that a prepared hole 36A of the first member 36 and a screw hole of the female screw M overlap each other. Further, the prepared hole 36A of the first member and a through hole 38A of the second member 38 are disposed so as to overlap each other.

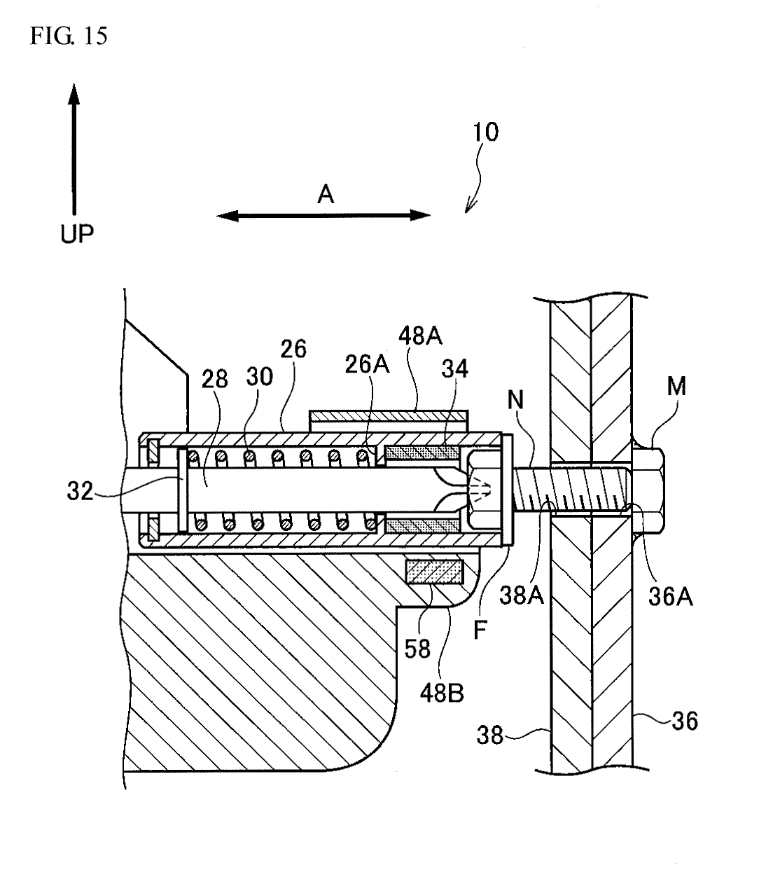

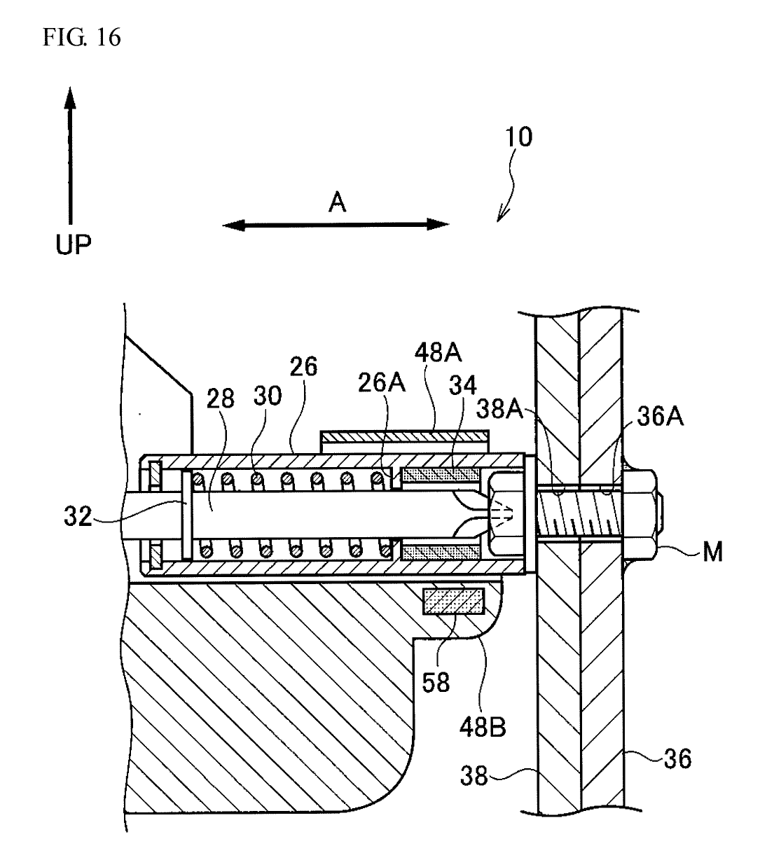

In this structure, as shown in FIGS. 15 and 16, the worker presses a tip portion of the male screw N, which is brought into contact with the end face of the tip portion of the bit guide 26 by the magnetic force of the magnet 34, against the female screw M while grasping the grip 20 (see FIG. 3). Accordingly, the bit guide 26 is moved toward the base end side of the bit 28 (hereinafter, referred to as a “base end side in one direction”) against a biasing force of the coil spring 30. Moreover, the tip portion of the bit 28, which is formed in a cross shape, is inserted into the cross recess of the head portion of the male screw N, so that the bit 28 is interposed between the grip 20 and the male screw N. Since the bit 28 is interposed between the grip 20 and the male screw N, the bit 28 is rotated by the operation of a motor (not shown) provided in the grip 20 when a compressive load is applied to the bit 28. Accordingly, the male screw N is screwed into the screw hole of the female screw M.

Connection Unit

Next, the connection unit 24 of which one end is fixed to the grip 20 and where a contact pin 24A coming into contact with an L-shaped member 72 (to be described below) of the moving section 14 is disposed at the other end will be described.

As shown in FIG. 3, the connection unit 24 includes an inverted U-shaped member 24B fixed to a large-diameter portion 20A which is formed at the tip portion of the grip 20 in one direction so as to have a diameter larger than the diameter of a general portion of the grip 20 and of which the lower portion is opened. Further, a base end portion of a rectangular plate-like base plate 24C is fixed to lower ends of the U-shaped member 24B through a connecting member 24D that extends in one direction. Furthermore, a tip portion of the base plate 24C extends to the tip side in one direction and a base end portion of a support plate 24E, which extends upward, is fixed to the tip portion of the base plate 24C through the connecting member 24D.

Moreover, a base end portion of the contact pin 24A, which extends in an orthogonal direction orthogonal to one direction and the vertical direction (a direction of an arrow B in the drawings: hereinafter, simply referred to as an “orthogonal direction”), is fixed to an upper end portion of the support plate 24E.

Moving Section

Next, the moving section 14, which is supported so as to be movable relative to the device body 12, will be described.

The moving section 14 includes a supply unit 42 which is movable relative to the device body 12 in one direction and to which male screws N to be screwed into female screws M (see FIG. 15) by the bit 28 are supplied, a guide unit 44 that guides the male screws N to the supply unit 42, and a rotational moving unit 46 that sequentially supplies the male screws N which are guided by the guide unit 44 to the supply unit 42 while being rotationally moved.

Supply Unit

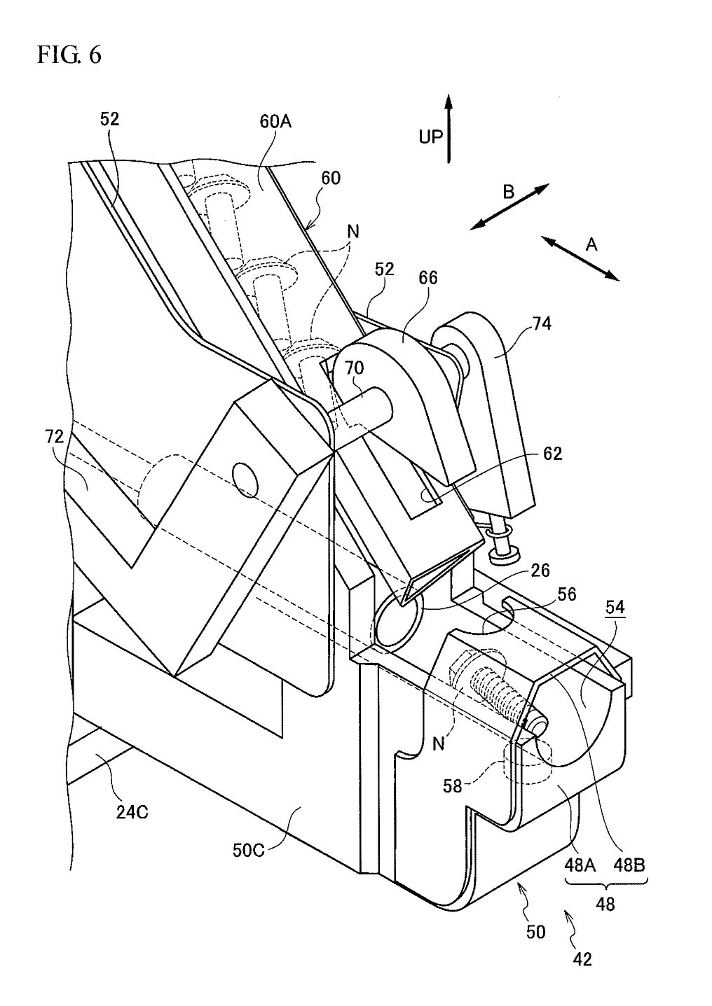

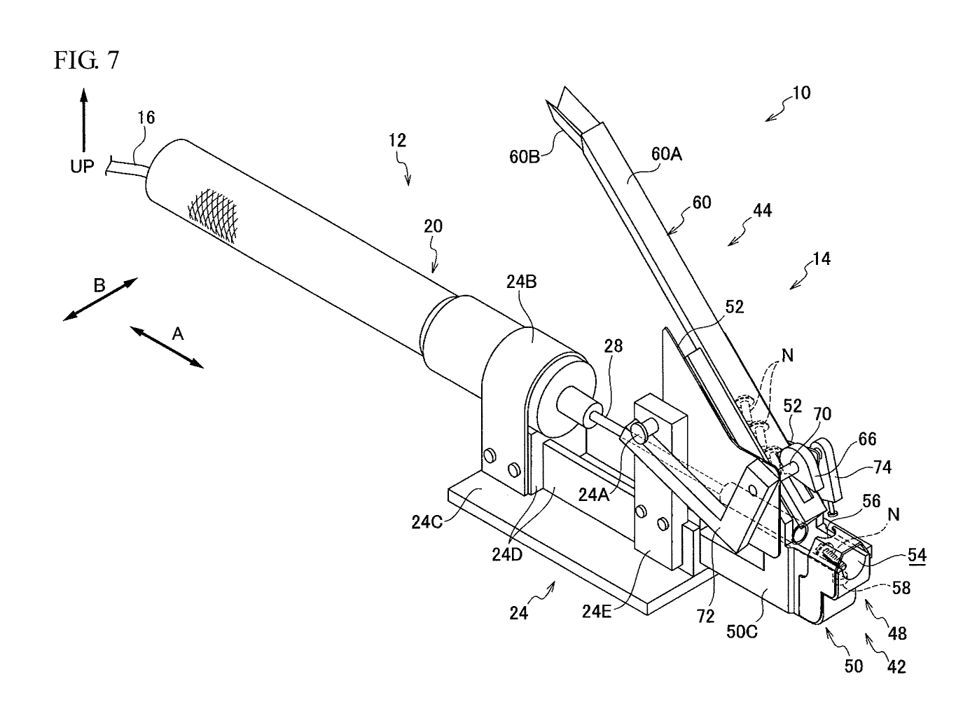

As shown in FIGS. 6 and 7, the supply unit 42 includes a supply target member 48 to which the male screw N is supplied and which extends in one direction, a support member 50 that is formed integrally with the supply target member 48 and is supported by the base plate 24C so as to be movable along the surfaces of the base plate 24C and the connecting member 24D in one direction, and a pair of plate members 52 that are mounted on a pair of side surfaces 50C of the support member 50.

In this structure, the moving range of the supply unit 42 is limited by stoppers (not shown). Accordingly, the supply unit 42 is supported by the connection unit 24 so as to be movable between a base end position (see FIGS. 2 and 3) where the supply unit 42 has been moved relative to the device body 12 toward the base end side in one direction and a tip position (see FIGS. 6 and 7) where the supply unit 42 has been moved relative to the device body 12 toward the tip side in one direction.

Further, the supply target member 48 includes a base portion 48A as an example of a wall portion that is formed so as to guide the bit guide 26 moving relative to the moving section 14, and a cover portion 48B that is formed by bending a plate member and is provided so as to cover a tip portion of the base portion 48A from above.

Furthermore, a cavity portion 54, to which the male screw N is supplied so as to extend in one direction and through which the bit guide 26 passes, is formed between the base portion 48A and the cover portion 48B. Moreover, a semicircular receiving portion 56, which receives the male screw N supplied to the cavity portion 54 from the rotational moving unit 46, is formed at a base end portion of the cover portion 48B in one direction.

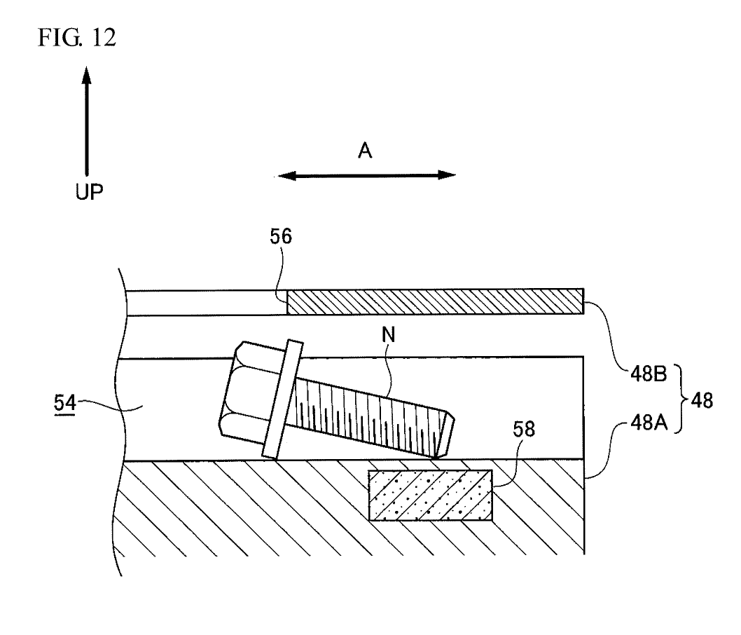

In addition, as shown in FIGS. 6 and 12, a magnet 58 as an example of a first magnet, which disposes the male screw N supplied to the cavity portion 54 by a magnetic force so that the male screw N extends in one direction and makes the head portion of the male screw N face the base end side in one direction (one side), is provided in the base portion 48A facing the receiving portion 56. Further, as shown in FIG. 12, the magnet 58 is disposed below a screw portion of the male screw N of which the head portion faces the base end side in one direction and in the tip portion of the base portion 48A in one direction.

Furthermore, the magnet 58 applies a magnetic force, which is smaller than the magnetic force of the magnet 34 (see FIG. 1) of the bit guide 26 moving relative to the supply unit 42, to the male screw N that is supplied to the cavity portion 54. In other words, the magnet 34 of the bit guide 26 moving relative to the supply unit 42 applies a magnetic force, which is larger than the magnetic force of the magnet 58, to the male screw N that is supplied to the cavity portion 54.

Guide Unit

Next, the guide unit 44, which guides the male screws N to the supply unit 42, will be described.

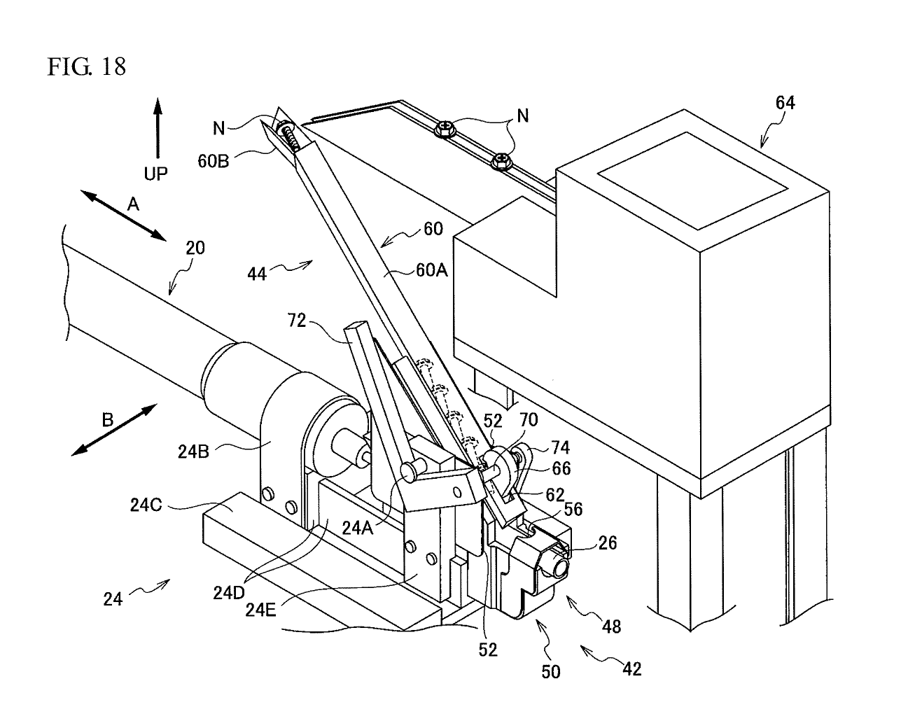

As shown in FIGS. 3 and 18, the guide unit 44 includes a guide member 60 that extends so as to be inclined downward from the base end side in one direction toward the tip side in one direction. In addition, the tip portion of the guide member 60 in one direction is opened toward the receiving portion 56 that is formed at the supply target member 48. Further, the guide member 60 is interposed between the pair of plate members 52, which are mounted on the side surfaces 50C of the support member 50, in a B direction and is mounted on the plate members 52.

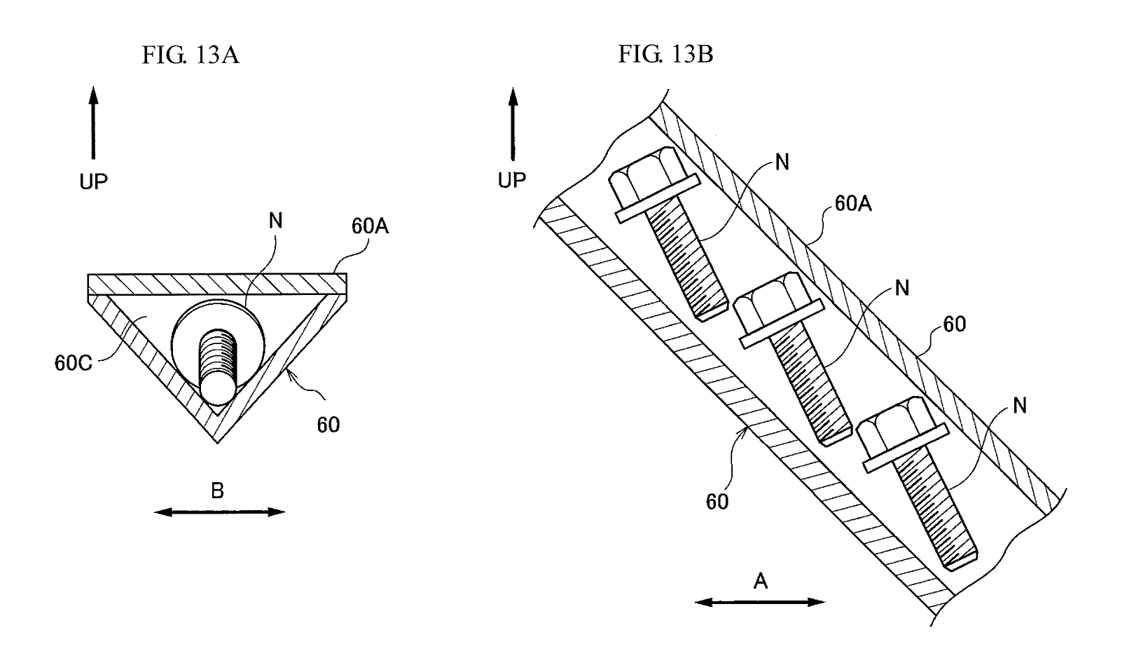

As shown in FIG. 13A, the cross-section of a guide passage 60C, which crosses the longitudinal direction of the guide member 60, is a closed cross-section including a ceiling board 60A, and is formed so that a lower portion of the cross-section of the guide passage 60C in a vertical direction is narrower than an upper portion thereof in the vertical direction. Accordingly, the head portions of the male screws N lined up in the guide passage 60C come into contact with both wall surfaces of the guide passage 60C as shown in FIGS. 13A and 13B, so that the head portions of the male screws N are disposed above the screw portions in the vertical direction.

Meanwhile, as shown in FIG. 18, a guide base-end portion 60B, which is bent so as to be close to a horizontal direction, is provided at the base end portion of the guide member 60 in one direction. Since the guide base-end portion 60B is not provided with the ceiling board 60A, the upper portion of the guide base-end portion 60B is opened.

Further, male screws N, which are supplied from a male screw supply device 64, are supplied to the guide member 60 from an upper portion of the guide base-end portion 60B.

Furthermore, a rectangular through hole 62 is formed at the tip portion of the ceiling board 60A of the guide member 60 in one direction, and a part of a moving member 66 to be described below is inserted into the guide member 60 from the outside through the through hole 62.

Rotational Moving Unit

Next, the rotational moving unit 46 that sequentially supplies the male screws N, which are guided by the guide unit 44, to the supply unit 42 while being rotationally moved will be described.

As shown in FIGS. 2 and 3, the rotational moving unit 46 includes a shaft 70 that extends in the orthogonal direction and is rotatably supported by the pair of plate members 52. One end portion of the L-shaped member 72, of which the end face comes into contact with the above-mentioned contact pin 24A and which has an L-shaped, is fixed to one end portion of the shaft 70 and one end portion of a long bar member 74 is fixed to the other end portion of the shaft 70. Moreover, an end portion of a spring member (not shown), which biases the L-shaped member 72 through the bar member 74 and the shaft 70 so that the L-shaped member 72 comes into contact with the contact pin 24A from below, is fixed to the other end portion of the bar member 74. Further, the moving member 66, which is fixed to the shaft 70, is provided between the L-shaped member 72 and the bar member 74.

The moving member 66 is formed in a substantially semicircular shape, and a part of the moving member 66 is inserted into the guide member 60 through the through hole 62 as described above.

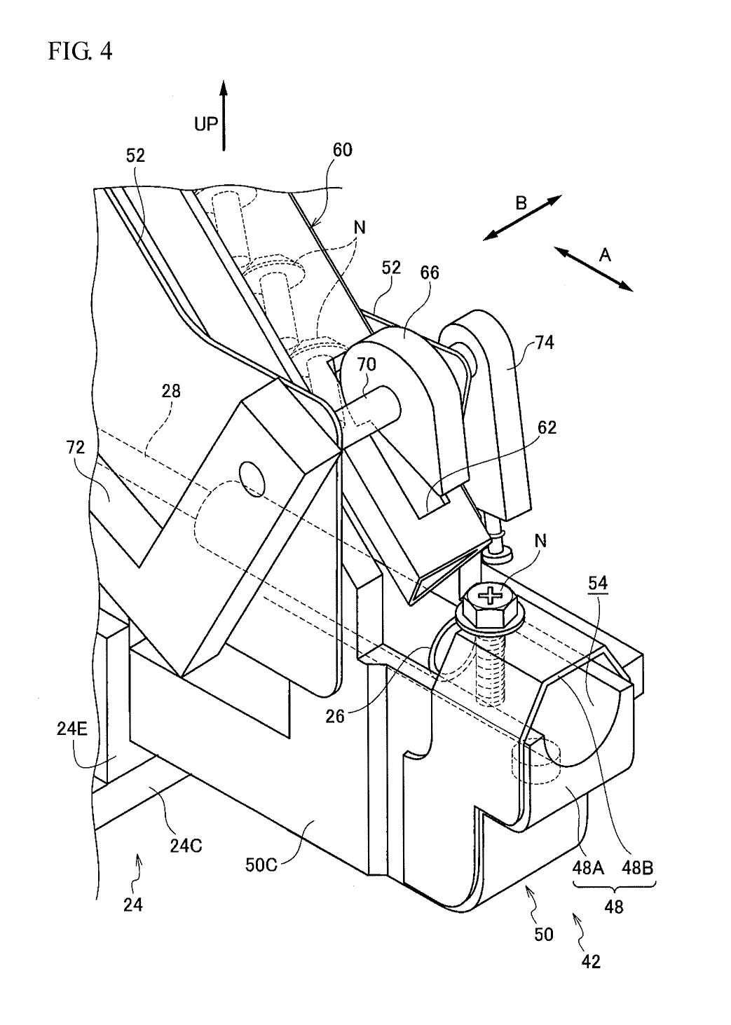

When the shaft 70 is rotated in the circumferential direction of the shaft 70, the moving member 66 is rotationally moved. Accordingly, the moving member 66 can be moved between a suppression position (see FIG. 2: first position) where a tip portion of the moving member 66 corresponding to the tip side in one direction comes into contact with the male screw N present in the guide member 60 so as to suppress the supply of the male screw N to the supply target member 48 and a supply position (see FIG. 4: second position) where the moving member 66 is rotationally moved so as to supply the male screw N having come into contact with the tip portion of the moving member 66 to the supply target member 48 and a rear end portion of the moving member 66 comes into contact with the next male screw N so as to stop the movement of the next male screw N.

In the above-mentioned structure, the moving member 66 is disposed at the suppression position when the supply unit 42 is disposed at the base end position as shown in FIGS. 2 and 3. In contrast, when the supply unit 42 is moved relative to the device body 12 in one direction and is disposed at the tip position as shown in FIGS. 6 and 7, the L-shaped member 72 coming into contact with the contact pin 24A is rotated about the shaft 70 and the shaft 70 is rotated in the circumferential direction. Accordingly, the moving member 66 is moved to the supply position.

Action

Next, a method of manufacturing a screw-fastened object using the above-mentioned screw fastening device 10 will be described.

The supply unit 42 is disposed at the base end position as shown in FIG. 18, and male screws N are supplied to the guide member 60 from the male screw supply device 64 in this state. As shown in FIG. 13B, the supplied male screws N are lined up in the guide member 60 in the longitudinal direction of the guide member 60 and the head portions of the male screws N are disposed above the screw portions in the vertical direction. Since the moving member 66 is disposed at the suppression position in this state, the male screw N supplied to the guide member 60 comes into contact with the tip portion of the moving member 66 and is not supplied to the supply target member 48.

As shown in FIGS. 2 and 3, in this state, the worker moves the support member 50 to the tip side in one direction while holding the grip 20 with one hand and grasping the support member 50 of the supply unit 42 with the other hand.

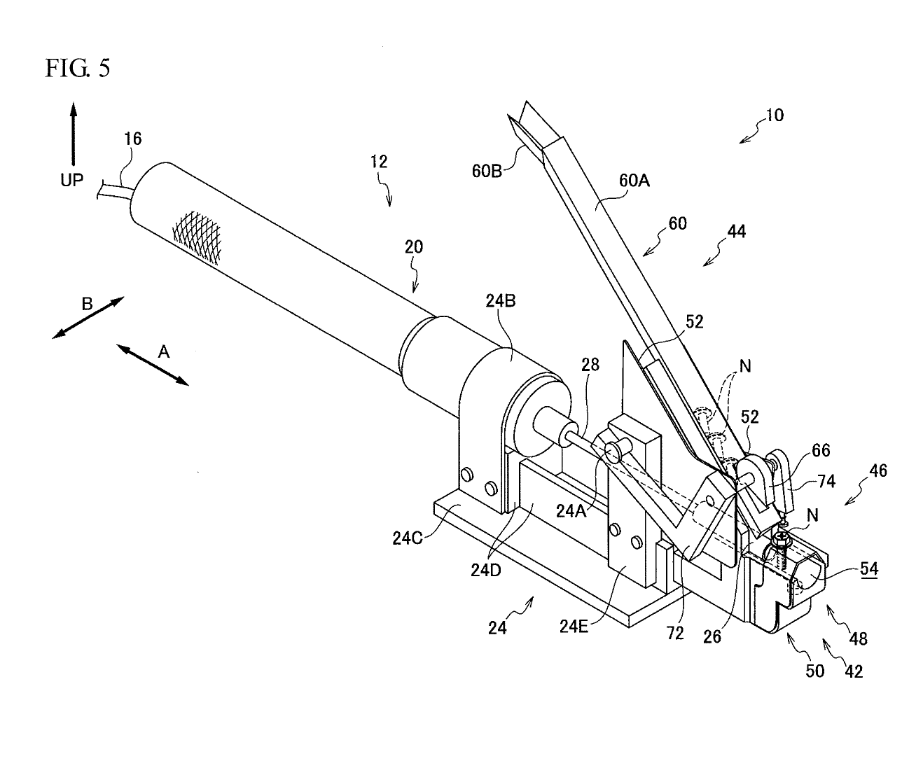

Since the support member 50 is moved to the tip side in one direction, the supply unit 42 is moved to the tip position as shown in FIGS. 4 and 5. Accordingly, the L-shaped member 72 coming into contact with the contact pin 24A is rotated about the shaft 70, so that the shaft 70 is rotated. The moving member 66 is moved to the supply position from the suppression position.

Since the moving member 66 is moved to the supply position, a male screw N having come into contact with the tip portion of the moving member 66 is supplied to the supply target member 48 and the rear end portion of the moving member 66 comes into contact with the next male screw N so as to stop the movement of the next male screw N.

The male screw N supplied to the supply target member 48 is supplied to the cavity portion 54 from the receiving portion 56 (see FIG. 2). Specifically, the head portion of the male screw N is caught by the receiving portion 56 once (see FIG. 4), and the male screw N is rotated about the receiving portion 56 as a fulcrum.

As shown in FIGS. 6 and 7, the male screw N, which is being rotated, is disposed so as to extend in one direction by the magnetic force of the magnet 58. Accordingly, the head portion of the male screw N faces the base end side in one direction. Moreover, in this state, the worker moves the support member 50 to the base end side in one direction.

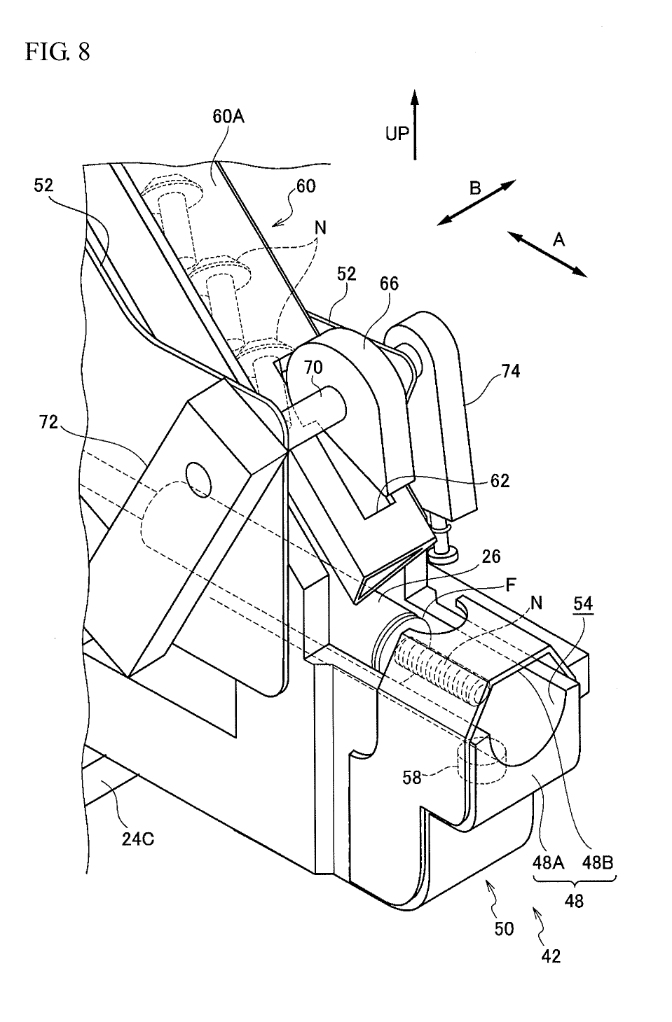

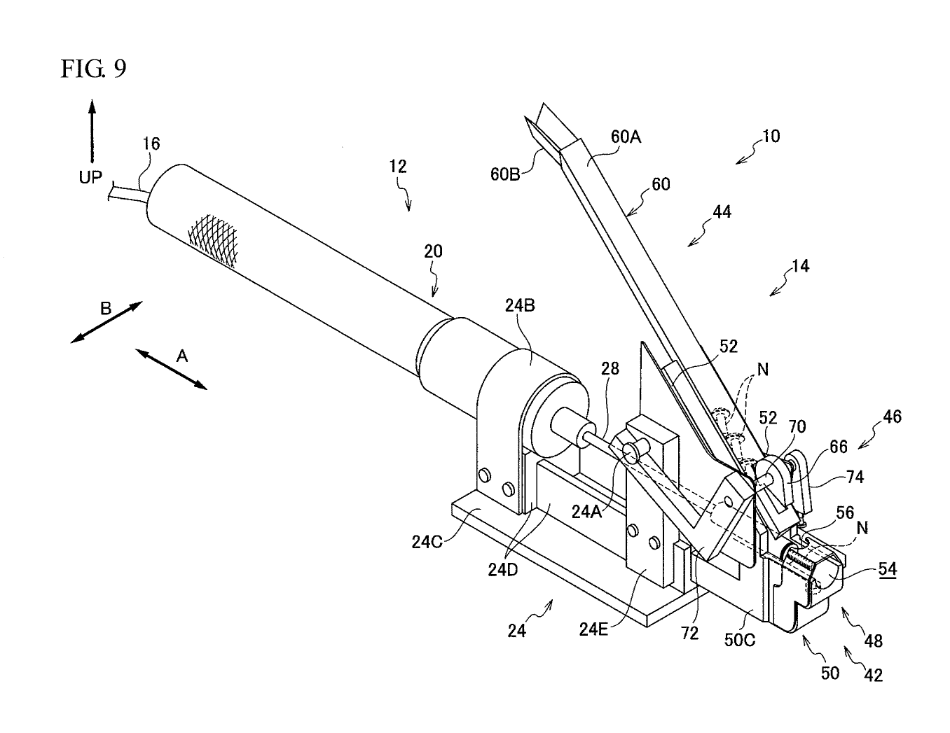

When the support member 50 is moved to the base end side in one direction, the male screw N which is supplied to the supply target member 48 and of which the head portion faces the base end side in one direction approaches the tip portion of the bit guide 26 as shown in FIGS. 8 and 9.

Further, before the supply unit 42 reaches the base end position, the head portion of the male screw N is attracted by the magnetic force of the magnet 34 (see FIG. 1). Accordingly, the flange F formed at the head portion of the male screw N comes into contact with the end face of the tip portion of the bit guide 26, so that the position of the male screw N held by the bit guide 26 becomes stable.

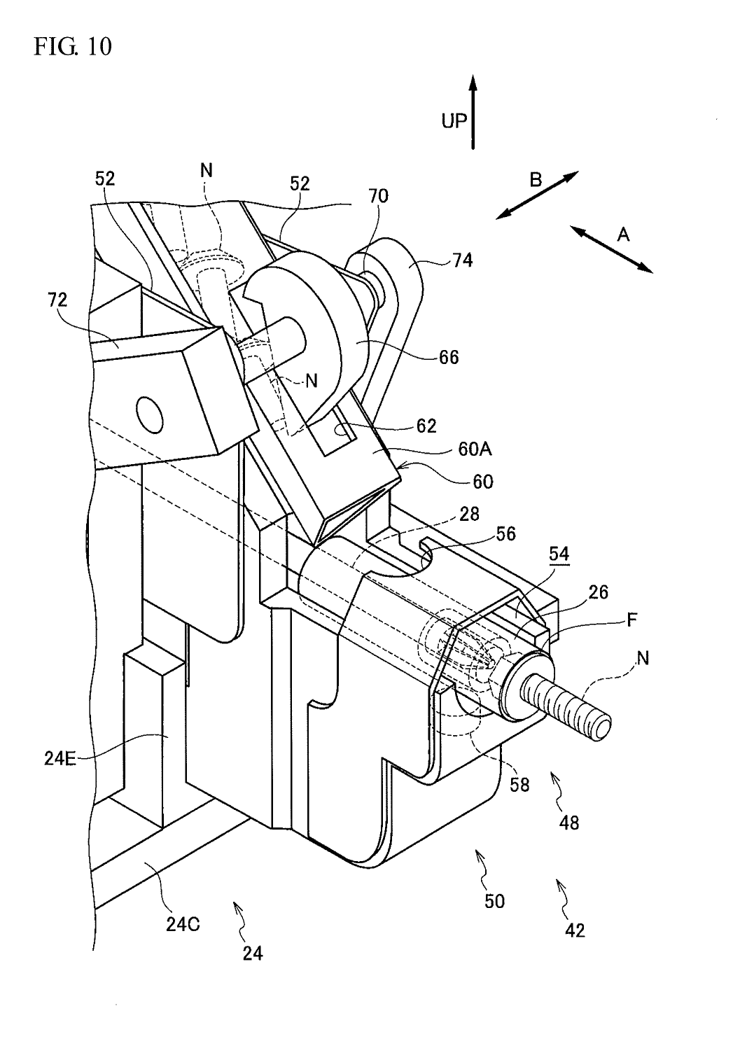

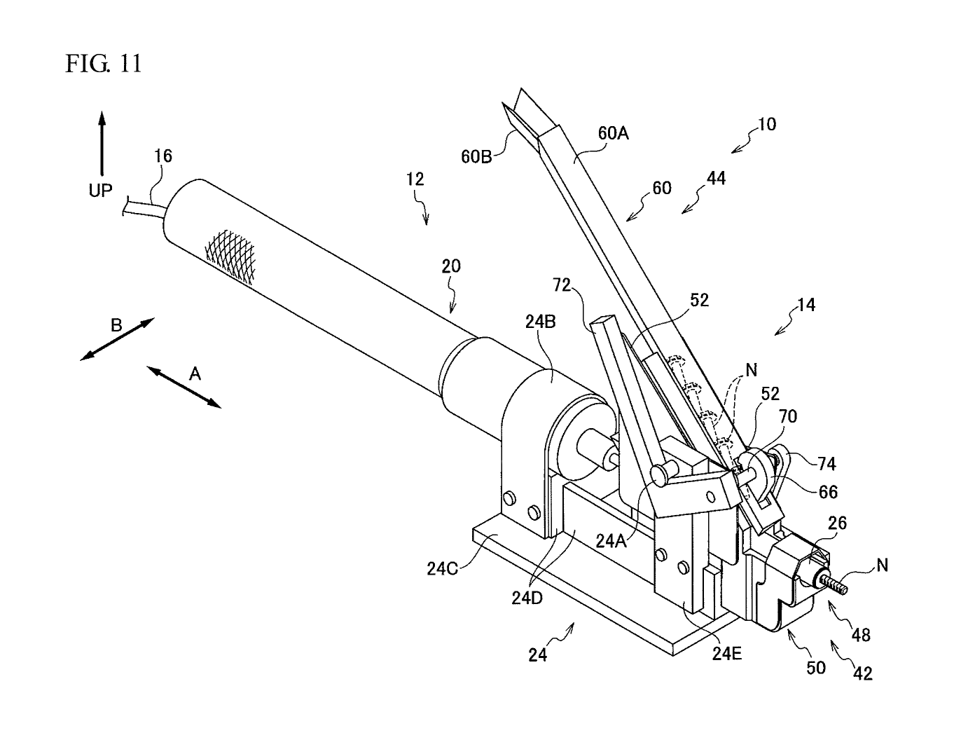

When the worker further moves the support member 50 toward the base end side in one direction as shown in FIGS. 10 and 11, the supply target member 48 is moved to the base end position and the male screw N, which comes into contact with the bit guide 26 and of which the position is stable, protrudes from the supply target member 48 toward the tip side in one direction.

Here, since the magnet 34 applies a magnetic force, which is larger than the magnetic force of the magnet 58, to the male screw N supplied to the cavity portion 54 as described above, the male screw N is not separated from the bit guide 26.

Further, since the supply unit 42 is moved to the base end position from the tip position, the L-shaped member 72 coming into contact with the contact pin 24A is rotated about the shaft 70 in a reverse direction. Accordingly, the shaft 70 is also rotated in the reverse direction. Furthermore, the moving member 66 is moved to the suppression position from the supply position.

Since the moving member 66 is moved to the suppression position, the next male screw N of which the movement is stopped by the rear end portion of the moving member 66 is separated from the rear end portion of the moving member 66 and is moved toward the tip portion of the moving member 66. The male screw N, which has been moved toward the tip portion of the moving member 66, comes into contact with the tip portion of the moving member 66 and is not supplied to the supply target member 48.

Meanwhile, as shown in FIG. 14, the worker positions the first member 36 and the second member 38 by disposing the through hole 38A of the plate-like second member 38 in which the through hole 38A is formed so that the through hole 38A overlaps the female screw M of the plate-like first member 36 where the female screw M is provided in the prepared hole 36A (positioning step).

Further, as shown in FIGS. 14 and 15, the worker presses the tip portion of the male screw N against the female screw M through the through hole 38A and the prepared hole 36A while grasping the grip 20 (see FIG. 3). Since the male screw N is pressed against the female screw M, the bit guide 26 is moved relative to the bit 28 toward the base end side in one direction against the biasing force of the coil spring 30. Accordingly, the tip portion of the bit 28, which is formed in a cross shape, is inserted into the cross recess of the head portion of the male screw N, so that the bit 28 is interposed between the grip 20 and the male screw N.

When the bit 28 is interposed between the grip 20 and the male screw N and a compressive load is applied to the bit 28, a motor (not shown) provided in the grip 20 is operated and the bit 28 is rotated. As a result, the male screw N is screwed into the female screw M as shown in FIG. 16 (male screw screwing step).

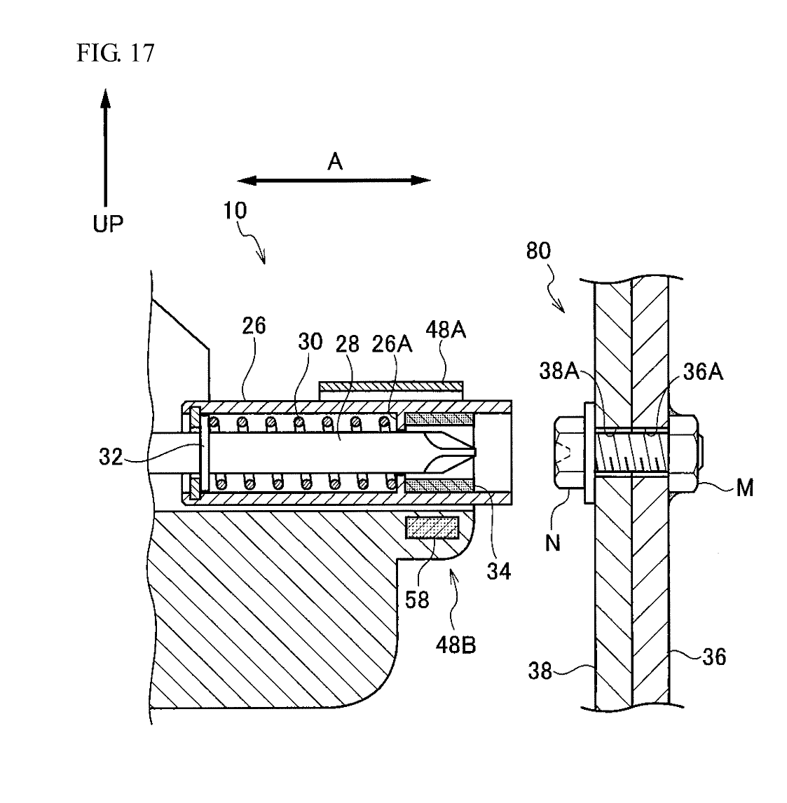

When the screw fastening device 10 is moved to the base end side in one direction as shown in FIG. 17, the rotation of the bit 28 is stopped and the screw fastening device 10 is separated from the male screw N. As a result, a screw-fastened object 80 using the male screw N is manufactured.

The above-mentioned steps are performed again to further screw another male screw N into another female screw M, so that the male screw N is successively screwed into the female screw M.

Since the magnet 58, which disposes a male screw N supplied to the supply target member 48 so that the male screw N extends in one direction and makes the head portion of the male screw N faces the base end side in one direction, is provided in the screw fastening device 10 as described above, the position of the male screw N supplied to the supply target member 48 is stable as compared to a case where the magnet 58 is not provided.

Further, since the magnet 58 is disposed at the base portion 48A facing the receiving portion 56, the magnetic force of the magnet 58 is effectively applied to the male screw N supplied to the supply target member 48.

Furthermore, since the cross-section of the guide passage 60C, which crosses the longitudinal direction of the guide member 60, is formed so that the lower portion of the cross-section of the guide passage in the vertical direction is narrower than the upper portion thereof in the vertical direction, the head portion of the male screw N comes into contact with both wall surfaces of the guide passage 60C. For this reason, the head portion of the male screw N, which is present in the guide member 60, is disposed above the screw portion in the vertical direction. Accordingly, even though the guide member 60 shakes, the position of the male screw N present in the guide member 60 is stable.

Moreover, since there is provided the moving member 66 that can be moved between the suppression position where the supply of the male screw N to the supply target member 48 is suppressed and the supply position where the male screw N is supplied to the supply target member 48, male screws N are sequentially supplied to the supply target member 48.

Further, since the end face of the tip portion of the bit guide 26 and the flange F formed at the head portion of the male screw N come into contact with each other, the position of the male screw N coming into contact with the bit guide 26 is stable.

Furthermore, since a screw-fastened object 80 is manufactured using the screw fastening device 10, the efficiency of a work for manufacturing the screw-fastened object 80 is improved.

### Second Exemplary Embodiment

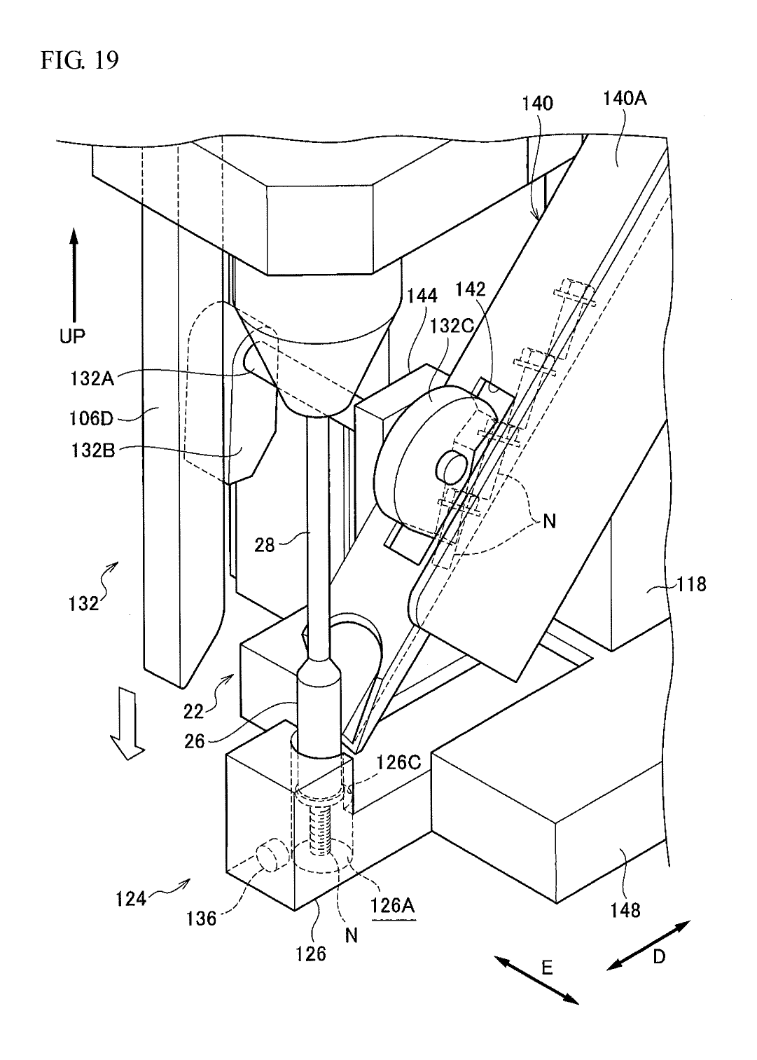

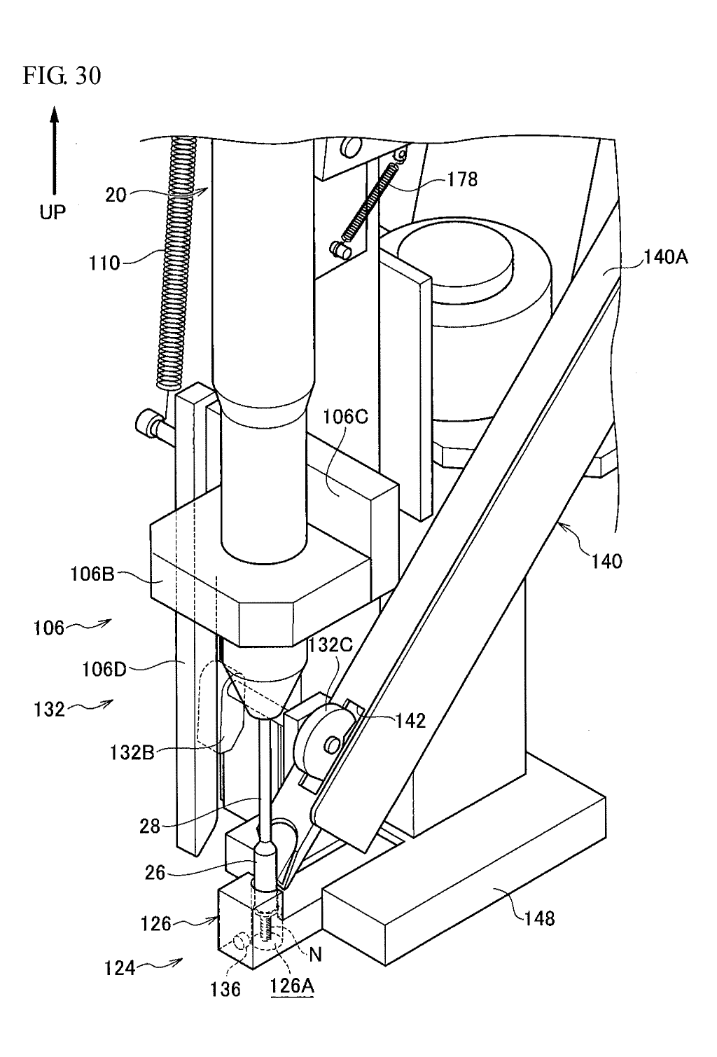

Next, examples of a screw fastening device and a method of manufacturing a screw-fastened object according to a second exemplary embodiment of the invention will be described with reference to FIGS. 19 to 34. Meanwhile, the same members as those of the first exemplary embodiment may be denoted by the same reference numerals, and the description thereof may be omitted.

Entire Structure

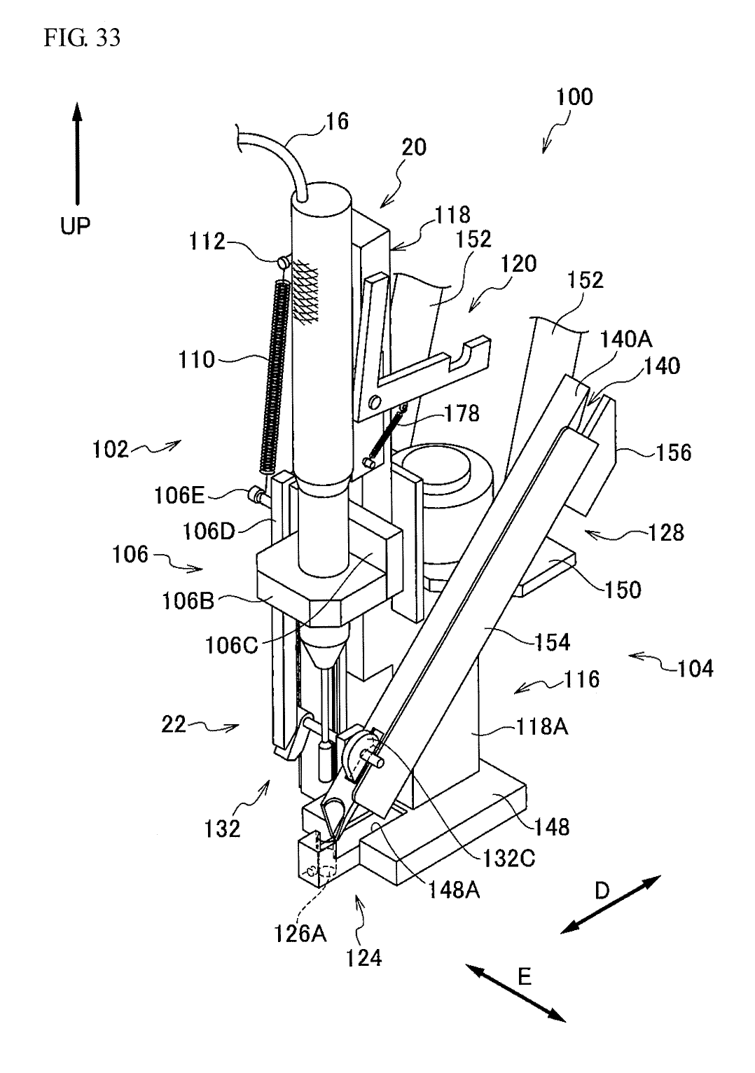

As shown in FIG. 33, a screw fastening device 100 according to the second exemplary embodiment is not a device that is used to screw a male screw N into a target in a horizontal direction but a device that is used to screw a male screw N into a target from above in a vertical direction.

The screw fastening device 100 includes a device body 102 to which an end portion of a power supply cord 16 is fixed and a support section 104 that supports the device body 102 so as to allow the device body 102 to move in a vertical direction.

Device Body

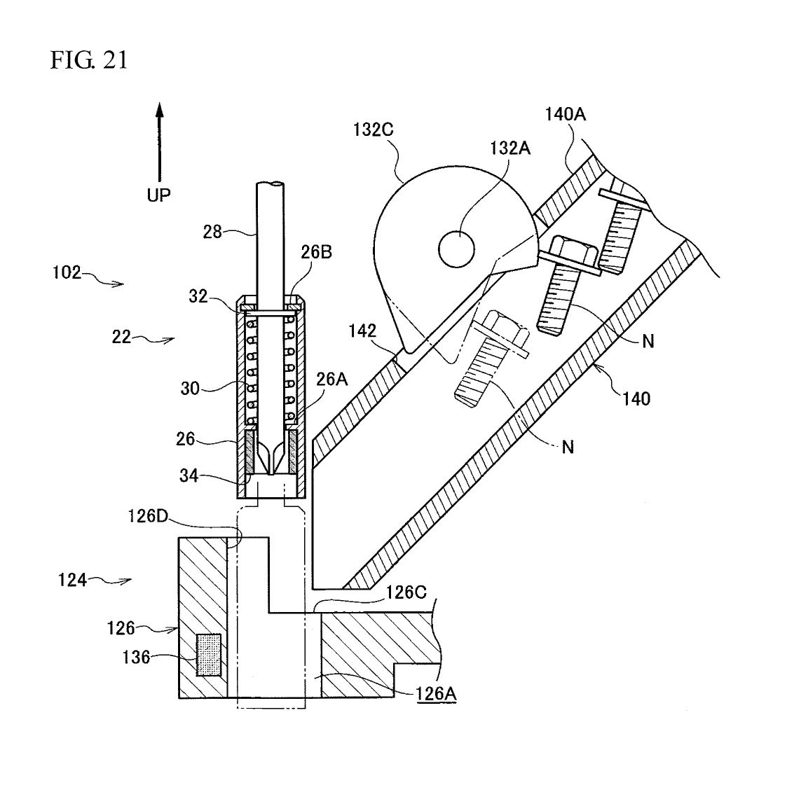

The device body 102 includes a columnar grip 20 of which one end portion is fixed to an end portion of the power supply cord 16 and which is held by a worker, an operating unit 22 that includes a bit 28 (see FIG. 21) protruding so as to extend from the other end portion of the grip 20 in one direction (which is a vertical direction in this example) and applying torque to the male screw N, and a connection unit 106 that is fixed to the grip 20 and is supported by the support section 104 so as to be movable in the vertical direction.

Operating Unit

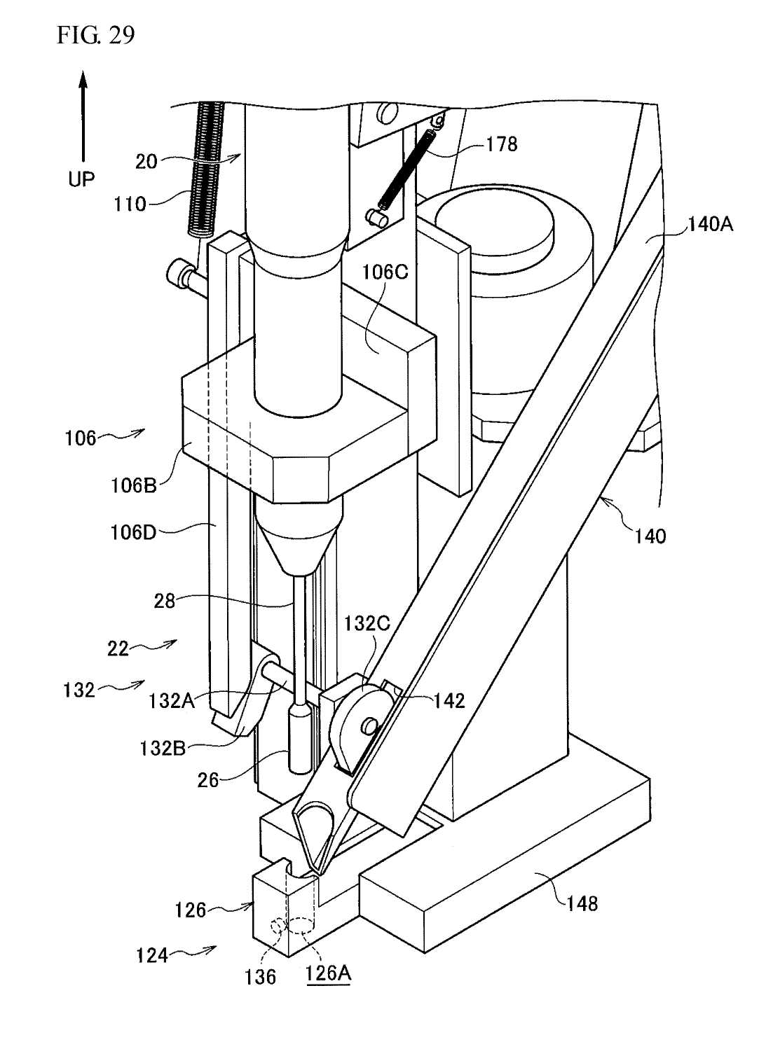

As shown in FIGS. 21 and 29, a tip portion of the bit 28, which is included in the operating unit 22 and extends downward in the vertical direction, is formed in a cross shape and can be inserted into a cross recess that is formed on a head portion of a male screw N.

In addition, a cylindrical bit guide 26, which is formed so as to surround the bit 28, is provided at the tip portion of the bit 28. The bit guide 26 is disposed so as to extend downward in the vertical direction, and is supported by the bit 28 so as to be movable relative to the bit 28 in the vertical direction.

As shown in FIG. 21, a coil spring 30, which biases the bit guide 26 to a side where the bit guide 26 protrudes from the tip portion of the bit 28 (a lower side in the vertical direction), is provided between the bit 28 and the bit guide 26. A base end of the coil spring 30 comes into contact with a ring member 32 that is fixed to the outer peripheral surface of the bit 28. Further, a tip of the coil spring 30 comes into contact with a protruding portion 26A that is integrally formed on the inner peripheral surface of the bit guide 26 and protrudes inward in the radial direction of the bit guide 26. Furthermore, a ring-shaped stopper 26B is fixed to a base end portion of the bit guide 26 (a portion of the bit guide 26 close to the grip 20 (see FIG. 29)). The stopper 26B comes into contact with the ring member 32 fixed to the bit 28, so that the bit guide 26 is positioned relative to the bit 28.

Moreover, a cylindrical magnet 34 is provided along the inner peripheral surface of the bit guide 26 on the side, which faces the tip, of the protruding portion 26A of the bit guide 26 so as not to protrude from the tip portion of the bit guide 26.

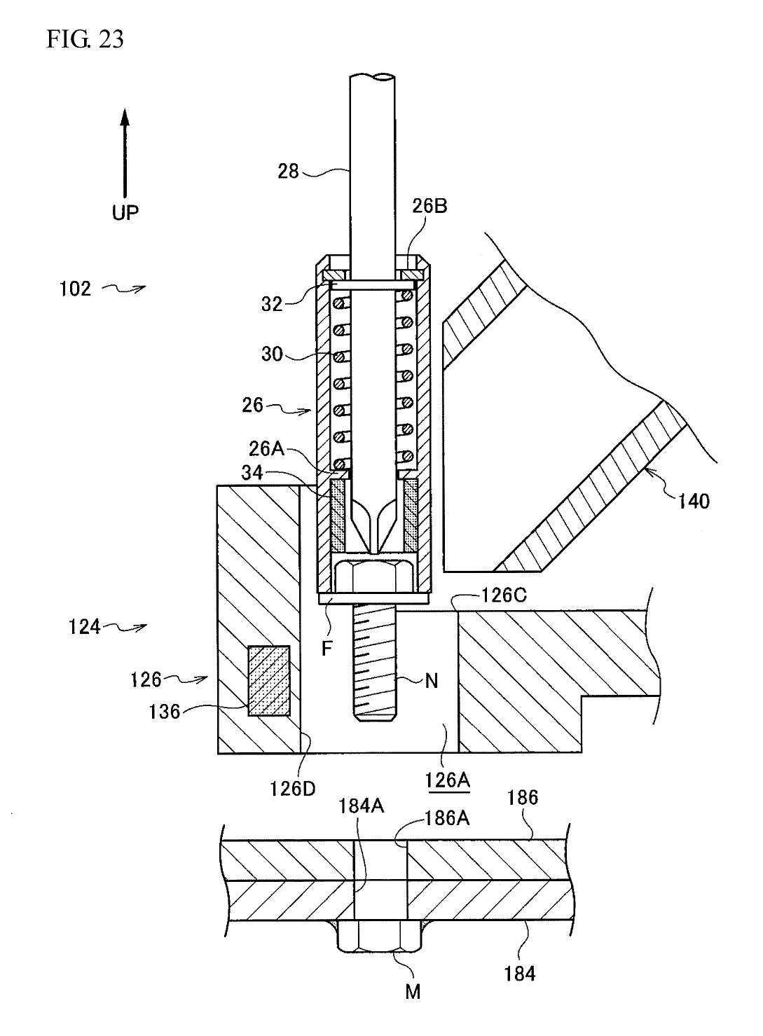

When the male screw N is attracted toward the magnet 34 by the magnetic force of the magnet 34, a flange F formed at the head portion of the male screw N comes into contact with the end face of the tip portion of the bit guide 26 as shown in FIG. 23 so that the male screw N faces one direction. Further, the head portion of the male screw N, the bit 28, and the magnet 34 are disposed so as to be separated from each other in this state.

Connection Unit

Next, the connection unit 106, which is fixed to the grip 20 and is supported by the support section 104 so as to be movable in the vertical direction, will be described.

As shown in FIG. 33, the connection unit 106 includes a plate-like fixing member 106B which is fixed to the lower portion of the grip 20, of which the diameter is smaller than the diameter of a general portion of the grip 20, in the vertical direction and of which the surface faces the vertical direction. The fixing member 106B is provided with a circular through hole and the above-mentioned small-diameter portion 20B is fitted into the through hole, so that the fixing member 106B is fixed to the grip 20.

Further, a rectangular plate-like slide member 106C that is supported so as to be movable relative to a pillar 118, which is provided in the support section 104 to be described below and extends in the vertical direction, in the vertical direction is fixed to the end face of the fixing member 106B.

Furthermore, an upper end portion of a pressing member 106D, which extends in the vertical direction and presses a tip portion of a swing member 132B to be described below, is fixed to an end portion of the slide member 106C.

Moreover, a pin 106E, which protrudes outward in the horizontal direction, is provided at the upper end portion of the pressing member 106D. Further, one end portion of a coil spring 110, which biases the connection unit 106 to the upper side in the vertical direction, is fixed to the pin 106E, and the other end portion of the coil spring 110 is fixed to a pin 112 that is disposed above the pin 106E and fixed to the pillar 118.

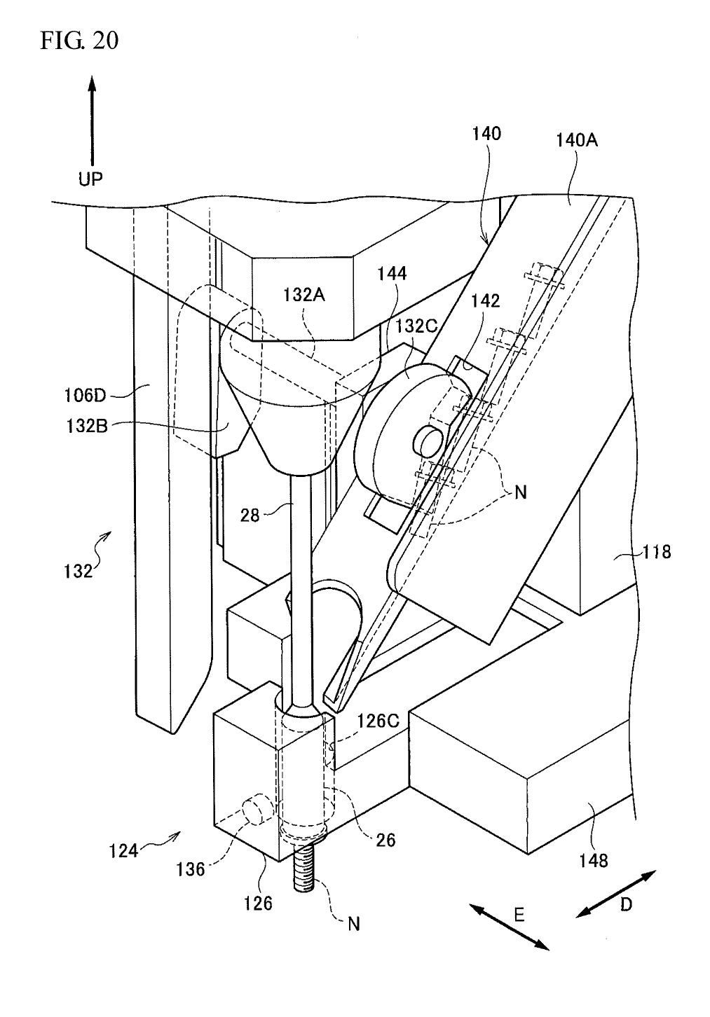

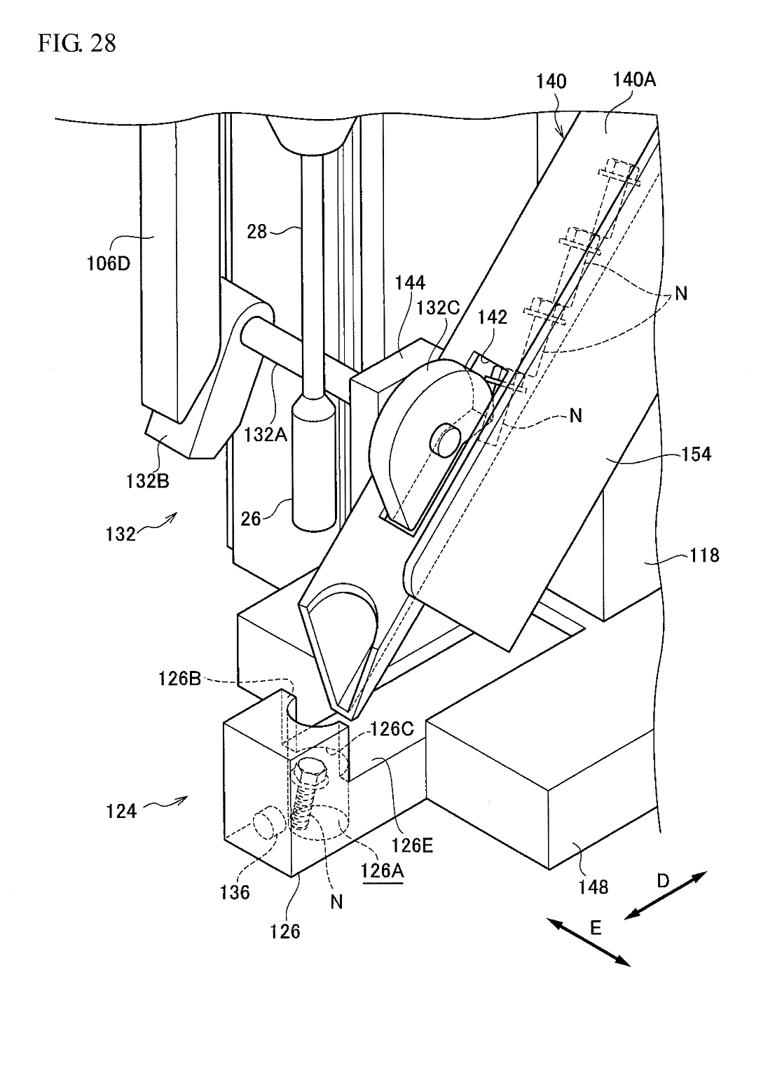

In this structure, the moving range of the device body 102 is limited by stoppers (not shown). Accordingly, the device body 102 can be moved between a lower end position (see FIG. 20) where the device body 102 has been moved downward in the vertical direction and an upper end position (see FIG. 28) where the device body 102 has been moved upward relative to the support section 104 in the vertical direction.

Support Section

Next, the support section 104, which supports the device body 102 so as to allow the device body 102 to move in the vertical direction, will be described.

As shown in FIG. 33, the support section 104 includes a support body portion 116 that supports the device body 102 so as to allow the device body 102 to move in the vertical direction, a supply unit 124 which is supported by the support body portion 116 and to which male screws N to be screwed into female screws M (see FIG. 23) by the bit 28 are supplied, a guide unit 128 that guides the male screws N to the supply unit 124, and a rotational moving unit 132 that sequentially supplies the male screws N, which are guided by the guide unit 128, to the supply unit 124 while being rotationally moved.

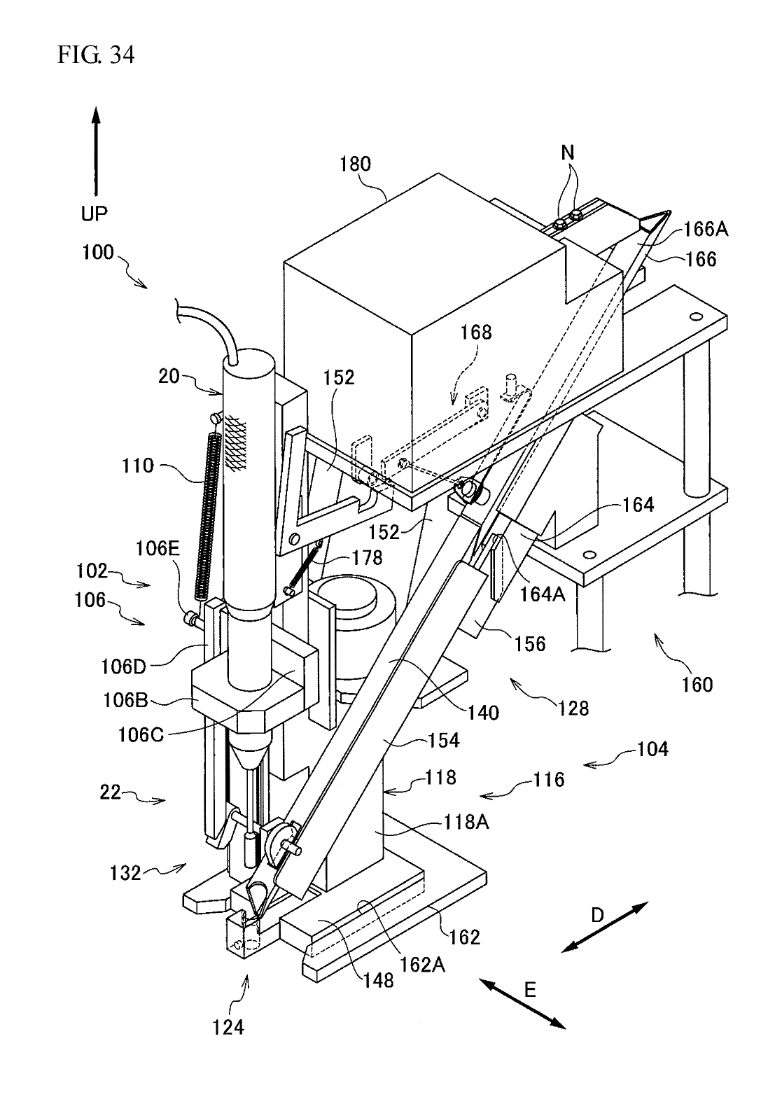

Moreover, the support section 104 includes a mounting unit 120 that is used to mount the screw fastening device 100 on a male screw supply device 160 (see FIG. 34).

Supply Unit

As shown in FIGS. 28 and 33, the supply unit 124 includes a supply target member 126 including a columnar cavity portion 126A which extends in the vertical direction and passes through the supply target member 126 in the vertical direction and through which the bit guide 26 passes.

A stepped surface 126B, which opens the inner peripheral surface of the cavity portion 126A, is formed on the supply target member 126, and a semicircular receiving portion 126C, which is surrounded by a ridge line formed between the cavity portion 126A and an upper surface 126E and receives a male screw N supplied to the cavity portion 126A, is formed on the upper surface 126E of the supply target member 126 that is to be low in the vertical direction.

As shown in FIG. 21, a magnet 136 as an example of a first magnet, which disposes the male screw N supplied to the cavity portion 126A by a magnetic force so that the male screw N extends in the vertical direction (one direction) and makes the head portion of the male screw N face the upper side in the vertical direction (one side), is provided in a wall portion 126D of the supply target member 126 facing the receiving portion 126C.

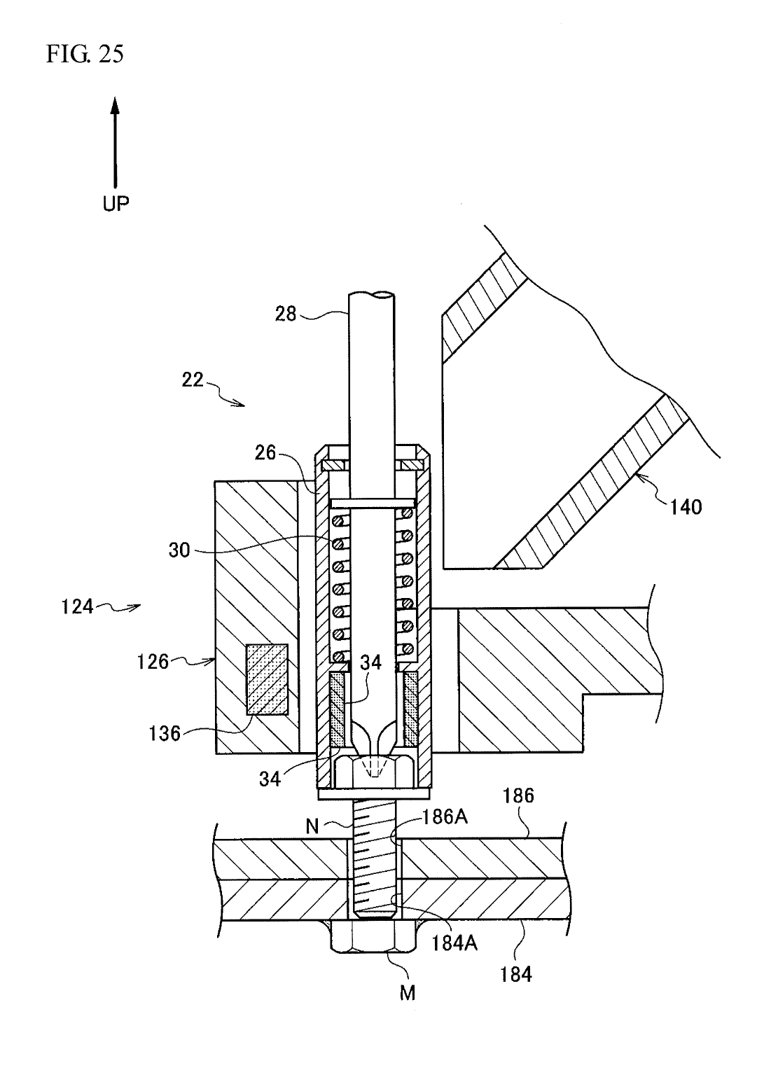

In addition, the magnet 136 applies a magnetic force, which is smaller than the magnetic force of the magnet 34 (see FIGS. 21 and 25) of the bit guide 26 moving relative to the supply unit 124, to the male screw N that is supplied to the cavity portion 126A. In other words, the magnet 34 of the bit guide 26 moving relative to the supply unit 124 applies a magnetic force, which is larger than the magnetic force of the magnet 136, to the male screw N that is supplied to the cavity portion 126A.

Guide Unit

Next, the guide unit 128, which guides the male screws N to the supply unit 124, will be described.

As shown in FIGS. 33 and 34, the guide unit 128 includes a guide member 140 of which a tip portion extends so as to be inclined downward toward the receiving portion 126C (see FIG. 28) of the cavity portion 126A. In addition, the tip portion of the guide member 140 is opened toward the receiving portion 126C that is formed at the supply target member 126. Further, the guide member 140 is mounted on a side surface 118A of the pillar 118.

That is, from a base end portion of the guide member 140 toward the tip portion of the guide member 140, the guide member 140 extends downward from the upper side in the vertical direction and extends toward a first direction (a direction of an arrow D in the drawings) in the horizontal direction.

Further, the cross-section of a guide passage of the guide member 140, which crosses the longitudinal direction of the guide member 140, is a closed cross-section including a ceiling board 140A, and is formed so that a lower portion of the cross-section of the guide passage in the vertical direction is narrower than an upper portion thereof in the vertical direction. Accordingly, the head portions of the male screws N come into contact with both wall surfaces of the guide passage, so that the head portions of the male screws N are disposed above the screw portions in the vertical direction.

Meanwhile, since the base end portion of the guide member 140 is opened, the male screws N supplied from the male screw supply device 160 to be described below are supplied from the base end portion of the guide member 140.

Further, as shown in FIG. 28, a rectangular through hole 142 is formed at the tip portion of the ceiling board 140A of the guide member 140 and a part of a moving member 132C to be described below is inserted into the guide member 140 from the outside through the through hole 142.

Furthermore, as shown in FIG. 33, a reinforcing plate 154, which extends in the longitudinal direction of the guide member 140, is mounted on the side surface of the guide member 140, and an insertion plate 156, of which a part is inserted into a recess 164A (see FIG. 34) of a regulating plate 164 to be described below, is fixed to the base end portion of the reinforcing plate 154.

Rotational Moving Unit

Next, the rotational moving unit 132 that sequentially supplies the male screws N, which are guided by the guide unit 128, to the supply unit 124 while being rotationally moved will be described.

As shown in FIGS. 20 and 28, the rotational moving unit 132 includes a shaft 132A that extends in a second direction (a direction of an arrow E in the drawings) orthogonal to the above-mentioned first direction in the horizontal direction and is rotatably supported by a support member 144 fixed to the pillar 118.

A base end portion of the swing member 132B of which a tip portion is pressed by the lower end portion of the above-mentioned pressing member 106D is fixed to one end portion of the shaft 132A, and the moving member 132C is fixed to the other end portion of the shaft 132A.

In addition, the rotational moving unit 132 includes a spring member (not shown) that biases the swing member 132B so that the tip portion of the swing member 132B comes into contact with the lower end portion of the pressing member 106D. Accordingly, when the pressing member 106D moves up and down in the vertical direction, the swing member 132B is rotated about the shaft 132A. As a result, the shaft 132A is rotated in the circumferential direction.

Further, the moving member 132C is formed in a substantially semicircular shape, and a part of the moving member 132C is inserted into the guide member 140 through the through hole 142 as described above.

When the shaft 132A is rotated in the circumferential direction of the shaft 132A, the moving member 132C is rotationally moved. Accordingly, the moving member 132C can be moved between a suppression position (see FIG. 20: first position) where a tip portion of the moving member 132C comes into contact with the male screw N present in the guide member 140 so as to suppress the supply of the male screw N to the supply target member 126 and a supply position (see FIG. 28: second position) where the moving member 132C is rotationally moved so as to supply the male screw N having come into contact with the tip portion of the moving member 132C to the supply target member 126 and a rear end portion of the moving member 132C comes into contact with the next male screw N so as to stop the movement of the next male screw N.

According to the above-mentioned structure, the moving member 132C is disposed at the suppression position when the device body 102 is disposed at the lower end position as shown in FIG. 20. In contrast, when the device body 102 is moved to the upper end position as shown in FIG. 28, the swing member 132B pressed by the pressing member 106D is rotated about the shaft 132A and the shaft 132A is rotated in the circumferential direction. Accordingly, the moving member 132C is moved to the supply position.

Support Body Portion

Next, the support body portion 116 that supports the device body 102 so as to allow the device body 102 to move in the vertical direction will be described.

As shown in FIG. 33, the support body portion 116 includes the pillar 118 that supports the slide member 106C of the connection unit 106 of the device body 102 so as to allow the slide member 106C to move in the vertical direction using a rail member (not shown).

In addition, the support body portion 116 includes a plate-like support plate 148 that supports the pillar 118 while the lower end portion of the pillar 118 is fixed to the upper surface of the support plate 148, and the base end side of the supply target member 126 is fitted into a recess 148A formed on the support plate 148, so that the supply target member 126 is fixed to the support plate 148.

Further, a plate member 150 of which the surface faces the vertical direction is fixed to an intermediate portion of the pillar 118 in the vertical direction, and one ends of a pair of link members 152, which allows the screw fastening device 100 to move in the horizontal direction, are fixed to the plate member 150.

Mounting Unit and Male Screw Supply Device

Next, the male screw supply device 160 that supplies male screws N to the guide member 140 of the screw fastening device 100 and the mounting unit 120 that is used to mount the screw fastening device 100 on the male screw supply device 160 will be described.

As shown in FIG. 34, the male screw supply device 160 includes a regulating plate 162 that regulates the position of the support plate 148 of the screw fastening device 100 mounted on the male screw supply device 160. A recess 162A, of which a portion corresponding to the tip side of the guide member 140 in the first direction (hereinafter, simply referred to as the “tip side in the first direction”) is opened when seen from the above and which regulates the support plate 148 in three directions, is formed at the regulating plate 162. When the screw fastening device 100 is moved to the base end side of the guide member 140 in the first direction (hereinafter, simply referred to as the “base end side in the first direction”) so that the support plate 148 is inserted into the recess 162A, the position of the support plate 148 is regulated by the regulating plate 162.

Further, the male screw supply device 160 includes a regulating plate 164 that regulates the position of the base end portion of the guide member 140 of the screw fastening device 100 mounted on the male screw supply device 160. A recess 164A of which a tip portion in one direction is opened is formed at the regulating plate 164 and a part of an insertion plate 156, which is provided at the base end portion of the guide member 140, is inserted into the recess 164A, so that the position of the base end portion of the guide member 140 is regulated by the regulating plate 164.

In addition, the male screw supply device 160 includes a supply member 166 which is connected to the base end portion of the guide member 140 of the screw fastening device 100 mounted on the male screw supply device 160 and through which male screws N supplied to the guide member 140 pass. Further, the supply member 166 is formed so as to extend by the extension of the base end portion of the guide member 140. Furthermore, the cross-section of a supply passage of the supply member 166, which crosses the longitudinal direction of the supply member 166, is formed in the same shape as the shape of the cross-section of the guide passage of the guide member 140, and a tip portion and a base end portion of the supply member 166 are opened. Male screws N to be supplied to the guide member 140 are sent to the opened base end portion of the supply member 166 from a supply body 180 of the male screw supply device 160. Moreover, the male screws N sent into the supply member 166 are supplied to the guide member 140 through the inside of the supply member 166.

Meanwhile, the male screw supply device 160 includes a supply prevention unit 168 that prevents the male screws N from being supplied to the guide member 140.

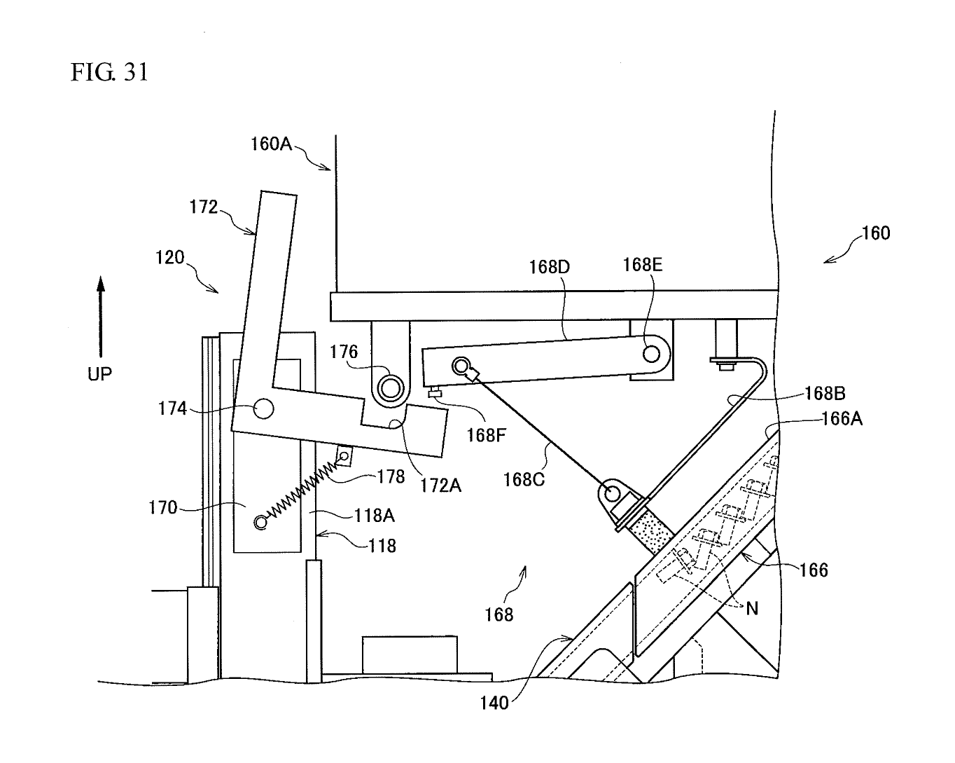

As shown in FIGS. 31 and 34, the supply prevention unit 168 includes a magnet 168A of which one end portion comes into contact with a tip portion of a ceiling board 166A of the supply member 166, a leaf spring 168B of which one end portion is fixed to the magnet 168A and which biases the magnet 168A so that the magnet 168A comes into contact with the ceiling board 166A, a wire 168C of which one end portion is fixed to the other end portion of the magnet 168A, and a swing member 168D of which a tip portion is fixed to the other end portion of the wire 168C.

A base end portion of the swing member 168D is rotatably supported on a supply device body 160A of the male screw supply device 160 by a shaft member 168E.

Here, the mounting unit 120 that is used to mount the screw fastening device 100 on the male screw supply device 160 will be described.

The mounting unit 120 includes a lever member 172 that has an L shape when seen in the above-mentioned second direction, and a shaft member 174 that supports a corner portion of the lever member 172 on a plate member 170 fixed to the side surface 118A of the pillar 118 so as to allow the corner portion to rotate.

Further, a recess 172A into which a columnar pin 176 provided on the supply device body 160A is fitted when the lever member 172 is rotationally moved about the shaft member 174 is formed at a tip portion of the lever member 172. Furthermore, a pressing member 168F, which is pressed by an end face of the lever member 172 when the pin 176 is fitted into the recess 172A, is provided at the tip portion of the swing member 168D.

Moreover, one end of a coil spring 178, which biases the lever member 172 so that the recess 172A is separated from the pin 176, is fixed to the lever member 172 and the other end of the coil spring 178 is fixed to the plate member 170.

According to this structure, when the screw fastening device 100 is not mounted on the male screw supply device 160 as shown in FIG. 31, the lever member 172 of which the moving range is limited by stoppers (not shown) is positioned by a biasing force of the coil spring 178. Accordingly, the lever member 172 is disposed at a separation position where the recess 172A is separated from the pin 176.

Since the magnet 168A comes into contact with the ceiling board 166A of the supply member 166 in this state, a male screw N present in the supply member 166 is attracted to the magnet 168A by the magnetic force of the magnet 168A. For this reason, the supply of the male screw N to the guide member 140 is prevented.

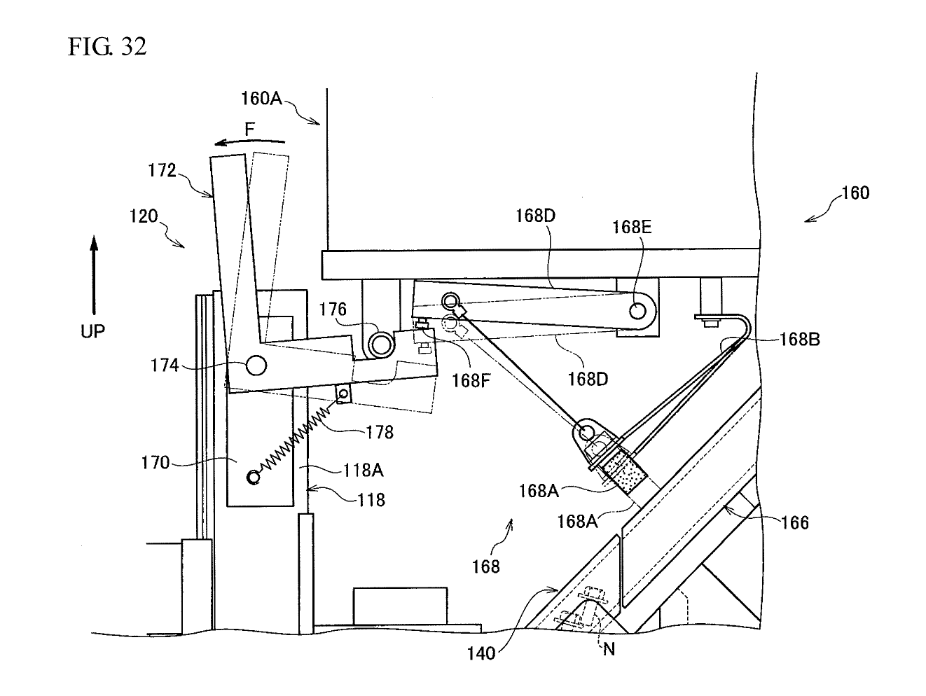

Meanwhile, when the worker grasps a base end portion of the lever member 172 and rotates the lever member 172 in the direction of an arrow F of FIG. 32 as shown in FIG. 32, the lever member 172 is moved to a fitting position where the pin 176 is fitted into the recess 172A. Therefore, the screw fastening device 100 is mounted on the male screw supply device 160.

Accordingly, the tip portion of the lever member 172 presses the pressing member 168F, so that the swing member 168D swings. Therefore, the wire 168C is pulled, so that the magnet 168A is separated from the ceiling board 166A of the supply member 166 by the wire 168C. Since the magnet 168A is separated from the ceiling board 166A of the supply member 166, a magnetic force applied to the male screw N present in the supply member 166 is weakened, so that the supply of the male screw N to the guide member 140 is allowed.

Action

Next, a method of manufacturing a screw-fastened object using the above-mentioned screw fastening device 100 will be described.

In order to mount the screw fastening device 100 on the male screw supply device 160 as shown in FIG. 34, the worker moves the screw fastening device 100, which is supported by the link members 152, toward the base end side in the first direction so that the screw fastening device 100 is mounted on the male screw supply device 160. Further, the worker inserts a part of the insertion plate 156, which is provided at a base end portion of the guide member 140 of the screw fastening device 100, into the recess 164A of the regulating plate 164 of the male screw supply device 160 by inserting the support plate 148 of the screw fastening device 100 into the recess 162A of the regulating plate 162 of the male screw supply device 160.

Accordingly, the position of the support plate 148 is regulated by the regulating plate 162. Moreover, the position of the base end portion of the guide member 140 is regulated by the regulating plate 164, so that the base end portion of the guide member 140 and the tip portion of the supply member 166 are continuously connected to each other.

In this state, as shown in FIGS. 31 and 32, the worker rotationally moves the lever member 172 to move the lever member 172, which is disposed at the separation position (see FIG. 31), to the fitting position where the pin 176 is fitted into the recess 172A (see FIG. 32).

When the lever member 172 is moved to the fitting position as shown in FIG. 32, the pressing member 168F provided at the tip portion of the swing member 168D is pressed by the tip portion of the lever member 172 and the swing member 168D swings about the shaft member 168E.

When the swing member 168D swings, the magnet 168A, which has come into contact with the ceiling board 166A and has prevented the supply of the male screw N to the guide member 140, is pulled in the direction where the magnet 168A is separated from the ceiling board 166A by the wire 168C. Accordingly, the magnet 168A is separated from the ceiling board 166A. Since the magnet 168A is separated from the ceiling board 166A of the supply member 166, a magnetic force applied to the male screw N present in the supply member 166 is weakened, so that the supply of the male screw N to the guide member 140 is allowed. As a result, the male screw N is supplied to the guide member 140.

When male screws N are supplied to the guide member 140 as shown by a solid line of FIG. 21, the device body 102 is disposed at the upper end position due to the biasing force of the coil spring 110 (see FIG. 33) and the moving member 132C is disposed at the supply position. Accordingly, the male screw N supplied to the guide member 140 comes into contact with the rear end portion of the moving member 132C disposed at the supply position, so that the movement of the male screw N is stopped.

The device body 102 is moved to the lower end position from the upper end position in this state, so that the moving member 132C is moved to the suppression position from the supply position (a two-dot chain line of FIG. 21). Since the moving member 132C is moved to the suppression position, the male screw N having come into contact with the rear end portion of the moving member 132C is moved toward the supply target member 126 and comes into contact with the tip portion of the moving member 132C. Accordingly, the supply of the male screw N to the supply target member 126 is suppressed.

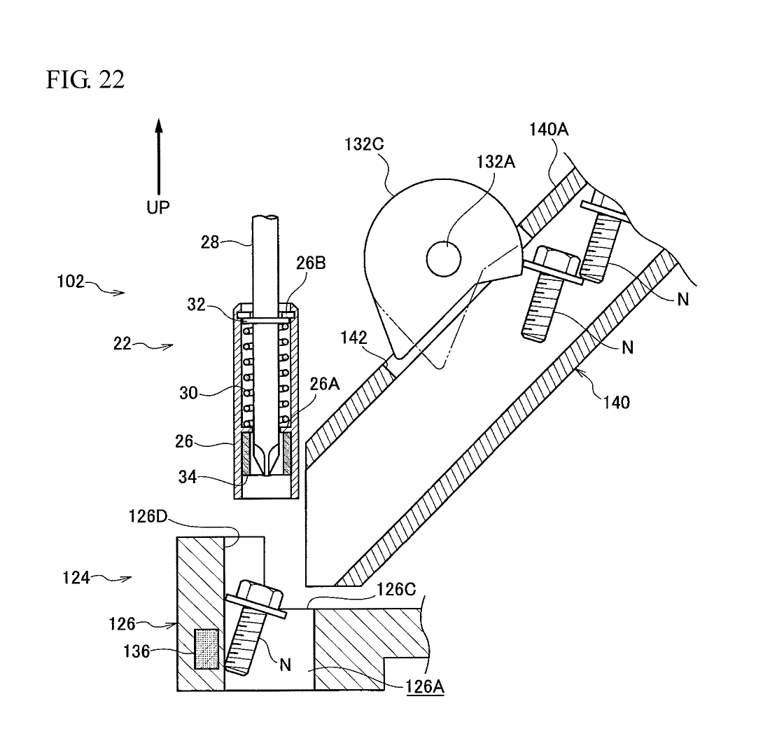

Next, the device body 102 moved to the lower end position is moved to the upper end position and the moving member 132C as shown in FIGS. 21 and 22, so that the moving member 132C is moved to the supply position from the suppression position. Since the moving member 132C is moved to the supply position, the male screw N having come into contact with the tip portion of the moving member 132C is supplied to the supply target member 126 and the rear end portion of the moving member 132C comes into contact with the next male screw N. Accordingly, the movement of the next male screw N is stopped.

As shown in FIGS. 22 and 28, the male screw N supplied to the supply target member 126 is supplied to the cavity portion 126A from the receiving portion 126C. Further, the male screw N supplied to the cavity portion 126A is disposed so as to extend in the vertical direction by the magnetic force of the magnet 136, so that the head portion of the male screw N faces the upper side in the vertical direction. Furthermore, the male screw N is held at that position.

In this state, as shown in FIGS. 31 and 32, the worker rotationally moves the lever member 172, which is disposed at the fitting position, to move the lever member 172 to the separation position where the lever member 172 is separated from the pin 176. Accordingly, the screw fastening device 100 can be opened and moved from the male screw supply device 160 (see FIG. 34). Since the magnet 168A comes into contact with the ceiling board 166A of the supply member 166 in this state, a male screw N present in the supply member 166 is attracted to the magnet 168A by the magnetic force of the magnet 168A. For this reason, the supply of the male screw N to the guide member 140 is prevented.

Meanwhile, as shown in FIG. 23, the worker positions a first member 184 and a second member 186 by disposing a through hole 186A of a plate-like second member 186 in which the through hole 186A is formed so that the through hole 186A overlaps a female screw M of the plate-like first member 184 where the female screw M is provided in a prepared hole 184A (positioning step).

In contrast, as shown in FIG. 34, the worker moves the screw fastening device 100, which can be moved in the horizontal direction by the link members 152, to the tip side in the first direction in order to separate the screw fastening device 100 from the male screw supply device 160. Accordingly, the support plate 148 of the screw fastening device 100 is separated from the recess 162A of the regulating plate 162 and the guide member 140 is separated from the supply member 166.

Further, the worker moves the screw fastening device 100 to the upper side of the through hole 186A (see FIG. 23), which is formed at the above-mentioned second member 186, in the vertical direction.

Next, when the worker moves the device body 102, which is disposed at the upper end position, toward the lower end position as shown in FIGS. 19, 23, and 30, the male screw N, which is supplied to the supply target member 126 and of which the head portion faces the upper side in the vertical direction, approaches the tip portion of the bit guide 26.

Further, before the device body 102 is moved to the lower end position, the head portion of the male screw N is attracted by the magnetic force of the magnet 34. Accordingly, the flange F formed at the head portion of the male screw N comes into contact with the end face of the tip portion of the bit guide 26, so that the position of the male screw N held by the bit guide 26 becomes stable. Furthermore, the worker moves the device body 102 toward the lower end position.

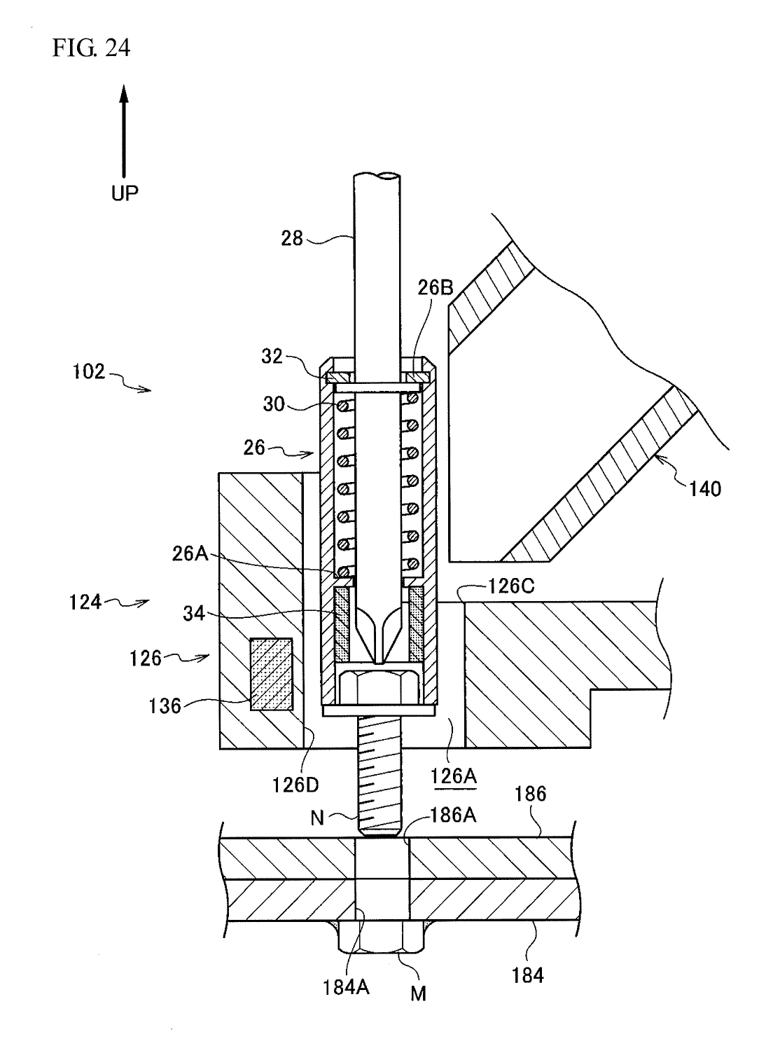

When the worker further moves the device body 102 toward the lower end position as shown in FIGS. 20 and 24, the tip portion of the male screw N, which comes into contact with the bit guide 26 and of which the position is stable, is exposed to the outside from the lower portion of the supply target member 126.

Here, since the magnet 34 applies a magnetic force, which is larger than the magnetic force of the magnet 136, to the male screw N supplied to the supply target member 126 as described above, the male screw N is not separated from the bit guide 26.

Moreover, since the device body 102 is moved toward the lower end position from the upper end position as shown in FIG. 21, the moving member 132C is moved to the suppression position (a two-dot chain line in FIG. 21) from the supply position (a solid line in FIG. 21).

Since the moving member 132C is moved to the suppression position, the next male screw N of which the movement is stopped by the rear end portion of the moving member 132C is separated from the rear end portion and is moved toward the tip portion of the moving member 132C. The male screw N, which is moved toward the tip portion of the moving member 132C, comes into contact with the tip portion of the moving member 132C and is not supplied to the supply target member 126.

Meanwhile, as shown in FIG. 25, the worker presses the tip portion of the male screw N, which comes into contact with the bit guide 26 and of which the position is stable, against the female screw M through the through hole 186A and the prepared hole 184A. Since the male screw N is pressed against the female screw M, the bit guide 26 is moved upward relative to the bit 28 against the biasing force of the coil spring 30 in the vertical direction. Accordingly, the tip portion of the bit 28, which is formed in a cross shape, is inserted into the cross recess of the head portion of the male screw N, so that the bit 28 is interposed between the grip 20 (see FIG. 33) and the male screw N.

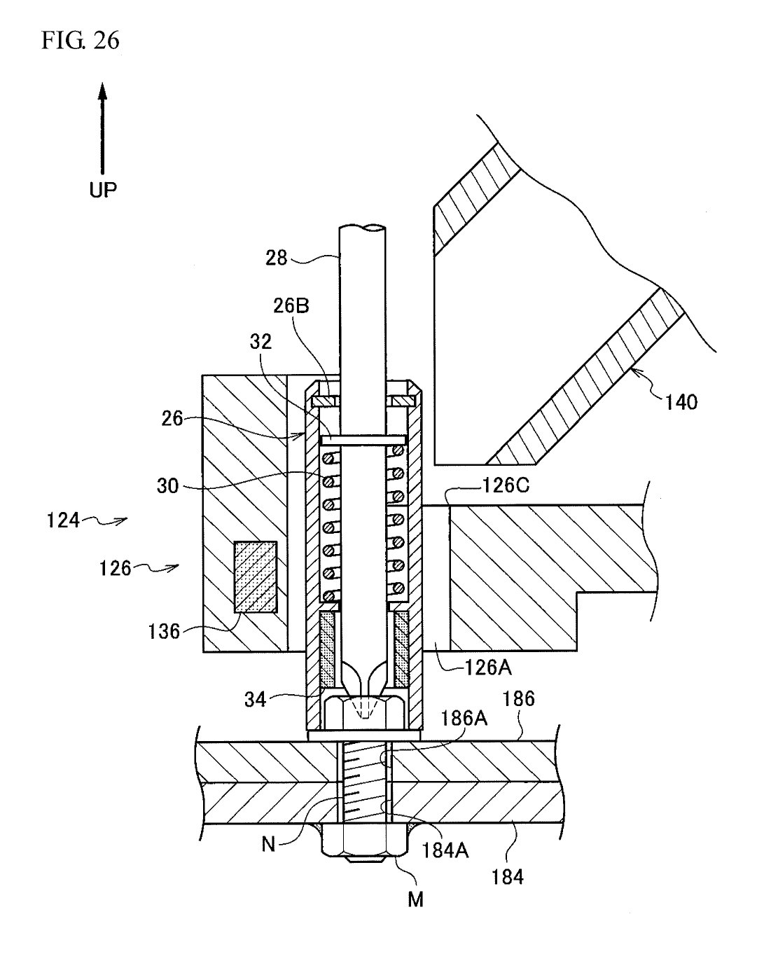

When the bit 28 is interposed between the grip 20 and the male screw N and a compressive load is applied to the bit 28, a motor (not shown) provided in the grip 20 is operated and the bit 28 is rotated. As a result, the male screw N is screwed into the female screw M as shown in FIG. 26 (male screw screwing step).

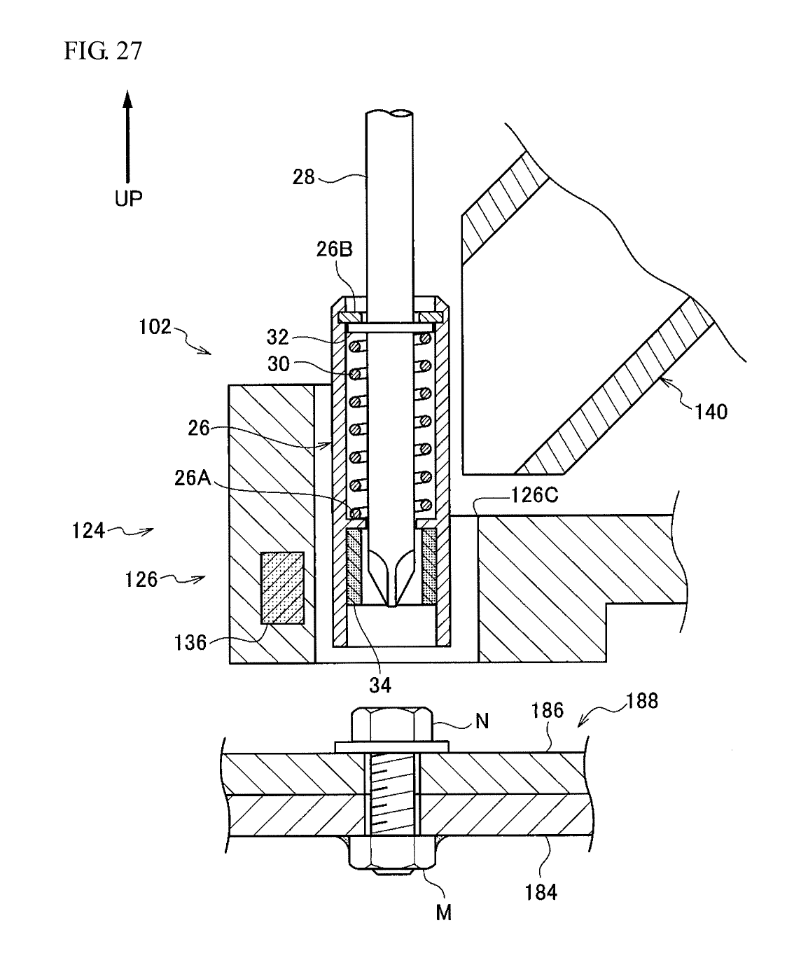

When the screw fastening device 100 is moved upward in the vertical direction as shown in FIG. 27, the male screw N is separated from the screw fastening device 100. As a result, a screw-fastened object 188 using the male screw N is manufactured.

The above-mentioned steps are performed again to further screw another male screw N into another female screw M, so that the male screw N is successively screwed into the female screw M.

The device body 102 is moved in the vertical direction as described above, so that the screw-fastened object 188 is manufactured. Other actions are the same as those of the first exemplary embodiment.

### Third Exemplary Embodiment

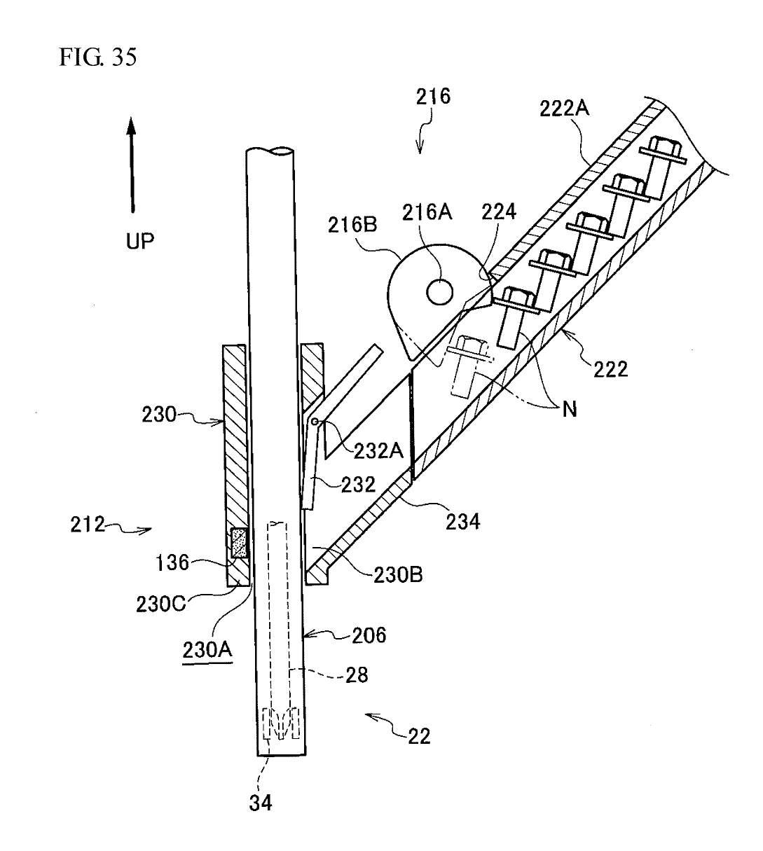

Next, examples of a screw fastening device and a method of manufacturing a screw-fastened object according to a third exemplary embodiment of the invention will be described with reference to FIGS. 35 to 47A and 47B. Meanwhile, the same members as those of the first exemplary embodiment may be denoted by the same reference numerals, and the description thereof may be omitted.

Entire Structure

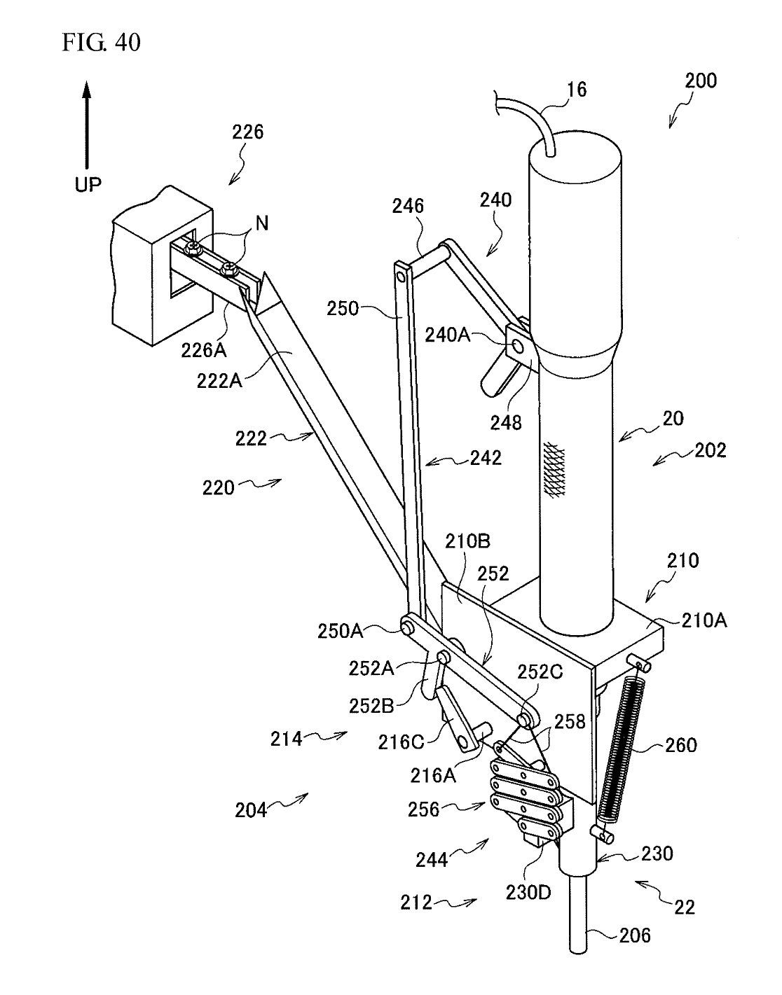

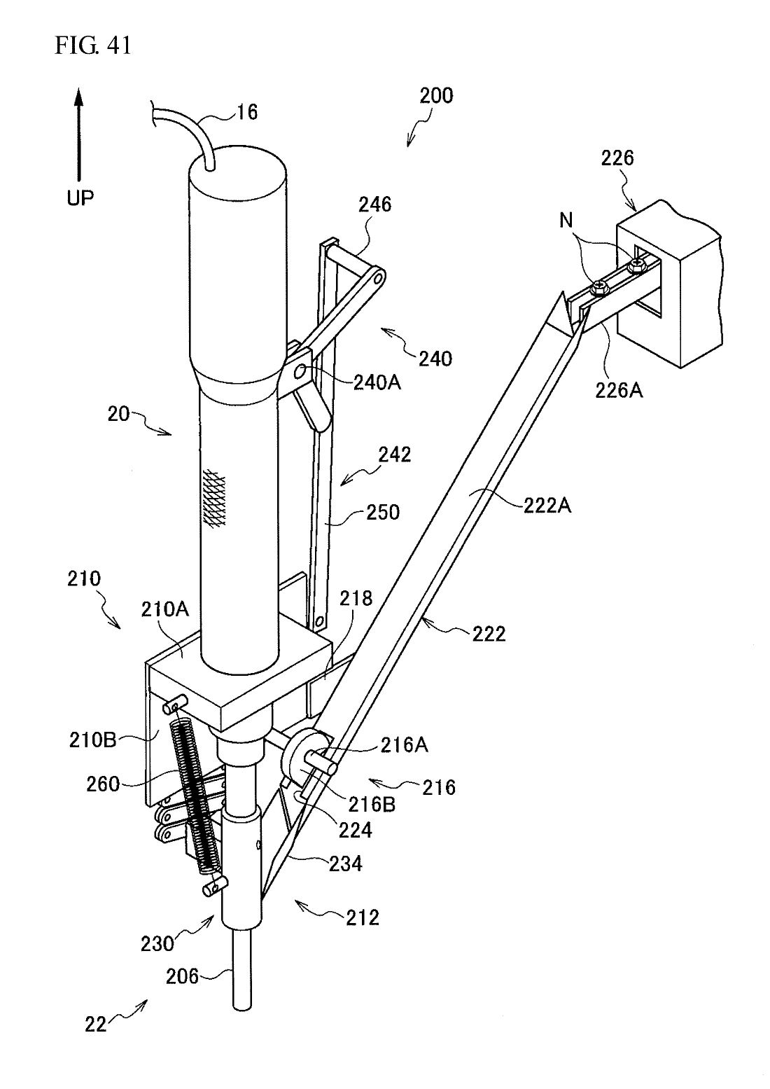

As shown in FIGS. 40 and 41, a screw fastening device 200 according to the third exemplary embodiment is not a device that is used to screw a male screw N into a target in a horizontal direction but a device that is used to screw a male screw N into a target from above in a vertical direction.

The screw fastening device 200 includes a device body 202 to which an end portion of a power supply cord 16 is fixed and a movable section 204 that is supported so as to be movable relative to the device body 202 in a vertical direction.

Device Body Section

The device body 202 includes a columnar grip 20 of which one end portion is fixed to an end portion of the power supply cord 16 and which is held by a worker, an operating unit 22 that includes a bit 28 (see FIG. 35) protruding so as to extend from the other end portion of the grip 20 in one direction (which is a vertical direction in this example) and applying torque to the male screw N, a connection unit 210 that is fixed to the grip 20 and supports the movable section 204, a guide unit 220 that guides male screws N to a supply unit 212 to be described below, and a rotational moving unit 216 that sequentially supplies the male screws N, which are guided by the guide unit 220, to the supply unit 212 while being rotationally moved.

Operating Unit

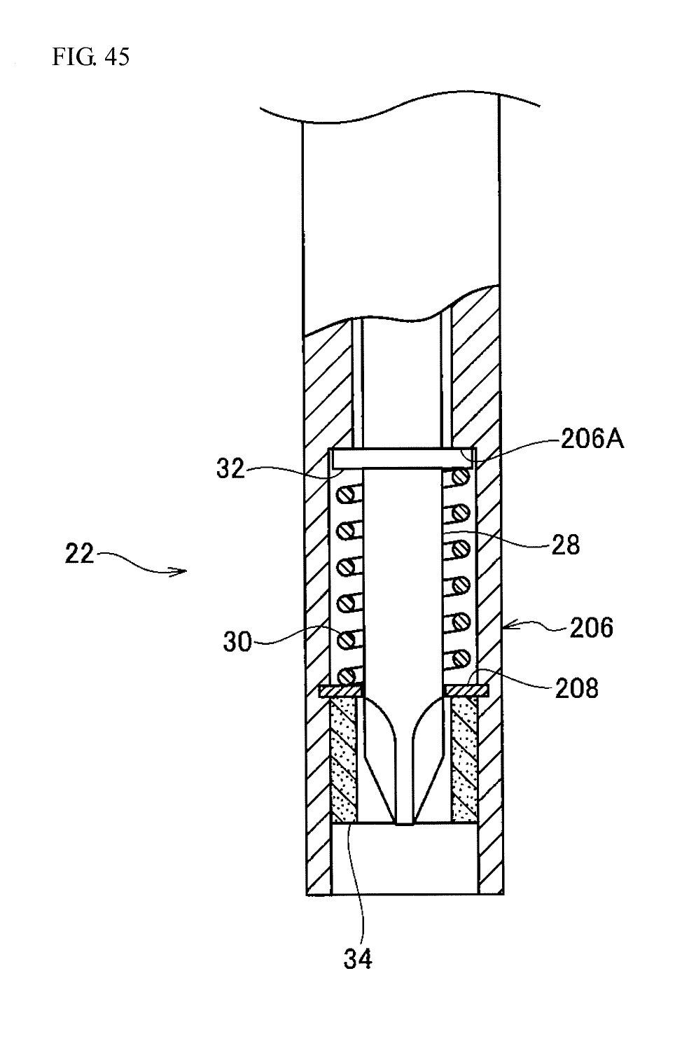

As shown in FIG. 45, a tip portion of the bit 28, which is included in the operating unit 22 and extends downward in the vertical direction, is formed in a cross shape and can be inserted into a cross recess that is formed on a head portion of a male screw N.

In addition, a cylindrical bit guide 206 is provided so as to surround the bit 28. The bit guide 206 is provided so as to extend in the vertical direction, and is supported by the bit 28 so as to be movable relative to the bit 28 in the vertical direction.

A coil spring 30, which biases the bit guide 206 to a side where the bit guide 26 protrudes from the tip portion of the bit 28 (a lower side in the vertical direction), is provided between the bit 28 and the bit guide 206. A base end of the coil spring 30 comes into contact with a ring member 32 that is fixed to the outer peripheral surface of the bit 28, and a tip of the coil spring 30 comes into contact with a ring-shaped protruding portion 208 that is integrally formed on the inner peripheral surface of the bit guide 206 and protrudes inward in the radial direction of the bit guide 206.

In addition, a stepped portion 206A, which comes into contact with the ring member 32, is formed at a base end portion of the bit guide 206 (a portion of the bit guide 206 close to the grip 20 (see FIG. 40)). The stepped portion 206A of the bit guide 206, which is biased downward in the vertical direction by the coil spring 30, comes into contact with the ring member 32 fixed to the bit 28 from above in the vertical direction, so that the bit guide 206 is positioned relative to the bit 28.

Moreover, a cylindrical magnet 34 is provided along the inner peripheral surface of the bit guide 206 on the side, which faces the tip, of a protruding portion 208A of the bit guide 206 so as not to protrude from the tip portion of the bit guide 206.

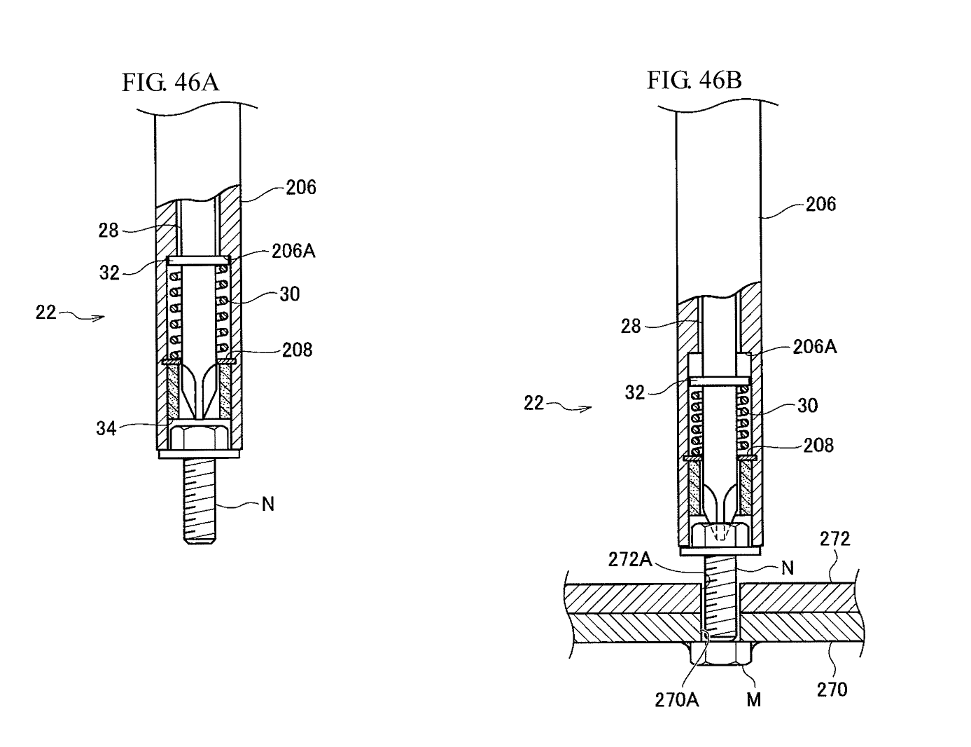

When the male screw N is attracted toward the magnet 34 by the magnetic force of the magnet 34, a flange F formed at the head portion of the male screw N comes into contact with the end face of the tip portion of the bit guide 26 as shown in FIG. 46A so that the male screw N faces one direction (the vertical direction in this exemplary embodiment). Further, the head portion of the male screw N, the bit 28, and the magnet 34 are disposed so as to be separated from each other in this state.

Guide Unit

Next, the guide unit 220, which guides the male screws N to a supply unit 212 to be described below, will be described.

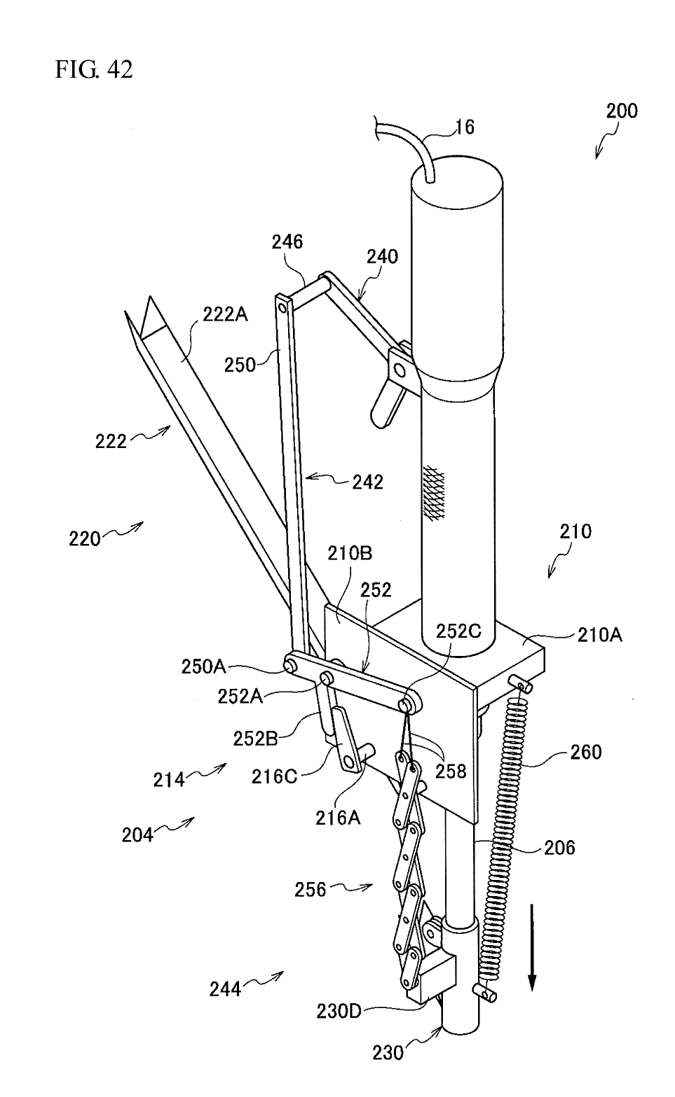

As shown in FIG. 42, the guide unit 220 includes a guide member 222 of which a tip portion extends so as to be inclined downward. The guide member 222 is fixed to one surface of a support plate 210B (the surface of the support plate 210B facing the grip 20) to be described below by a plate-like bracket 218, and the tip portion of the guide member 222 is opened.

The cross-section of a guide passage of the guide member 222, which crosses the longitudinal direction of the guide member 222, is a closed cross-section including a ceiling board 222A, and is formed so that a lower portion of the cross-section of the guide passage in the vertical direction is narrower than an upper portion thereof in the vertical direction. Accordingly, the head portions of the male screws N come into contact with both wall surfaces of the guide passage, so that the head portions of the male screws N are disposed above the screw portions in the vertical direction.

Meanwhile, since a base end portion of the guide member 222 is opened, the male screws N supplied from a male screw supply device 226 are supplied from the base end portion of the guide member 222.

Further, as shown in FIG. 41, a recessed notch 224 is formed at the tip portion of the ceiling board 222A of the guide member 222 and a part of a moving member 216B to be described below is inserted into the guide member 222 from the outside through the notch 224.

Furthermore, when the screw fastening device 200 is mounted on a setting jig (not shown), a rear end portion of the guide member 222 and an end portion of a male screw supply guide 226A of the male screw supply device 226 face each other.

Rotational Moving Unit

Next, the rotational moving unit 216 that sequentially supplies the male screws N, which are guided by the guide unit 220, to the supply unit 212 to be described below while being rotationally moved will be described.

As shown in FIGS. 35 and 41, the rotational moving unit 216 includes a shaft 216A of which one end portion is rotatably supported by the support plate 210B to be described below and which extends in a direction perpendicular to the surface of the support plate 210B (a horizontal direction in this example).

Further, the moving member 216B is fixed to the other end portion of the shaft 216A. The moving member 216B is formed in a substantially semicircular shape, and a part of the moving member 216B is inserted into the guide member 222 through the notch 224 as described above.

When the shaft 216A is rotated in the circumferential direction of the shaft 216A, the moving member 216B is rotationally moved. Accordingly, the moving member 216B can be moved between a suppression position (see a two-dot chain line of FIG. 35: first position) where a tip portion of the moving member 216B comes into contact with the male screw N present in the guide member 222 so as to suppress the supply of the male screw N to the supply unit 212 and a supply position (see a solid line of FIG. 35: second position) where the moving member 216B is rotationally moved so as to supply the male screw N having come into contact with the tip portion of the moving member 216B to the supply unit 212 and a rear end portion of the moving member 216B comes into contact with the next male screw N so as to stop the movement of the next male screw N.

Furthermore, the rotational moving unit 216 includes a spring member (not shown) biases the moving member 216B so that the moving member 216B is disposed at the supply position.

In addition, as shown in FIG. 40, a base end portion of a long swing member 216C is fixed to one end of the shaft 216A passing through the support plate 210B.

Connection Unit

Next, the connection unit 210, which is fixed to the grip 20 and supports the movable section 204, will be described.

As shown in FIGS. 40 and 41, the connection unit 210 includes a rectangular plate-like fixing member 210A which is fixed to the lower portion of the grip 20 in the vertical direction and of which the surface faces the vertical direction. The fixing member 210A is provided with a circular through hole and the lower portion of the grip 20 in the vertical direction is fitted into the through hole, so that the fixing member 210A is fixed to the grip 20. Further, a rectangular plate-like support plate 210B of which the surface faces the horizontal direction and which supports the movable section 204 is mounted on the end face of the fixing member 210A.

Movable Section

Next, the movable section 204, which is supported so as to be movable relative to the device body 202 in the vertical direction, will be described.

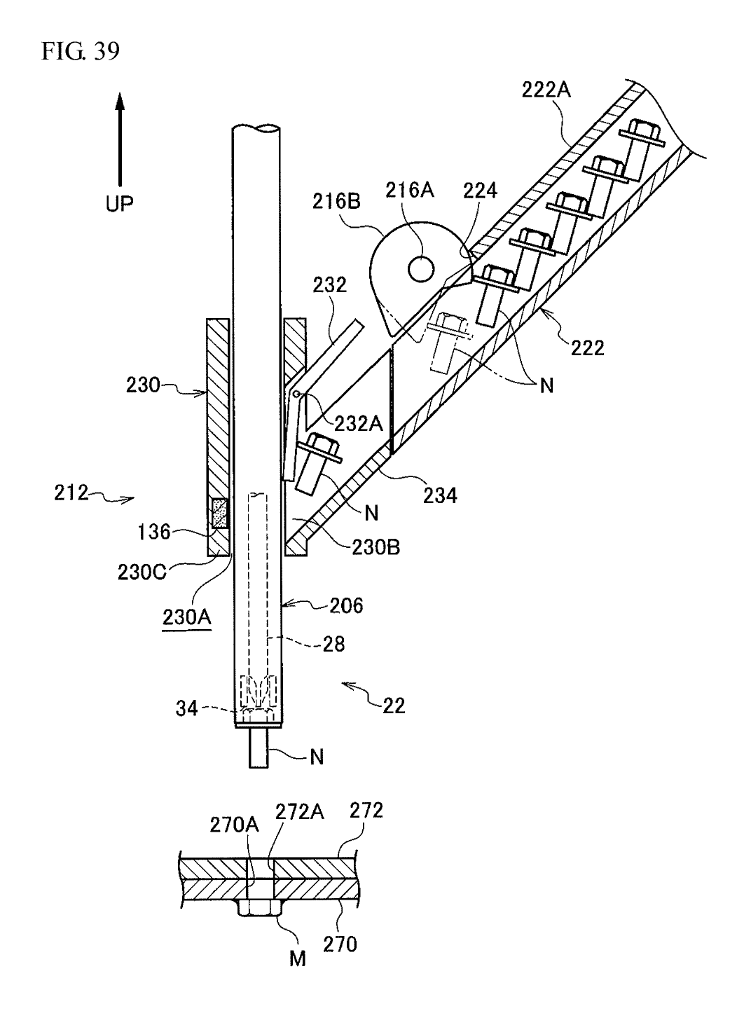

As shown in FIGS. 40 and 41, the movable section 204 includes a supply unit 212 which is movable relative to the device body 202 in the vertical direction and to which a male screw N to be screwed into a female screw M (see FIG. 39) by the bit 28 is supplied, and an actuator 214 that makes the supply unit 212 move relative to the device body 202.

Supply Unit

As shown in FIGS. 35 and 41, the supply unit 212 includes a cylindrical supply target member 230 which extends in the vertical direction (one direction) and includes a cavity portion 230A in which the bit guide 206 is disposed.

A receiving portion 230B, through which the cavity portion 230A is opened to the outside and which receives a male screw N to be supplied to the cavity portion 230A, is formed on the side surface of the supply target member 230. Further, an intermediate member 234, which extends from the receiving portion 230B toward the tip portion of the guide member 222, is formed integrally with the supply target member 230.

The cross-section of a supply passage of the intermediate member 234, which crosses the longitudinal direction of the intermediate member 234, is formed so that a lower portion of the cross-section of the supply passage in the vertical direction is narrower than an upper portion thereof in the vertical direction. Accordingly, the head portions of the male screws N present in the intermediate member 234 are disposed above the screw portions in the vertical direction. Moreover, since the intermediate member 234 is not provided with a ceiling board, the upper portion of the intermediate member 234 in the vertical direction is opened. However, the basic cross□sectional shape of the supply passage of the intermediate member 234 is the same as that of the guide passage of the guide member 222.

Further, the receiving portion 230B is provided with a partition door 232 that partitions the cavity portion 230A from the outside. The partition door 232 is provided with a pivot pin 232A extending along the shaft 216A, and is a plate-like member that includes a bent portion at an intermediate portion thereof when seen in the axial direction of the pivot pin 232A. Furthermore, the pivot pin 232A is provided at the bent portion of the partition door 232.

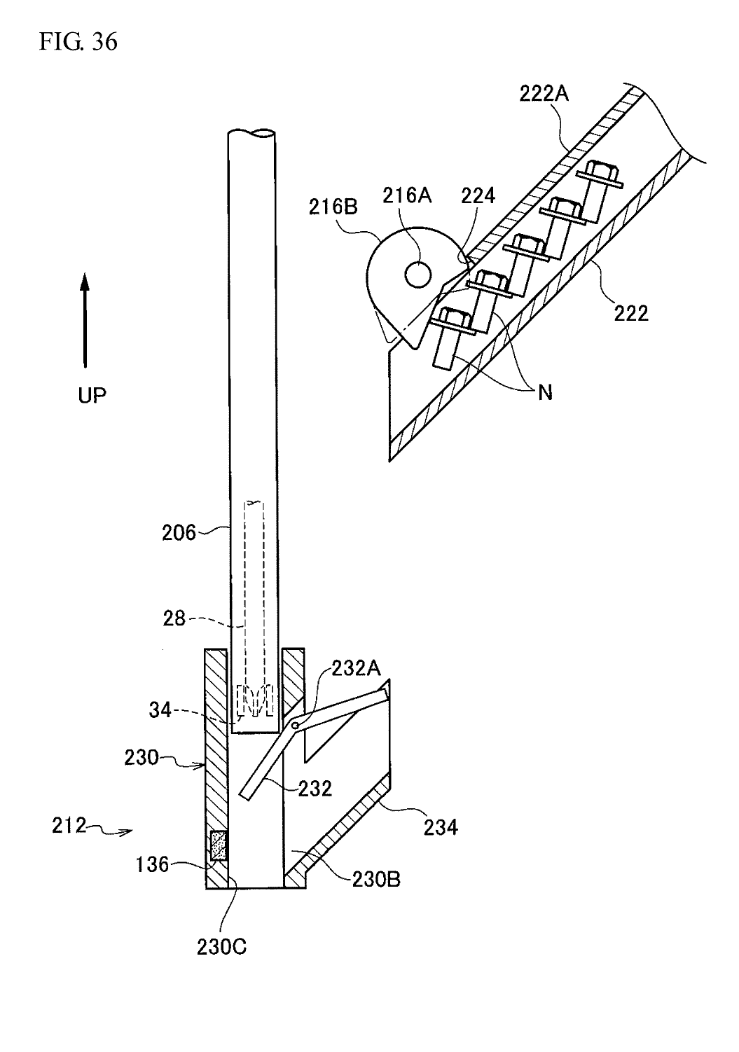

When the bit guide 206 passes through the cavity portion 230A formed in the supply target member 230, the partition door 232 and the bit guide 206 come into contact with each other and the partition door 232 closes the cavity portion 230A (see FIG. 35). Meanwhile, the supply target member 230 may be moved relative to the bit guide 206 so that the supply target member 230 protrudes downward from the bit guide 206. In this case, the partition door 232 is rotated about the pivot pin 232A due to its own weight, so that a part of the partition door 232 enters the cavity portion 230A. Accordingly, the cavity portion 230A is opened (see FIG. 36).

Moreover, a magnet 136 as an example of a first magnet, which makes the male screw N supplied to the cavity portion 230A extend in the vertical direction (one direction) to make a head portion of the male screw N face the upper side (one side) in the vertical direction, is provided in a wall portion 230C of the supply target member 230 facing the receiving portion 230B.

In addition, the magnet 136 applies a magnetic force, which is smaller than the magnetic force of the magnet 34 moving relative to the supply unit 212, to the male screw N that is supplied to the cavity portion 230A. In other words, the magnet 34 moving relative to the supply unit 212 applies a magnetic force, which is larger than the magnetic force of the magnet 136, to the male screw N that is supplied to the cavity portion 230A.

Actuator

Next, the actuator 214, which makes the supply unit 212 move relative to the device body 202, will be described.

As shown in FIGS. 40 and 41, the actuator 214 includes a grip member 240 to which a load is input when the grip member 240 is held by the worker, a link unit 242 that transmits the load input to the grip member 240, and an expanding and contracting unit 244 that moves the supply unit 212 along the bit guide 206 by expanding or contracting due to the load transmitted from the link unit 242.

The grip member 240 is formed in an L shape, and includes a pivot pin 240A that is provided at a bent portion thereof and extends along the shaft 216A. The pivot pin 240A is rotatably supported by a support member 248 that protrudes from the grip 20.

According to this structure, the grip member 240 is rotationally moved about the pivot pin 240A when the worker holds one side of the grip member 240 together with the grip 20.

The link unit 242 includes a first link part 250 which extends in the vertical direction and of which an upper end portion is rotatably mounted on an end portion of the other side of the grip member 240 by a shaft member 246 extending along the pivot pin 240A.

Further, a lower end portion of the first link part 250 is rotatably mounted on one end portion of a second link part 252, which is rotatably mounted on the support plate 210B, by a shaft member 250A. The second link part 252 is formed in the shape of a bar that extends in the horizontal direction, and an intermediate portion of the second link part 252, which is formed between one end portion and the other end portion of the second link part 252, is rotatably mounted on the support plate 210B by a shaft member 252A.

Furthermore, a protruding portion 252B, which extends downward in the vertical direction, is formed integrally with a portion of the second link part 252 between the shaft member 250A and the shaft member 252A. Moreover, a tip portion (lower end portion) of the protruding portion 252B comes into contact with the tip portion of the above-mentioned swing member 216C.

Meanwhile, the expanding and contracting unit 244 is mounted on the other end portion of the second link part 252 as shown in FIGS. 40 and 42.

The expanding and contracting unit 244 includes an expanding and contracting member 256 that can expand and contract in the vertical direction. The expanding and contracting member 256 has a so-called magic hand structure, and includes a plurality of pairs of arm members that are connected to each other so as to be rotatable relative to each other at crossing positions where the arm members cross each other in a substantially X shape.

An upper end portion of the expanding and contracting member 256 is connected to a protrusion 252C, which is provided at the other end portion of the second link part 252, by a pair of wires 258. On the other hand, a lower end portion of the expanding and contracting member 256 is mounted on a tip portion of a protruding portion 230D that protrudes from the outer peripheral surface of the supply target member 230. When the expanding and contracting member 256 contracts, the supply unit 212 is disposed at an upper end position where the intermediate member 234 faces the guide member 222 (see FIGS. 35 and 40). In contrast, when the expanding and contracting member 256 extends, the supply unit 212 is disposed at a lower end portion where a part of the supply target member 230 protrudes downward from the bit guide 206 in the vertical direction (see FIGS. 36 and 42).

Meanwhile, a spring member 260, which biases the supply unit 212 to the upper end position, is provided between the supply target member 230 and the fixing member 210A.

According to this structure, when the worker does not hold the grip member 240 as shown in FIGS. 35 and 40, the supply unit 212 is disposed at the upper end position due to the biasing force of the spring member 260 and the expanding and contracting member 256 contracts. Meanwhile, the moving member 216B is disposed at the supply position (see a solid line of FIG. 35) due to the biasing force of a spring member (not shown), and the tip portion of the swing member 216C and the tip portion of the protruding portion 252B come into contact with each other. Further, the intermediate member 234 and the tip portion of the guide member 222 face each other.

In contrast, when the worker holds the grip member 240 as shown in FIGS. 36 and 42, a load is transmitted to the second link part 252 through the first link part 250 and the second link part 252 including the protruding portion 252B is rotated about the shaft member 252A. Since the protruding portion 252B is rotated, the swing member 216C having come into contact with the protruding portion 252B swings about the shaft 216A. Accordingly, the shaft 216A is rotated, so that the moving member 216B is moved to the suppression position (see a solid line of FIG. 36) from the supply position. Further, since the second link part 252 is rotated, the other end portion of the second link part 252 is moved upward in the vertical direction. When the other end portion of the second link part 252 is moved upward in the vertical direction, a load is transmitted to the expanding and contracting member 256 through the wires 258 and the expanding and contracting member 256 having contracted extends. Therefore, the supply unit 212 is moved to the lower end position.

Action

Next, a method of manufacturing a screw-fastened object using the above-mentioned screw fastening device 200 will be described.

When the screw fastening device 200 is mounted on a setting jig (not shown) as shown in FIGS. 40 and 41, the rear end portion of the guide member 222 and the end portion of the male screw supply guide 226A of the male screw supply device 226 face each other. Further, male screws N are supplied to the guide member 222 from the male screw supply device 226.

Since the worker does not hold the grip member 240 in this state as shown in FIGS. 35 and 40, the supply unit 212 is disposed at the upper end position due to the biasing force of the spring member 260 and the expanding and contracting member 256 contracts. Meanwhile, the moving member 216B is disposed at the supply position (see a solid line of FIG. 35) due to the biasing force of a spring member (not shown) and the tip portion of the swing member 216C and the tip portion of the protruding portion 252B come into contact with each other. When the moving member 216B is disposed at the supply position, the male screw N supplied to the guide member 222 comes into contact with the rear end portion of the moving member 216B disposed at the supply position. Accordingly, the movement of the male screw N is stopped. Further, the intermediate member 234 and the tip portion of the guide member 222 face each other.

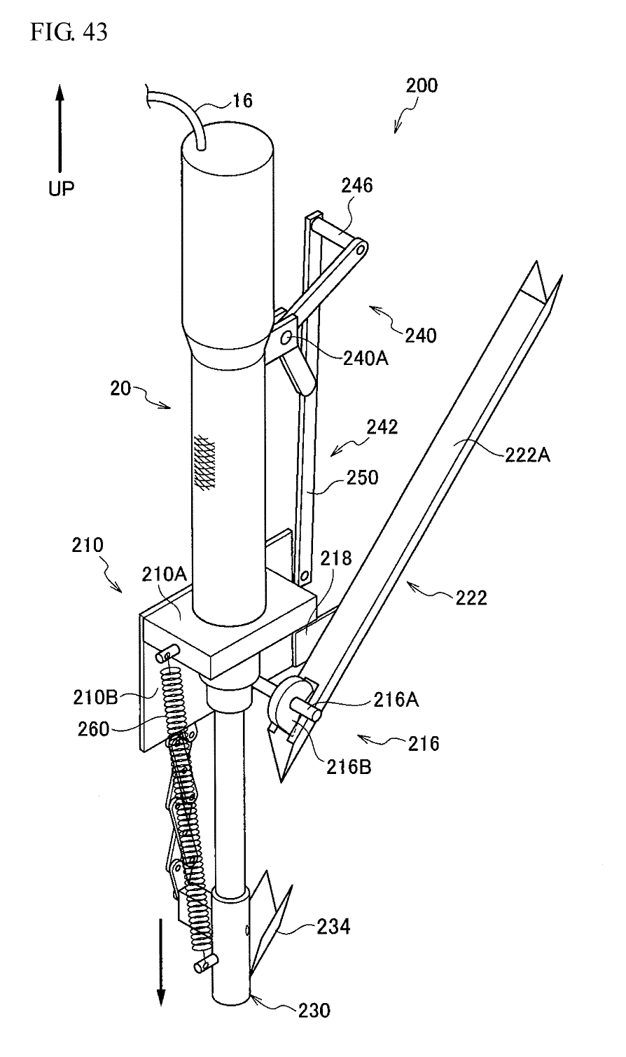

Next, as shown in FIGS. 42 and 43, the worker holds the grip member 240 after separating the screw fastening device 200 from the setting jig.

When the worker holds the grip member 240, a load is transmitted to the second link part 252 through the first link part 250 and the second link part 252 including the protruding portion 252B is rotated about the shaft member 252A. Since the protruding portion 252B is rotated, the swing member 216C having come into contact with the protruding portion 252B swings about the shaft 216A.

Accordingly, as shown in FIGS. 35 and 36, the moving member 216B disposed at the supply position is moved to the suppression position. Therefore, the male screw N having come into contact with the rear end portion of the moving member 216B is moved toward the supply target member 230 and comes into contact with the tip portion of the moving member 216B, so that the supply of the male screw N to the supply target member 126 is suppressed.

Further, when the second link part 252 is rotated as shown in FIGS. 42 and 43, the other end portion of the second link part 252 is moved upward in the vertical direction and a load is transmitted to the expanding and contracting member 256 through the wires 258. Accordingly, the expanding and contracting member 256 having contracted extends, so that the supply unit 212 is moved to the lower end position.

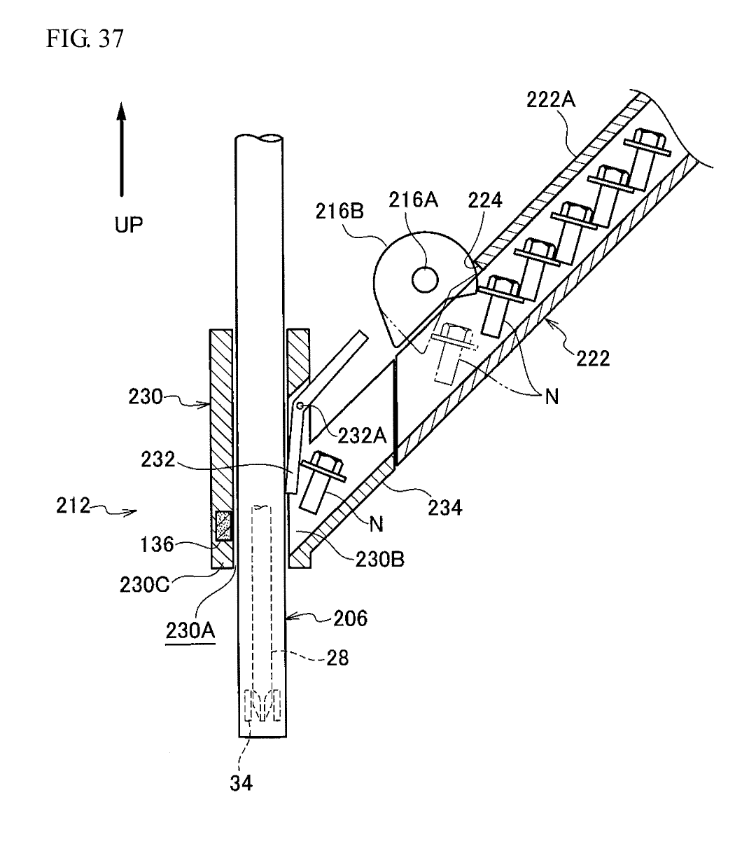

Next, when the worker releases the grip member 240, the supply unit 212 is moved to the upper end position due to the biasing force of the spring member 260 as shown in FIGS. 37 and 40. Accordingly, the expanding and contracting member 256 contracts, so that the second link part 252 is rotated in a reverse direction. Moreover, since the supply unit 212 is moved to the upper end position, the intermediate member 234 and the tip portion of the guide member 222 face each other.

Since the second link part 252 is rotated in the reverse direction, the swing member 216C and the shaft 216A are rotated in the reverse direction and the moving member 216B disposed at the suppression position is moved to the supply position. Accordingly, the male screw N having come into contact with the tip portion of the moving member 216B is supplied to the supply unit 212 and the rear end portion of the moving member 216B and the next male screw N come into contact with each other, so that the movement of the next male screw N is stopped.

As shown in FIG. 37, the male screw N supplied to the supply unit 212 comes into contact with the partition door 232, which closes the cavity portion 230A by coming into contact with the bit guide 206, and stops in front of the receiving portion 230B.

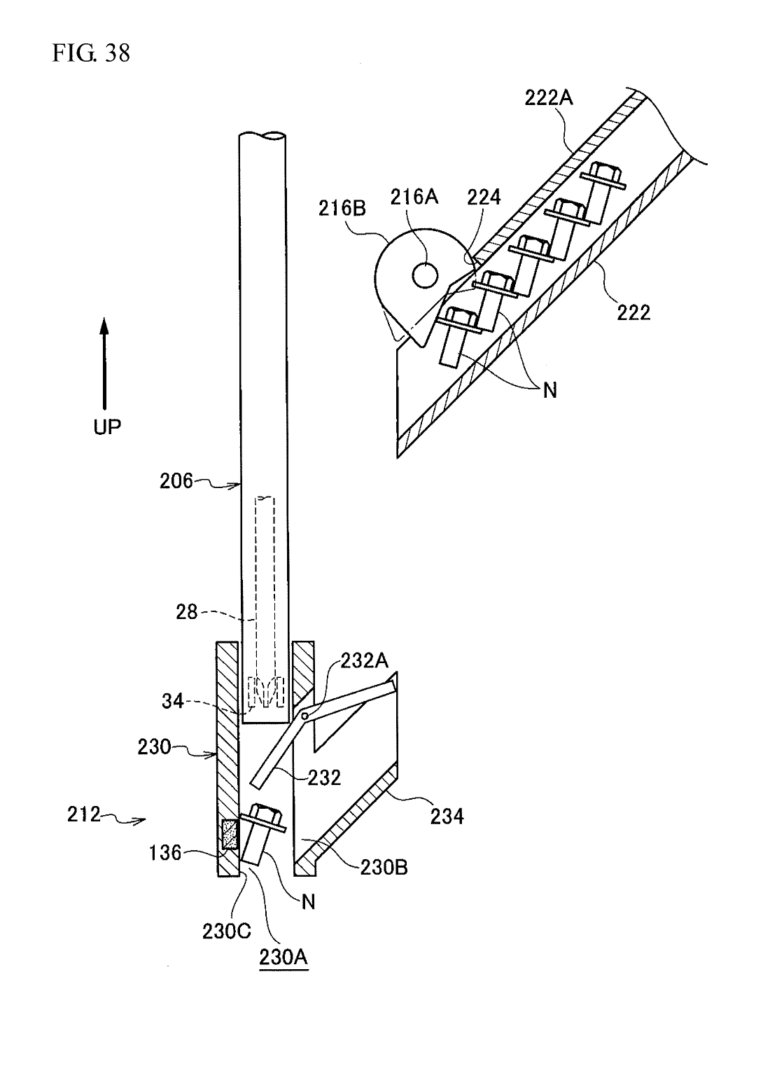

Next, as shown in FIG. 38, the supply unit 212 is moved to the lower end position and the moving member 216B is moved to the suppression position as described above when the worker holds the grip member 240.

Since the supply unit 212 is moved to the lower end position, a part of the supply target member 230 protrudes downward from the bit guide 206 in the vertical direction. Accordingly, the partition door 232 opens the cavity portion 230A. Since the partition door 232 opens the cavity portion 230A, the male screw N having stopped in front of the receiving portion 230B is supplied to the cavity portion 230A from the receiving portion 230B. In addition, the male screw N supplied to the cavity portion 230A is disposed so as to extend in the vertical direction (one direction) by the magnetic force of the magnet 136 and the head portion of the male screw N faces the upper side (one side) in the vertical direction.

Further, since the moving member 216B is moved to the suppression position, the male screw N having come into contact with the rear end portion of the moving member 216B is moved toward the supply target member 230 and comes into contact with the tip portion of the moving member 216B. Accordingly, the supply of the male screw N to the supply target member 126 is suppressed.

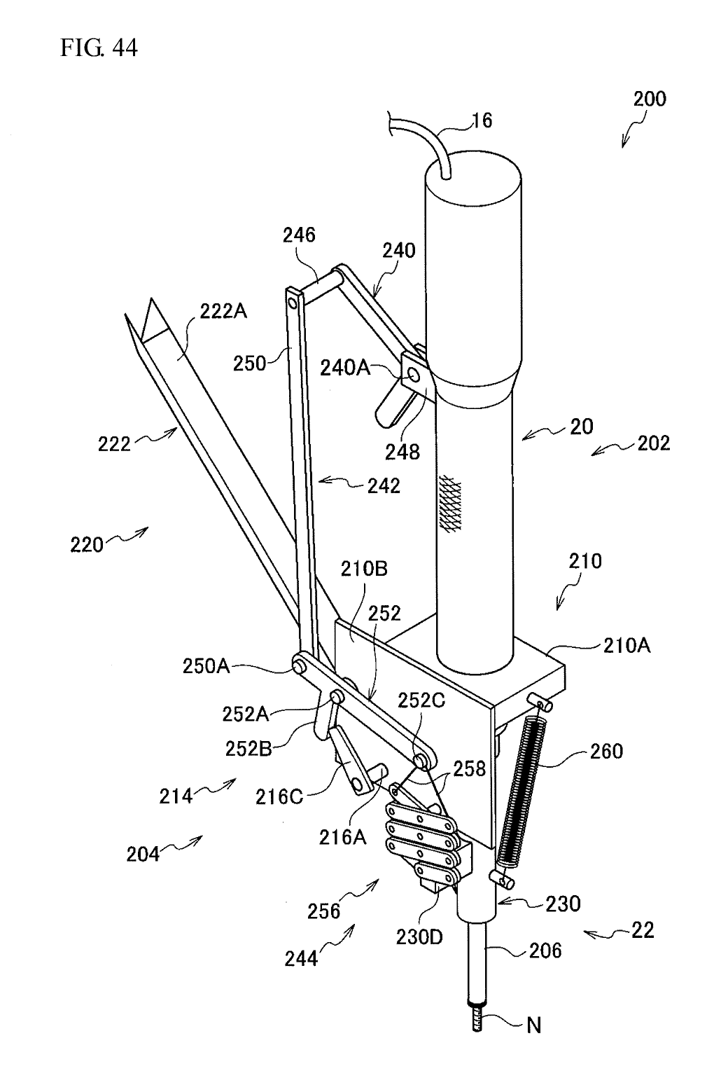

Next, when the worker releases the grip member 240, the supply unit 212 is moved to the upper end position from the lower end position and the moving member 216B is moved to the supply position as described above as shown in FIGS. 39 and 44.

Here, while the supply unit 212 disposed at the lower end position is moved to the upper end position, the male screw N, which is supplied to the supply target member 230 and of which the head portion faces the upper side in the vertical direction, approaches the tip portion of the bit guide 206.

Before the supply unit 212 is moved to the upper end position, the head portion of the male screw N is attracted by the magnetic force of the magnet 34. Accordingly, the flange F formed at the head portion of the male screw N comes into contact with the end face of the tip portion of the bit guide 206, so that the position of the male screw N becomes stable. Further, the tip portion of the male screw N, which comes into contact with the bit guide 206 and of which the position is stable, is exposed to the outside from the lower portion of the supply target member 230.

Here, since the magnet 34 applies a magnetic force, which is larger than the magnetic force of the magnet 136, to the male screw N supplied to the supply target member 230 as described above, the male screw N is not separated from the bit guide 206.

Moreover, the partition door 232 closes the cavity portion 230A by coming into contact with the bit guide 206.

In addition, since the moving member 216B is moved to the supply position, the male screw N having come into contact with the tip portion of the moving member 216B is supplied to the supply unit 212 and the rear end portion of the moving member 216B and the next male screw N come into contact with each other. Accordingly, the movement of the next male screw N is stopped.

Meanwhile, as shown in FIG. 39, the worker positions the first member 270 and the second member 272 by disposing the through hole 272A of the plate-like second member 272 in which the through hole 272A is formed so that the through hole 272A overlaps the female screw M of the plate-like first member 270 where the female screw M is provided in the prepared hole 270A (positioning step).

Next, as shown in FIG. 39 and FIGS. 46A and 46B, the worker presses the tip portion of the male screw N, which comes into contact with the bit guide 206 and of which the position is stable, against the female screw M through the through hole 272A and the prepared hole 270A. Since the male screw N is pressed against the female screw M, the bit guide 206 is moved upward relative to the bit 28 against the biasing force of the coil spring 30 in the vertical direction. Accordingly, the tip portion of the bit 28, which is formed in a cross shape, is inserted into the cross recess of the head portion of the male screw N, so that the bit 28 is interposed between the grip 20 (see FIG. 40) and the male screw N.

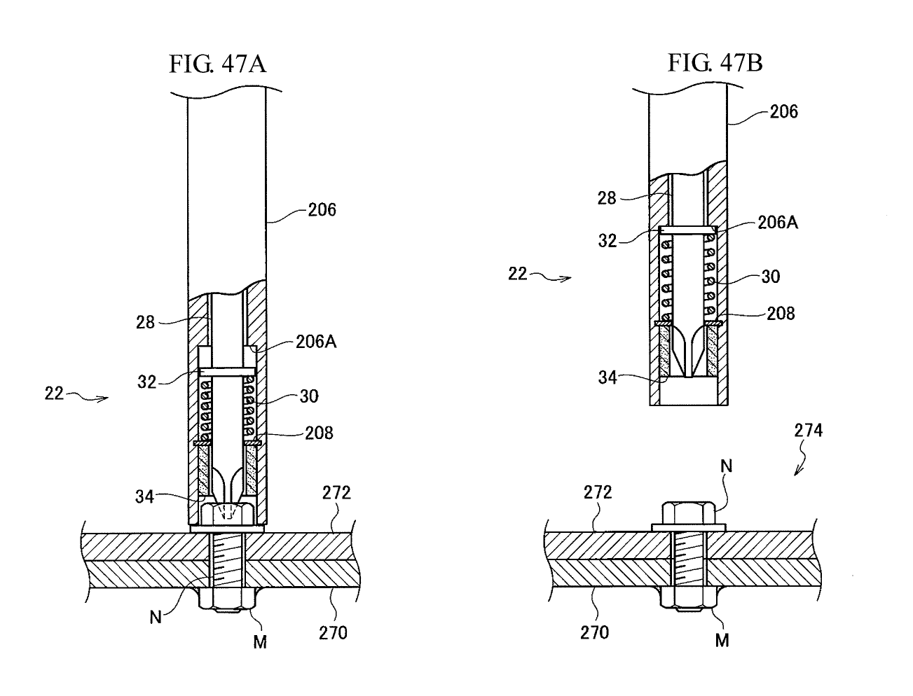

When the bit 28 is interposed between the grip 20 and the male screw N and a compressive load is applied to the bit 28, a motor (not shown) provided in the grip 20 (see FIG. 40) is operated and the bit 28 is rotated. When the bit 28 is rotated, the male screw N is screwed into the female screw M as shown in FIG. 47A (male screw screwing step).

When the screw fastening device 200 is moved upward in the vertical direction as shown in FIG. 47B, the screw fastening device 200 is separated from the male screw N. As a result, a screw-fastened object 274 using the male screw N is manufactured.

The above-mentioned steps are performed again to further screw another male screw N into another female screw M, so that the male screw N is successively screwed into the female screw M.

When the grip member 240 is operated by the hand that holds the grip 20 as described above, the male screw N is supplied to the supply unit 212. Other actions are the same as those of the first exemplary embodiment.

### Fourth Exemplary Embodiment

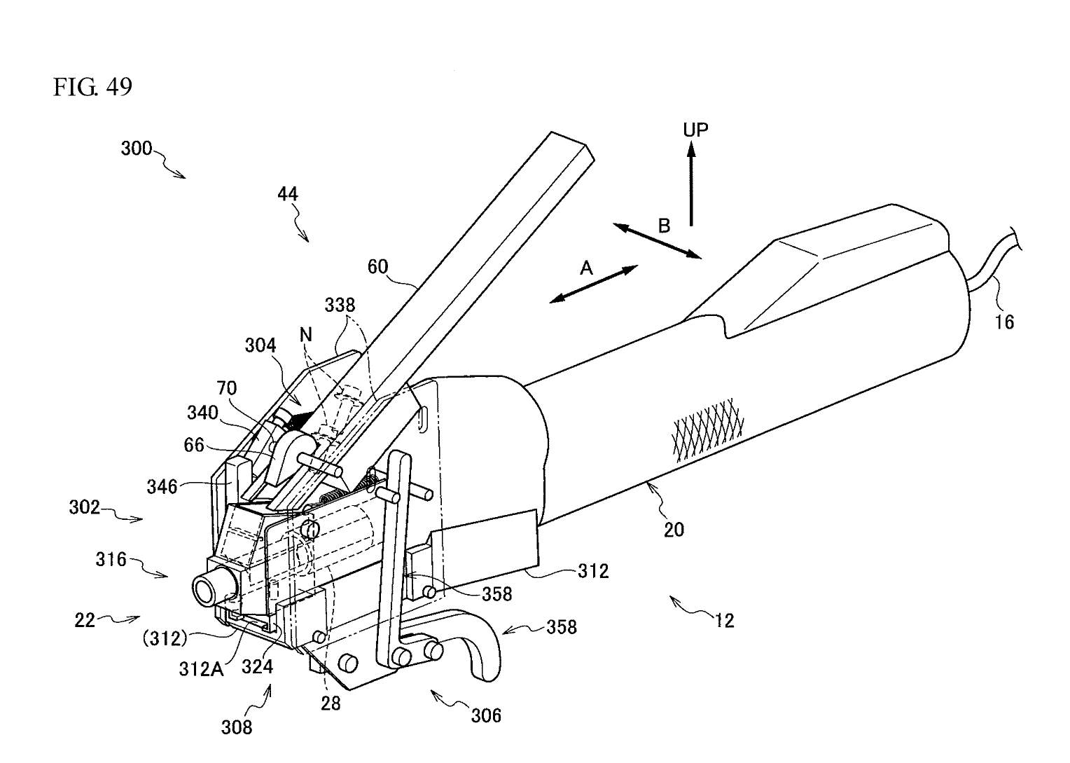

Next, examples of a screw fastening device and a method of manufacturing a screw-fastened object according to a fourth exemplary embodiment of the invention will be described with reference to FIGS. 49 to 61. Meanwhile, the same members as those of the first exemplary embodiment may be denoted by the same reference numerals, and the description thereof may be omitted.

Entire Structure

As shown in FIG. 49, a screw fastening device 300 is a device that is used to screw a male screw N into a target in a horizontal direction. The screw fastening device 300 includes a device body 12 to which an end portion of a power supply cord 16 is fixed, a moving section 302 that is supported so as to be movable relative to the device body 12 in a vertical direction, a guide unit 44 that is fixed to the device body 12 and guides the male screws N to the moving section 302, a rotational moving unit 304 that sequentially supplies the male screws N, which are guided by the guide unit 44, to the moving section 302 while being rotationally moved, and an operating unit 306 as an example of an operating member that makes the moving section 302 move relative to the device body 12.

Device Body

The device body 12 includes a grip 20 as an example of a columnar grip portion of which one end portion is fixed to an end portion of the power supply cord 16 and which is held by a worker, an operating unit 22 that includes a bit 28 extending from the other end portion of the grip 20 in one direction (a direction of an arrow A), and a connection unit 308 of which one end portion is fixed to the grip 20 and the other end portion supports a base 324 to be described below included in the moving section 302 so as to allow the base 324 to move.

Connection Unit

The connection unit 308 includes a base member 312 of which a base end portion in one direction is fixed to the lower surface of the grip 20 and which protrudes and extends from the grip 20 toward the tip side in one direction.

A rail portion 312A, which extends in one direction and has a recessed cross-section, is formed on the upper surface of a portion of the base member 312 that protrudes from the grip 20, and the base 324 to be described below is movably supported by the rail portion 312A.

Moving Section

Next, the moving section 302, which is supported so as to be movable relative to the device body 12, will be described.

The moving section 302 includes a supply unit 316 which is supported so as to be movable relative to the device body 12 in one direction and to which male screws N to be screwed into female screws M (see FIG. 15) by the bit 28 are supplied from the guide unit 44.

Supply Unit

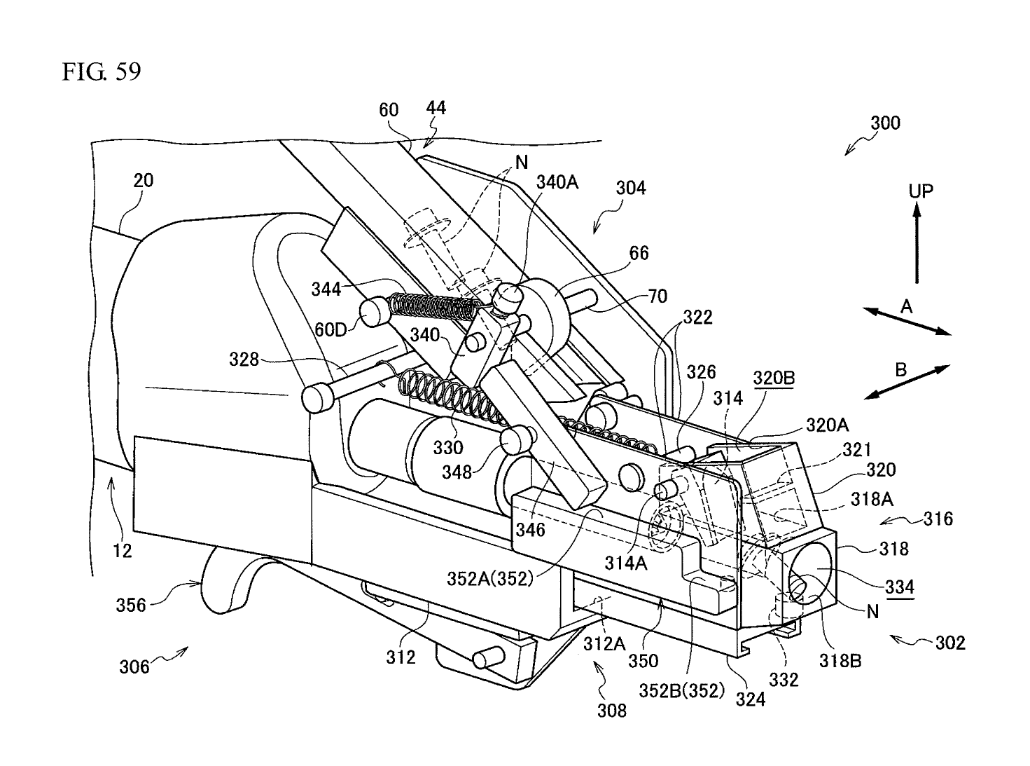

As shown in FIG. 59, the supply unit 316 includes a supply target member 318 that extends in one direction and has a rectangular cross-section, and an intermediate member 320 that is formed integrally with the supply target member 318, receives the male screws N from the guide unit 44, and supplies the male screws N to the supply target member 318.

In addition, the supply unit 316 includes a pair of plate members 322 between which the supply target member 318 is interposed in an orthogonal direction (a direction of an arrow B) and which is fixed to the supply target member 318, and the base 324 that is fixed to the lower surface of the supply target member 318 and is movably supported by the above-mentioned rail portion 312A

A part of the plate members 322 protrude upward from the supply target member 318, and a rod 326, which stretches between the pair of plate members 322, is mounted on the protruding portions of the plate members 322. Further, a rod 328, which extends in the orthogonal direction, is mounted on the tip portion of the grip 20 in one direction.

Furthermore, the moving section 302 includes a coil spring 330 of which one end is mounted on the rod 326 and the other end is mounted on the rod 328 and which extend in one direction, and the supply unit 316 is biased to the base end side in one direction by the biasing force of the coil spring 330.

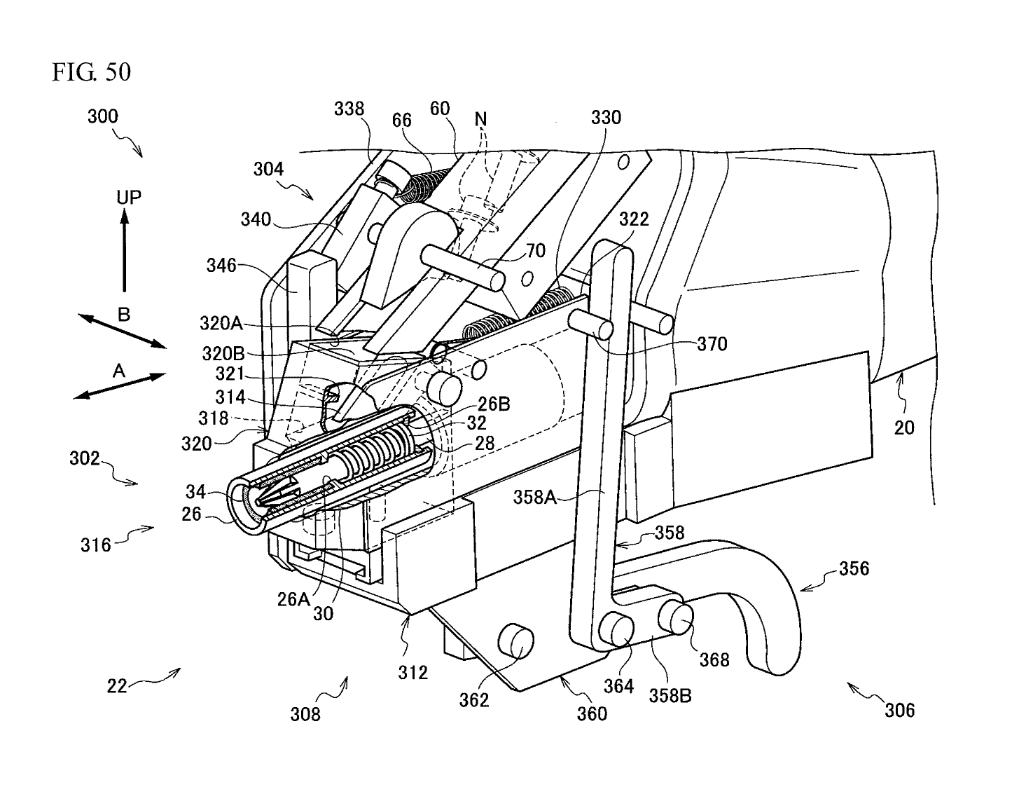

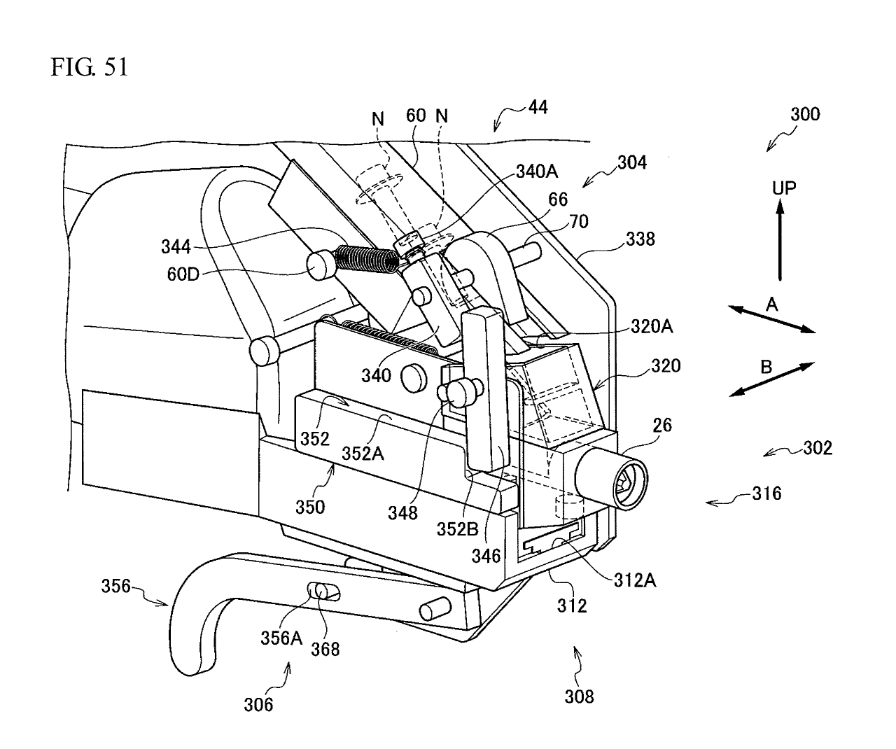

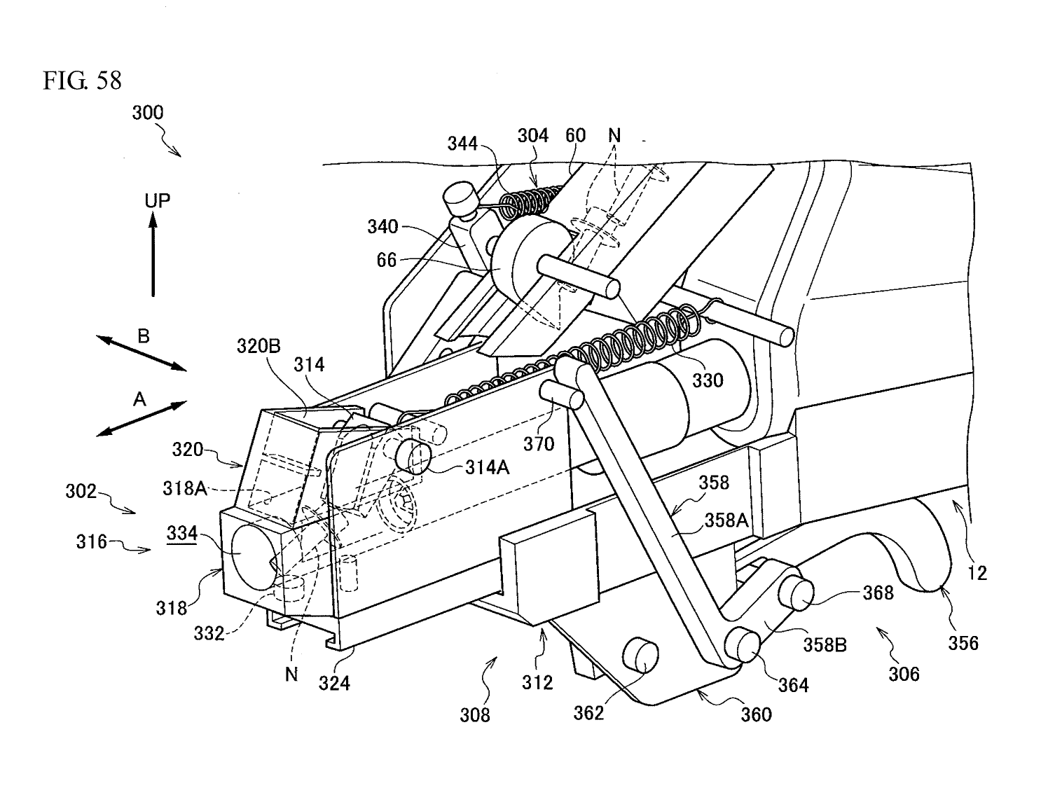

Moreover, the moving range of the supply unit 316 is limited by stoppers (not shown), and the supply unit 316 is supported by the connection unit 308 so as to be movable between a base end position (see FIGS. 50 and 51) where the supply unit 316 has been moved relative to the device body 12 toward the base end side in one direction and a tip position (see FIGS. 58 and 59) where the supply unit 316 has been moved relative to the device body 12 toward the tip side in one direction.

Further, a cavity portion 334, which extends in one direction and has a circular cross-section, to which a male screw N is supplied, and through which a bit guide 26 passes, is formed in the supply target member 318. Furthermore, a receiving opening 318A as an example of a rectangular receiving portion, which receives the male screw N supplied to the cavity portion 334 from the intermediate member 320, is formed on the upper surface of the supply target member 318.

Moreover, a magnet 332 as an example of a first magnet, which disposes the male screw N supplied to the cavity portion 334 by a magnetic force so that the male screw N extends in one direction and makes the head portion of the male screw N face the base end side in one direction (one side), is provided in a portion of a wall portion 318B of the supply target member 318 facing the receiving opening 318A. The magnet 332 is disposed below a screw portion of the male screw N of which the head portion faces the base end side in one direction.

In addition, the magnet 332 applies a magnetic force, which is smaller than the magnetic force of the magnet 34 (see FIG. 50) of the bit guide 26 moving relative to the supply unit 316, to the male screw N supplied to the cavity portion 334. In other words, the magnet 34 of the bit guide 26 moving relative to the supply unit 316 applies a magnetic force, which is larger than the magnetic force of the magnet 332, to the male screw N that is supplied to the cavity portion 334.

Meanwhile, the moving member 66 is rotationally moved, so that a male screw N is supplied to the intermediate member 320, which supplies the male screws N to the supply target member 318, from the guide unit 44.

The intermediate member 320 includes a supply port 320A to which a male screw N is supplied from the guide unit 44, and a hollow holding portion 320B that primarily holds the male screw N supplied from the supply port 320A and is continued to the receiving opening 318A of the supply target member 318.

In addition, a widening-narrowing member 314, which widens or narrows an opening formed of the receiving opening 318A, is provided on the base end side of the holding portion 320B in one direction. The widening-narrowing member 314 is rotatably supported by a shaft member 314A that extends in the orthogonal direction. Further, the widening-narrowing member 314 is rotationally moved about the shaft member 314A, so that a free end portion of the widening-narrowing member 314 is moved to widen or narrow the opening formed of the receiving opening 318A.

Further, a catch portion 321 (see FIG. 50) by which a head of the male screw N passing through the holding portion 320B and the receiving opening 318A of the supply target member 318 is temporarily caught is formed on the wall surface that faces the widening-narrowing member 314 with the holding portion 320B interposed therebetween so as to protrude toward the holding portion 320B.

In this structure, the free end portion of the widening-narrowing member 314 comes into contact with the bit guide 26 as shown in FIGS. 50 and 51 when the moving section 302 is disposed at the base end position. In this state, the opening formed of the receiving opening 318A is narrowed by the widening-narrowing member 314. Accordingly, the male screw N held by the holding portion 320B does not pass through the receiving opening 318A. Further, the supply port 320A of the intermediate member 320 faces a lower end portion of the guide member 60, so that a male screw N can be supplied to the holding portion 320B from the guide member 60 through the supply port 320A.

Meanwhile, when the moving section 302 is moved to the tip side in one direction from the base end position and the free end portion of the widening-narrowing member 314 and the bit guide 26 are separated from each other, the widening-narrowing member 314 is rotated about the shaft member 314A as shown in FIGS. 58 and 59. Accordingly, the opening formed of the receiving opening 318A is widened. In this state, the male screw N held by the holding portion 320B passes through the receiving opening 318A.

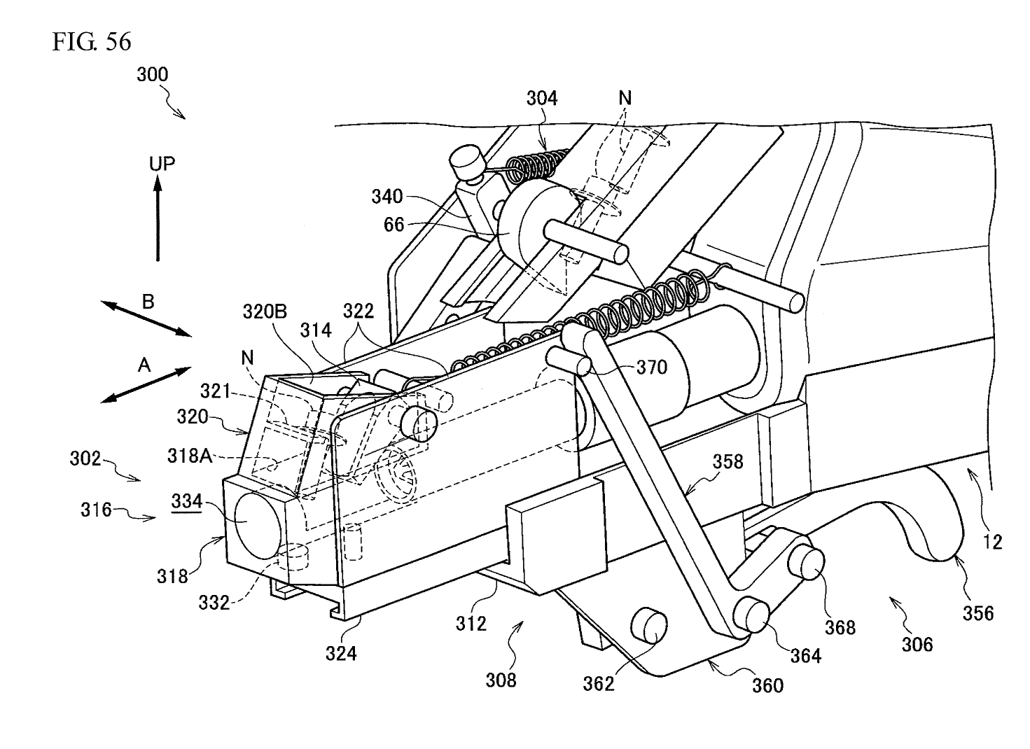

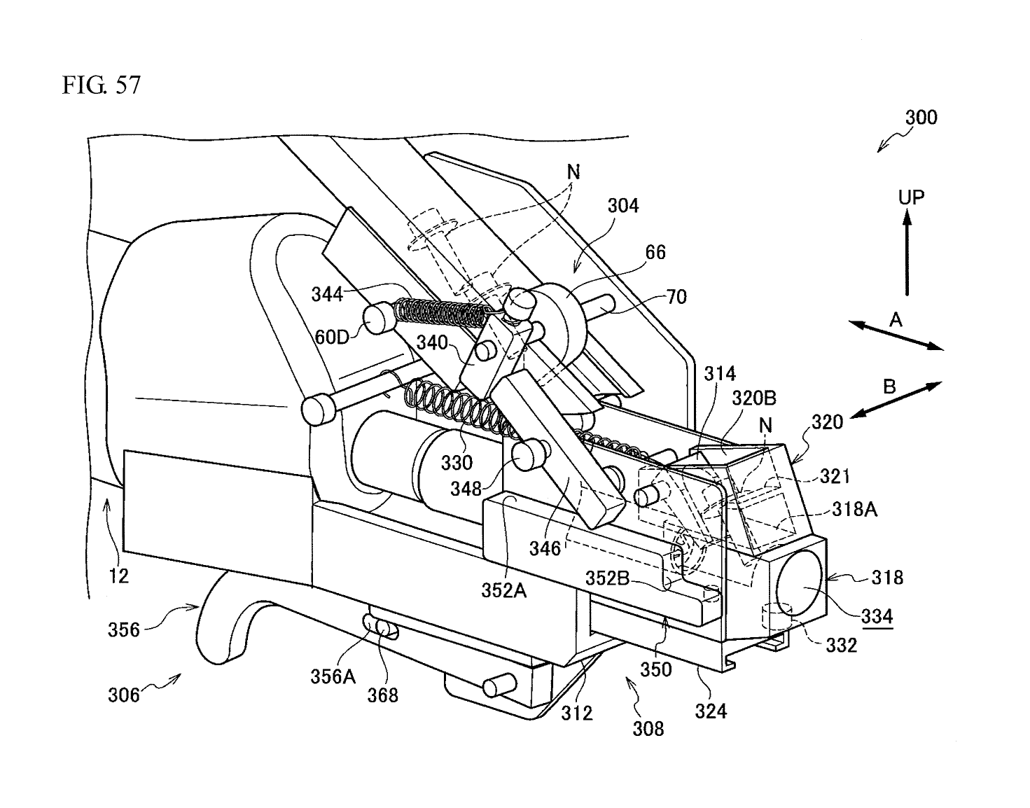

Here, when the male screw N passes through the receiving opening 318A while the widening-narrowing member 314 is rotated about the shaft member 314A so that the opening formed of the receiving opening 318A is widened, the head portion of the male screw N is caught by the catch portion 321 once as shown in FIGS. 56 and 57. Further, the male screw N is supplied to the cavity portion 334 of the supply target member 318 while the tip portion of the male screw N is rotationally moved about the head portion of the male screw N toward the tip side in one direction.

Rotational Moving Unit

Next, the rotational moving unit 304 that sequentially supplies the male screws N, which are guided by the guide unit 44, to the moving section 302 while being rotationally moved will be described.

As shown in FIGS. 50 and 51, the rotational moving unit 304 includes a shaft 70 that extends in the orthogonal direction and is rotatably supported by a pair of plate members 338 (see FIG. 49). Meanwhile, the respective portions of the plate members 338 will be appropriately omitted in the drawings so that the structures of other members can be easily understood.

As shown in FIG. 51, one end portion of a bar member 340 is fixed to one end portion of the shaft 70. A projection 340A is formed at one end of the bar member 340. In addition, a coil spring 344 of which one end is mounted on a projection 60D protruding from the side of the guide member 60 of the guide unit 44 and the other end is mounted on the projection 340A is provided. Further, the other end portion of the bar member 340 comes into contact with one end portion of a bar member 346 to be described below due to the biasing force of the coil spring 344.

The intermediate portion of the bar member 346 in the longitudinal direction of the member 346 is rotatably supported by a shaft member 348 that is fixed to one plate member 338 (which is omitted in FIG. 51). Moreover, the other end portion of the bar member 346 comes into contact with a stepped cam face 352 of a cam member 350 that is fixed to the base member 312.

The cam face 352 includes an upper surface 352A that faces upward and extends in one direction, and a side surface 352B that is connected to a tip portion of the upper surface 352A in one direction and is formed so as to face the tip side in one direction by bending the upper surface 352A downward.

In this structure, the other end portion of the bar member 346 comes into contact with the side surface 352B of the cam member 350 when the moving section 302 is disposed at the base end position as shown in FIG. 51. Further, the other end portion of the bar member 340 comes into contact with one end portion of the bar member 346 due to the biasing force of the coil spring 344. In this state, the moving member 66, which is connected to the bar member 340 by the shaft 70, supplies a male screw N, which has come into contact with a tip portion of the moving member 66, to the intermediate member 320 and the rear end portion of the moving member 66 comes into contact with the next male screw N. Accordingly, the moving member 66 is disposed at the supply position where the movement of the next male screw N is stopped.

Meanwhile, when the moving section 302 is disposed at the tip position as shown in FIG. 59, the other end portion of the bar member 346 comes into contact with the upper surface 352A of the cam member 350. Accordingly, the bar member 340, which comes into contact with one end portion of the bar member 346, is rotated together with the shaft 70. Since the shaft 70 is rotated, the moving member 66 is disposed at the suppression position where the tip portion of the moving member 66 comes into contact with the male screw N present in the guide member 60 so that the supply of the male screw N to the intermediate member 320 is suppressed.

Operating Unit

Next, the operating unit 306 that makes the supply unit 316 (moving section 302) move relative to the device body 12 will be described.

As shown in FIGS. 49 and 50, the operating unit 306 includes an L-shaped lever 356 which is disposed below the base member 312 and extends in one direction and of which a base end portion in one direction is bent downward and an L-shaped link 358 that is disposed on the side of the supply unit 316 opposite to the bar member 346.

Lever

The operating unit 306 includes a plate member 360 of which an upper end portion is mounted on the base member 312, and the tip portion of the lever 356 in one direction is rotatably supported by a shaft member 362 that is fixed to the plate member 360. Accordingly, when the base end portion of the lever 356 in one direction is operated by the hand that holds the grip 20, the lever 356 is rotated about the shaft member 362.

Meanwhile, the link 358 is disposed on the side of the plate member 360 opposite to the lever 356, and a bent portion of the link 358 is rotatably supported by a shaft member 364 that is fixed to the plate member 360.

Further, the L-shaped link 358 includes a vertical portion 358A that extends from the bent portion in the vertical direction and a horizontal portion 358B that extends from the bent portion toward the base end side in one direction. A pin 368, which extends in the orthogonal direction, is fixed to the base end portion of the horizontal portion 358B in one direction.

As shown in FIG. 51, a tip portion of the pin 368 is movably received in a long hole 356A that is formed in the lever 356 and extends in one direction.

Meanwhile, as shown in FIG. 50, an upper portion of the vertical portion 358A of the link 358 comes into contact with the outer peripheral surface of a pin 370 of which a base end portion is fixed to the plate member 322 and which extends in the orthogonal direction.

When the lever 356 is not operated (a force is not applied) in this structure, the vertical portion 358A of the link 358 is pressed against the pin 370 of the moving section 302 that is disposed at the base end position due to a biasing force of the coil spring 330. Accordingly, the position of the link 358 is determined, and the position of the lever 356 is determined by the pin 368 and the long hole 356A (see FIG. 51). In this state, the lever 356 is disposed at the initial position of the lever 356 as shown in FIGS. 50 and 51.

Meanwhile, when the worker rotates the lever 356 by grasping the lever 356 with the hand holding the grip 20, the lever 356 is moved to an operating position of the lever 356 as shown in FIG. 58. Moreover, the link 358 is rotated about the shaft member 364 through the pin 368 and the long hole 356A (see FIG. 51). Accordingly, the upper portion of the vertical portion 358A of the link 358 presses the pin 370 toward the tip side in one direction, so that the moving section 302 is moved to the tip side in one direction. As a result, the moving section 302 is disposed at the tip position.

Action

Next, a method of manufacturing a screw-fastened object using the above-mentioned screw fastening device 300 will be described.

First of all, the worker holds the grip 20 of the screw fastening device 300. In this state, the worker does not grasp the lever 356.

Further, as shown in FIG. 49, male screws N are lined up in the guide member 60 in the longitudinal direction of the guide member 60 and the head portions of the male screws N are disposed above the screw portions in the vertical direction.

Since the moving member 66 is disposed at the supply position as shown in FIGS. 50 and 51 in this state, the male screw N supplied to the guide member 60 comes into contact with the rear end portion of the moving member 66 and is stopped at that position.

Next, when the worker grasps the lever 356 while holding the grip 20, the moving section 302 is moved toward the tip side in one direction.

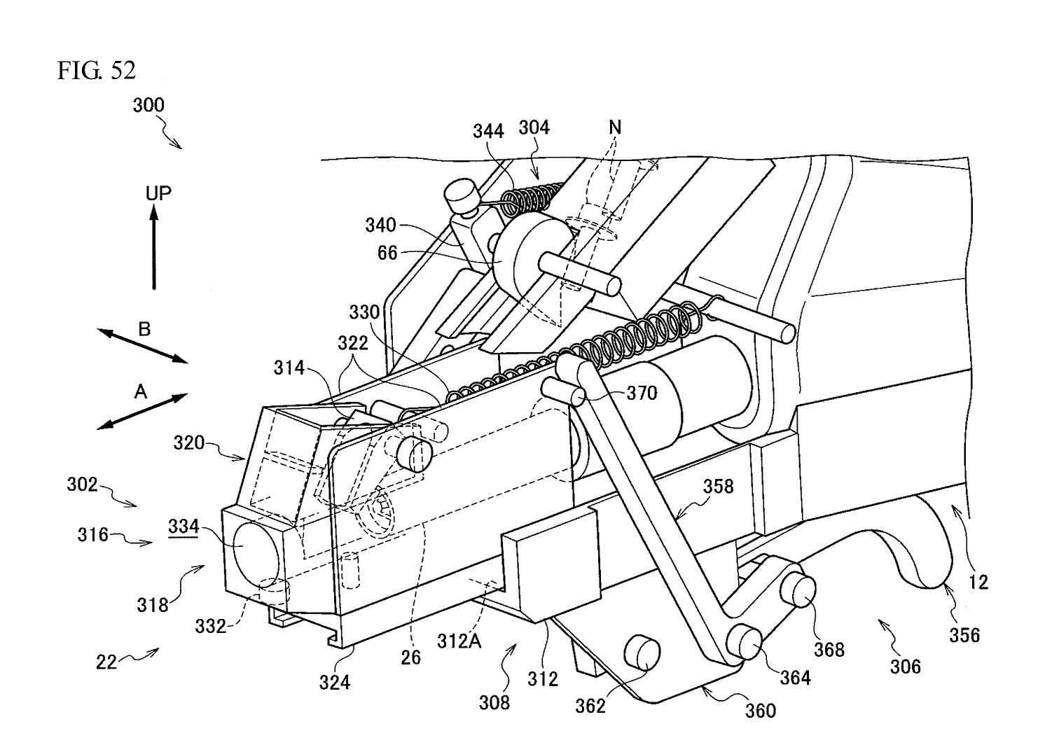

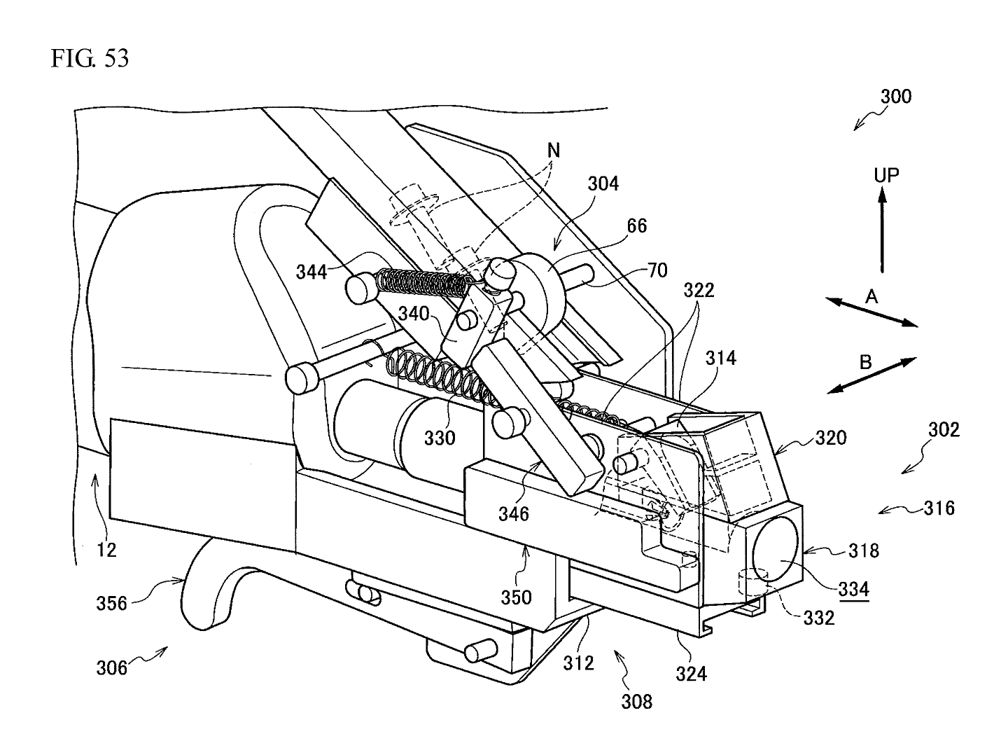

When the moving section 302 is moved toward the tip side in one direction, the cam member 350 is moved as shown in FIG. 53. Accordingly, the other end portion of the bar member 346 having come into contact with the side surface 352B of the cam member 350 comes into contact with the upper surface 352A of the cam member 350. Further, when the bar member 346 and the bar member 340 are rotationally moved, the moving member 66 disposed at the supply position is moved to the suppression position. Accordingly, the male screw N having come into contact with the rear end portion of the moving member 66 is moved to the tip portion of the guide member 60, comes into contact with the tip portion of the moving member 66, and is stopped at that position (see FIG. 52).

Next, when the worker releases the lever 356, the moving section 302 is moved to the base end position on the base end side in one direction (the moving section 302 returns to the base end position).

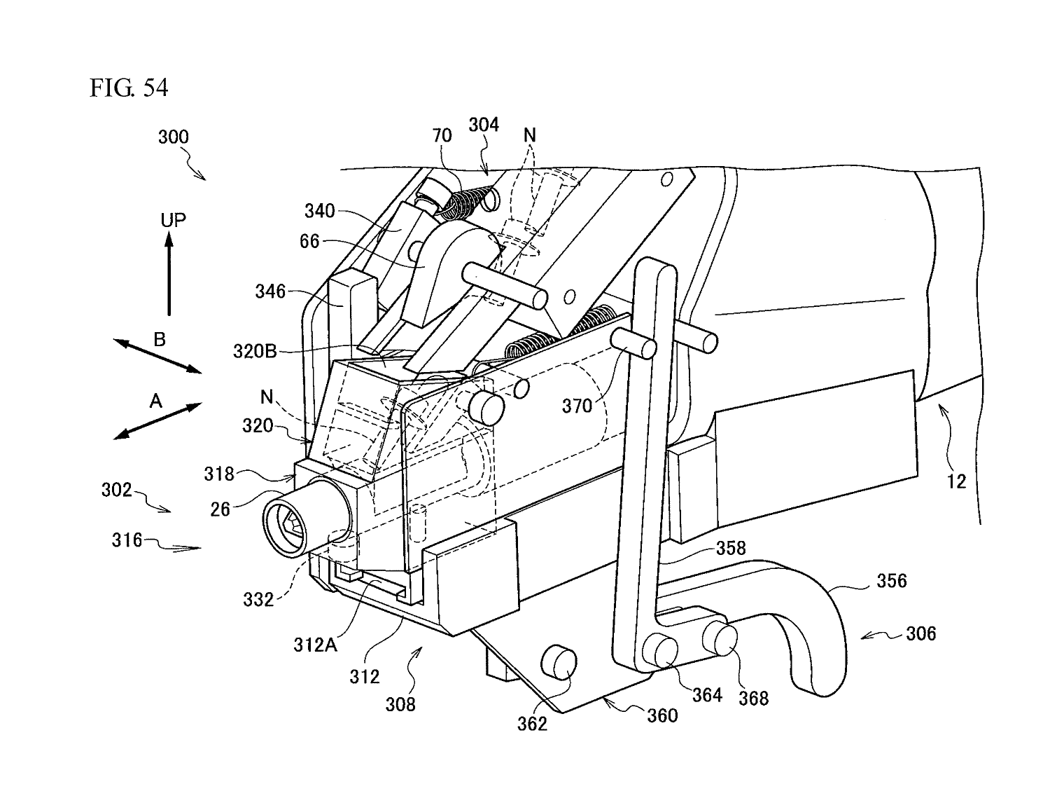

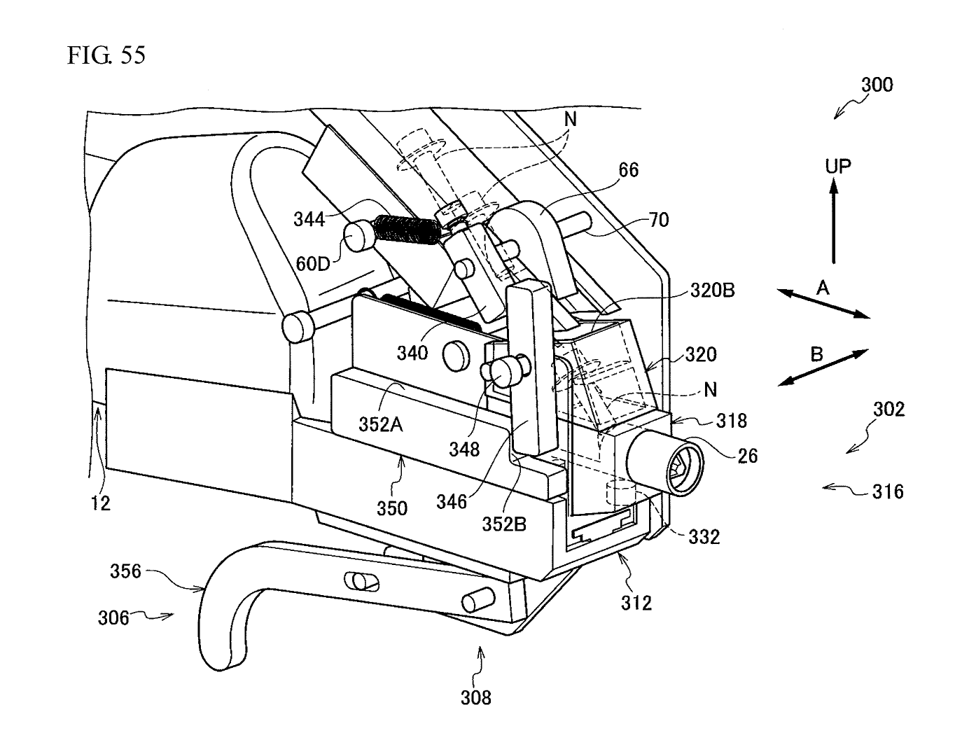

When the moving section 302 is moved to the base end position, the cam member 350 is also moved as shown in FIG. 55. Accordingly, the other end portion of the bar member 346, which has come into contact with the upper surface 352A of the cam member 350, comes into contact with the side surface 352B of the cam member 350. Therefore, the bar member 346 and the bar member 340 are rotationally moved, so that the moving member 66 disposed at the suppression position is moved to the supply position. Accordingly, the male screw N having come into contact with the tip portion of the moving member 66 is supplied to the holding portion 320B of the intermediate member 320, and the rear end portion of the moving member 66 comes into contact with the next male screw N so as to stop the movement of the next male screw N (see FIG. 54).

Meanwhile, when the moving section 302 is disposed at the base end position, the free end portion of the widening-narrowing member 314 comes into contact with the outer peripheral surface of the bit guide 26 and the opening formed of the receiving opening 318A is narrowed. Accordingly, the tip portion of the male screw N supplied to the holding portion 320B comes into contact with the outer peripheral surface of the bit guide 26, which is disposed in the cavity portion 334, through the receiving opening 318A, and the male screw N is held in the holding portion 320B.

Next, when the worker grasps the lever 356 while holding the grip 20, the pin 370 is pressed toward the tip side in one direction by the link 358. Accordingly, the moving section 302 is moved toward the tip side in one direction.

When the moving section 302 is moved toward the tip side in one direction, the cam member 350 is also moved as shown in FIG. 57. Accordingly, the other end portion of the bar member 346, which has come into contact with the side surface 352B of the cam member 350, comes into contact with the upper surface 352A of the cam member 350. Therefore, the bar member 346 and the bar member 340 are rotationally moved, so that the moving member 66 disposed at the supply position is moved to the suppression position.

Accordingly, the male screw N having come into contact with the rear end portion of the moving member 66 is moved to the tip portion of the guide member 60, comes into contact with the tip portion of the moving member 66, and is stopped at that position (see FIG. 56).

In addition, when the worker grasps the lever 356 while holding the grip 20, the pin 370 is pressed toward the tip side in one direction by the link 358. Accordingly, the moving section 302 is moved to the tip position on the tip side in one direction.

When the moving section 302 is moved to the tip position, the receiving opening 318A is disposed closer to the tip side in one direction than the tip portion of the bit guide 26 that is disposed in the cavity portion 334 as shown in FIGS. 58 and 59. Accordingly, the free end portion of the widening-narrowing member 314 is separated from the outer peripheral surface of the bit guide 26 disposed in the cavity portion 334, so that the widening-narrowing member 314 is rotated. Therefore, the opening formed of the receiving opening 318A is widened.

Accordingly, the male screw N held in the holding portion 320B passes through the receiving opening 318A. Here, when the male screw N passes through the receiving opening 318A, the head portion of the male screw N passes through the receiving opening 318A after being caught by the catch portion 321 once (see FIGS. 56 and 57). For this reason, the male screw N is supplied to the cavity portion 334 of the supply target member 318 while the tip portion of the male screw N is rotationally moved about the head portion of the male screw N toward the tip side in one direction. The male screw N, which is being rotated, is disposed so as to extend in one direction by the magnetic force of the magnet 332. Accordingly, the head portion of the male screw N faces the base end side in one direction.

Next, when the worker releases the lever 356 while holding the grip 20, the moving section 302 is moved to the base end position on the base end side in one direction due to the biasing force of the coil spring 330 (the moving section 302 returns to the base end position).

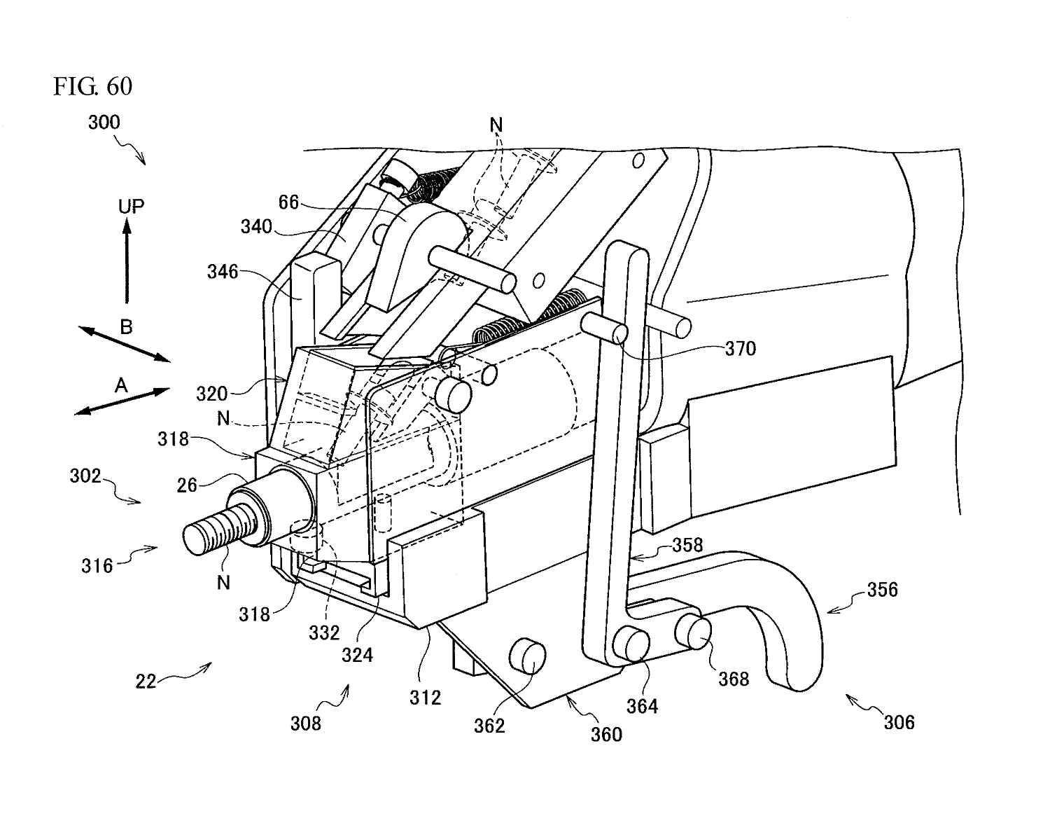

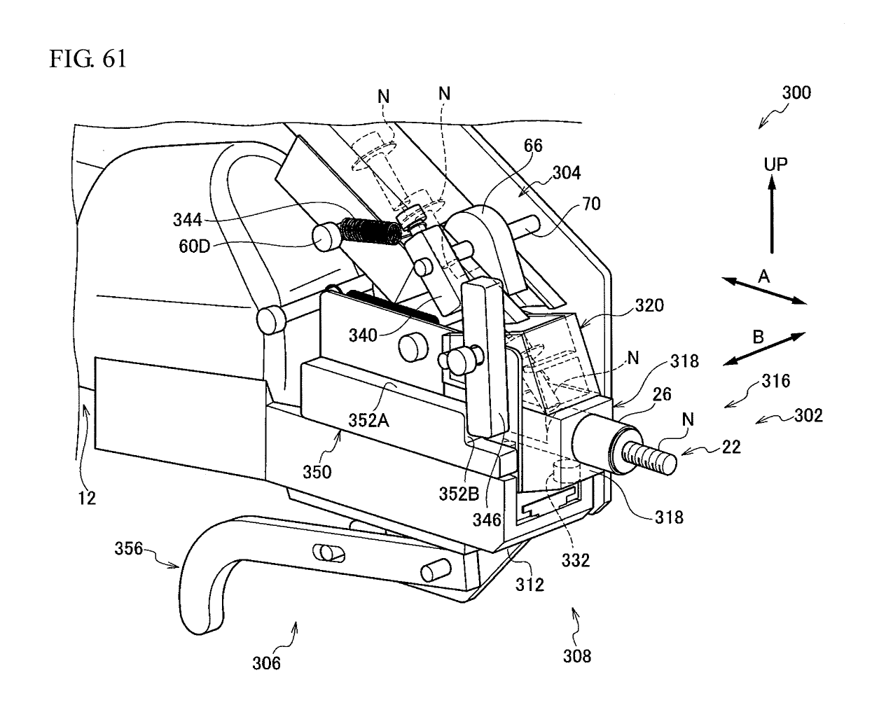

When the moving section 302 is moved to the base end position, the link 358 is pressed toward the base end side in one direction by the pin 370 as shown in FIGS. 60 and 61 and the link 358 is rotated. Accordingly, the lever 356 returns to the initial position.

Further, when the moving section 302 is moved to the base end position, the cam member 350 is also moved. Accordingly, the other end portion of the bar member 346, which has come into contact with the upper surface 352A of the cam member 350, comes into contact with the side surface 352B of the cam member 350. Therefore, the bar member 346 and the bar member 340 are rotationally moved, so that the moving member 66 disposed at the suppression position is moved to the supply position. Accordingly, the male screw N having come into contact with the tip portion of the moving member 66 is supplied to the holding portion 320B of the intermediate member 320, and the rear end portion of the moving member 66 comes into contact with the next male screw N so as to stop the movement of the next male screw N.

Meanwhile, the free end portion of the widening-narrowing member 314 comes into contact with the outer peripheral surface of the bit guide 26 disposed in the cavity portion 334 and the opening formed of the receiving opening 318A is narrowed. Accordingly, the tip portion of the male screw N supplied to the holding portion 320B comes into contact with the outer peripheral surface of the bit guide 26, which is disposed in the cavity portion 334, through the receiving opening 318A, and the male screw N is held in the holding portion 320B.

Meanwhile, when the moving section 302 is moved to the base end position, the male screw N which is supplied to the supply target member 318 and of which the head portion faces the base end side in one direction approaches the tip portion of the bit guide 26.

Further, before the moving section 302 reaches the base end position, the head portion of the male screw N is attracted by the magnetic force of the magnet 34 (see FIG. 50). Accordingly, the flange F formed at the head portion of the male screw N comes into contact with the end face of the tip portion of the bit guide 26. Therefore, the male screw N is held by the bit guide 26, so that the position of the male screw N becomes stable. The male screw N, which comes into contact with the bit guide 26 and of which the position is stable, protrudes from the supply target member 318 toward the tip side in one direction.

Here, since the magnet 34 applies a magnetic force, which is larger than the magnetic force of the magnet 332, to the male screw N supplied to the cavity portion 334 as described above, the male screw N is not separated from the bit guide 26.

When the worker operates the lever 356 while holding the grip 20 in the screw fastening device 300 as described above, the male screw N is supplied to the supply target member 318.

Other actions are the same as those of the first exemplary embodiment.

### Fifth Exemplary Embodiment

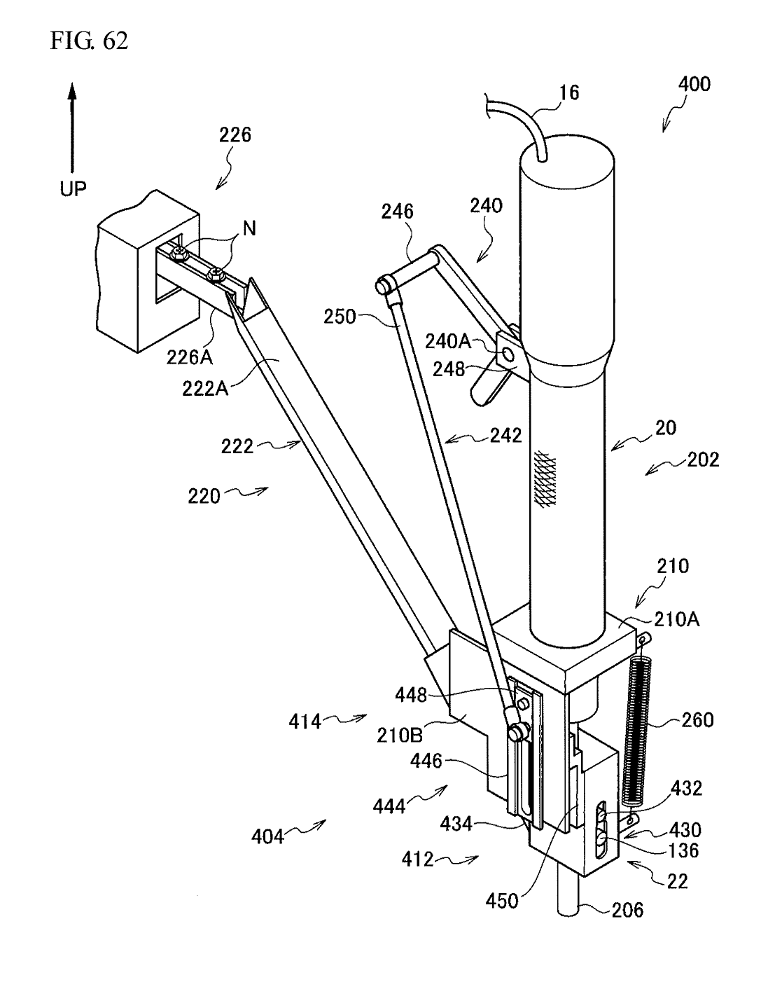

Next, examples of a screw fastening device and a method of manufacturing a screw-fastened object according to a fifth exemplary embodiment of the invention will be described with reference to FIGS. 62 to 66. Meanwhile, the same members as those of the third exemplary embodiment may be denoted by the same reference numerals, and the description thereof may be omitted.

Entire Structure

As shown in FIG. 62, a screw fastening device 400 according to the fifth exemplary embodiment is not a device that is used to screw a male screw N into a target in a horizontal direction but a device that is used to screw a male screw N into a target from above in a vertical direction.

The screw fastening device 400 includes a device body 202 to which an end portion of a power supply cord 16 is fixed and a movable section 404 that is supported so as to be movable relative to the device body 202 in a vertical direction.

Movable Section

Next, the movable section 404, which is supported so as to be movable relative to the device body 202 in the vertical direction, will be described.

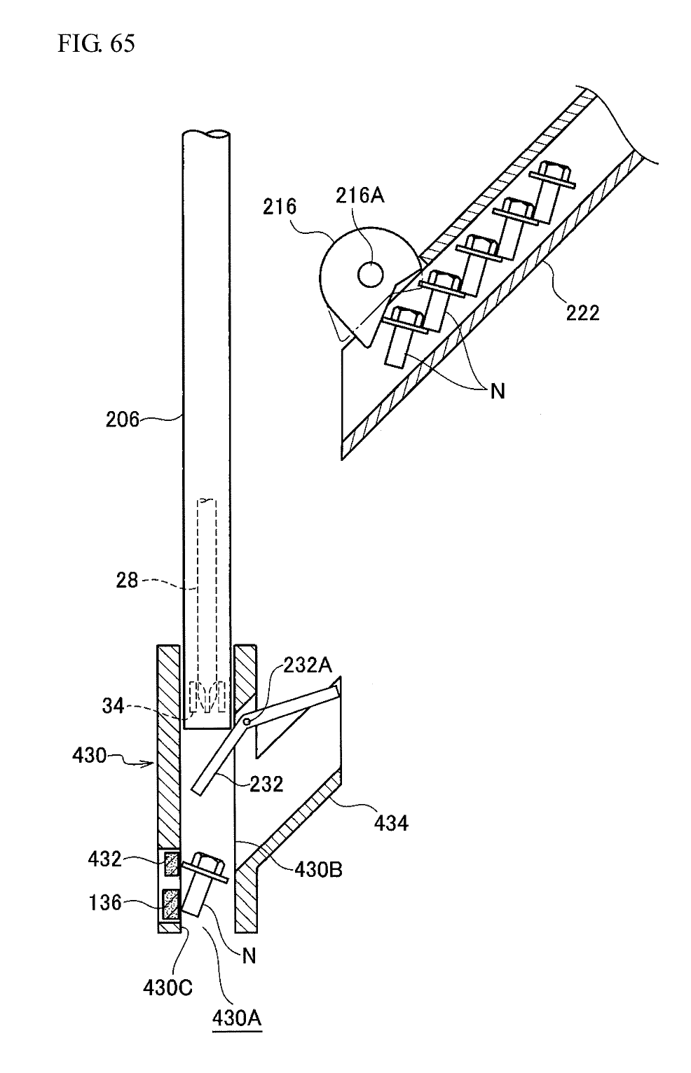

As shown in FIG. 62, the movable section 404 includes a supply unit 412 which is movable relative to the device body 202 in the vertical direction and to which a male screw N to be screwed into a female screw M by a bit 28 (see FIG. 65) is supplied, and an actuator 414 that makes the supply unit 412 move relative to the device body 202.

Supply Unit

As shown in FIGS. 62 and 65, the supply unit 412 includes a supply target member 430 which extends in the vertical direction (one direction) and includes a cavity portion 430A in which the bit guide 206 is disposed.

A receiving portion 430B, through which the cavity portion 430A is opened to the outside and which receives a male screw N to be supplied to the cavity portion 430A, is formed on the side surface of the supply target member 430 as shown in FIG. 65. Further, an intermediate member 434, which extends from the receiving portion 430B toward the tip portion of a guide member 222, is formed integrally with the supply target member 430.

Furthermore, the receiving portion 430B is provided with a partition door 232 that partitions the cavity portion 430A from the outside. The partition door 232 is provided with a pivot pin 232A extending along the shaft 216A, and is a plate-like member that includes a bent portion at an intermediate portion thereof when seen in the axial direction of the pivot pin 232A. Further, the above-mentioned pivot pin 232A is provided at the bent portion of the partition door 232.

Moreover, a magnet 136 as an example of a first magnet, which disposes the male screw N supplied to the cavity portion 430A by a magnetic force so that the male screw N extends in the vertical direction (one direction) and makes the head portion of the male screw N face the upper side in the vertical direction (one side), is provided in a wall portion 430C of the supply target member 430 facing the receiving portion 430B. In addition, a magnet 432, which applies a magnetic force smaller than the magnetic force of the magnet 136 to the male screw N supplied to the cavity portion 430A, is provided above the magnet 136.

Accordingly, the tip portion of the male screw N supplied to the cavity portion 230A is attracted by the magnetic force of the magnet 136 and the head portion of the male screw N is attracted by the magnetic force of the magnet 432, so that the position of the male screw N becomes stable.

Actuator

Next, the actuator 414, which makes the supply unit 412 move relative to the device body 202, will be described.

As shown in FIG. 62, the actuator 414 includes a grip member 240 to which a load is input when the grip member 240 is held by a worker, a link unit 242 that transmits the load input to the grip member 240, and a slide unit 444 that is slid by the load transmitted from the link unit 242 and moves the supply unit 412 along the bit guide 206.

A rail 446 extending in the vertical direction is mounted on the support plate 210B, and the lower end portion of the first link part 250 of the link unit 242 is mounted on a slide member 448 that is movably supported by the rail 446.

Further, the slide member 448 is mounted on the above-mentioned supply target member 430 by a connecting member 450 that is disposed on the side of the support plate 210B opposite to the first link part 250.

Action

Next, a method of manufacturing a screw-fastened object using the above-mentioned screw fastening device 400 will be described.

When the screw fastening device 400 is mounted on a setting jig (not shown) as shown in FIG. 62, the rear end portion of the guide member 222 and the end portion of the male screw supply guide 226A of the male screw supply device 226 face each other. Further, male screws N are supplied to the guide member 222 from the male screw supply device 226.

Since the worker does not hold the grip member 240 in this state as shown in FIG. 62, the supply unit 412 is disposed at the upper end position due to the biasing force of the spring member 260 and the slide member 448 is disposed on the upper end portion of the rail 446. In this state, the intermediate member 434 (see FIG. 65) and the tip portion of the guide member 222 face each other.

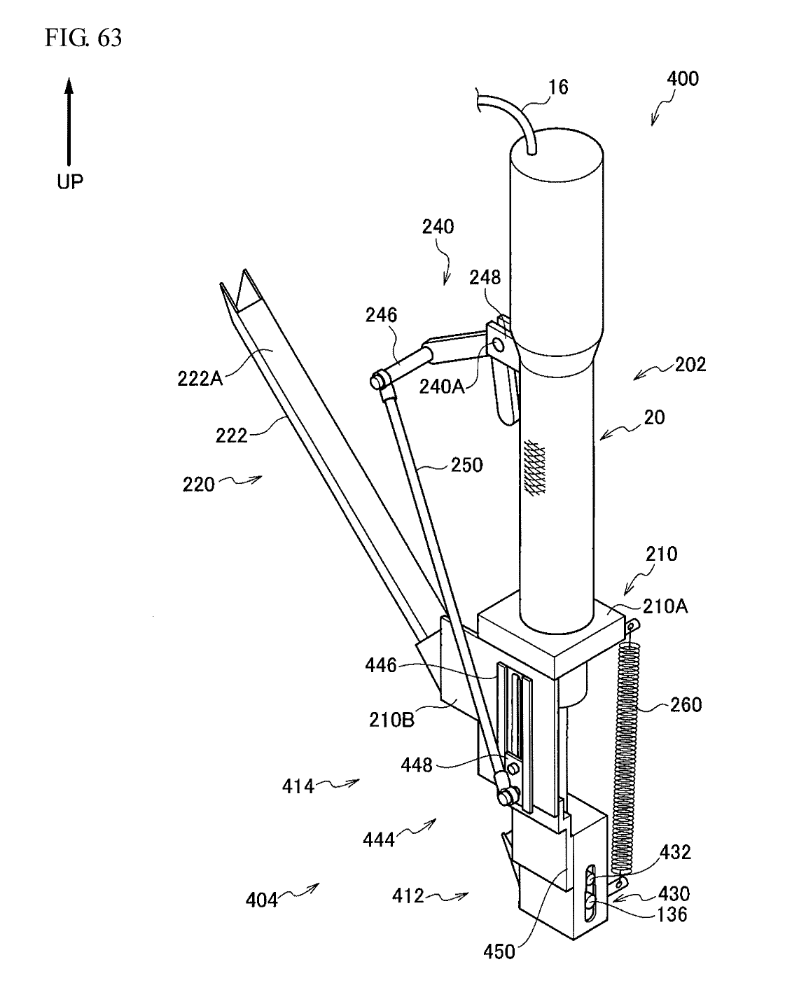

Next, as shown in FIG. 63, the worker holds the grip member 240 with the hand grasping the grip 20 after separating the screw fastening device 400 from the setting jig. When the worker holds the grip member 240, a load is transmitted to the slide member 448 through the first link part 250 and the slide member 448 is moved downward along the rail 446.

Since the supply unit 412 is moved to the lower end position as shown in FIG. 65, a part of the supply target member 430 protrudes downward from the bit guide 206 in the vertical direction. Accordingly, the partition door 232 opens the cavity portion 430A. Since the partition door 232 opens the cavity portion 430A, the male screw N having stopped in front of the receiving portion 430B is supplied to the cavity portion 430A from the receiving portion 430B.

In addition, the tip portion of the male screw N supplied to the cavity portion 430A is attracted by the magnetic force of the magnet 136 and the head portion of the male screw N is attracted by the magnetic force of the magnet 432. Accordingly, the male screw N is disposed so as to extend in the vertical direction (one direction), and the head portion of the male screw N faces the upper side in the vertical direction (one side).

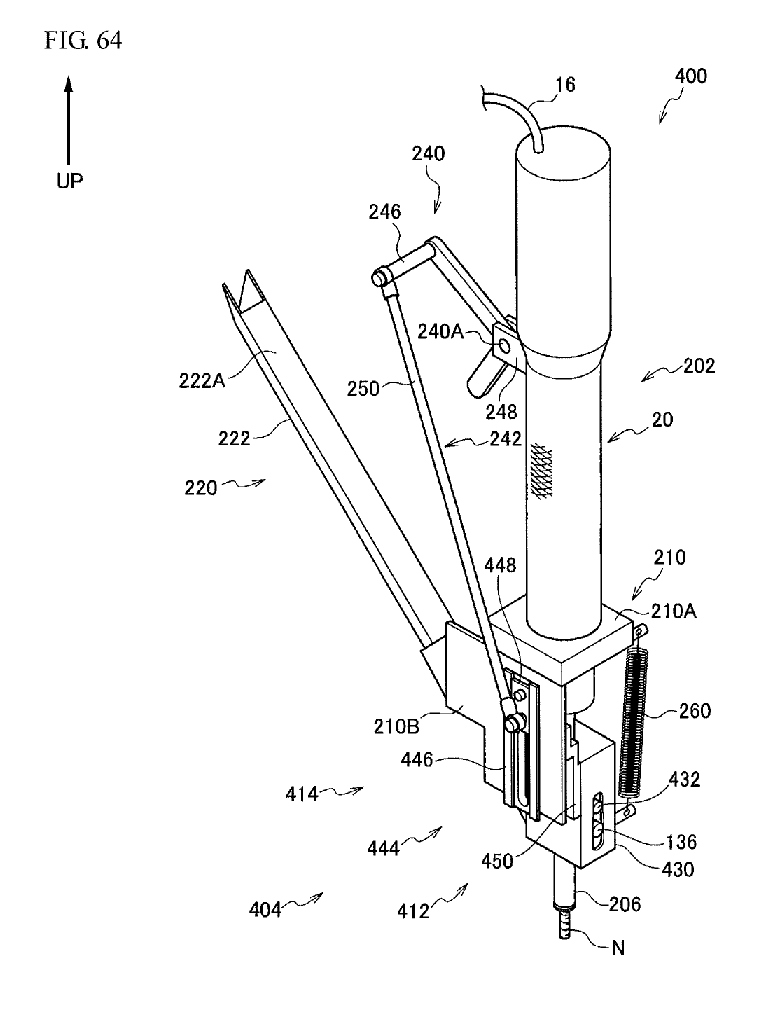

Next, when the worker releases the grip member 240, the supply unit 412 is moved to the upper end position from the lower end position due to the biasing force of the spring member 260 as shown in FIG. 64.

Before the supply unit 412 is moved to the upper end position, the head portion of the male screw N is attracted by the magnetic force of the magnet 34 (see FIG. 65). Accordingly, the flange F formed at the head portion of the male screw N comes into contact with the end face of the tip portion of the bit guide 206, so that the position of the male screw N becomes stable. Further, the tip portion of the male screw N, which comes into contact with the bit guide 206 and of which the position is stable, is exposed to the outside from the lower portion of the supply target member 430.

Other actions are the same as those of the third exemplary embodiment.

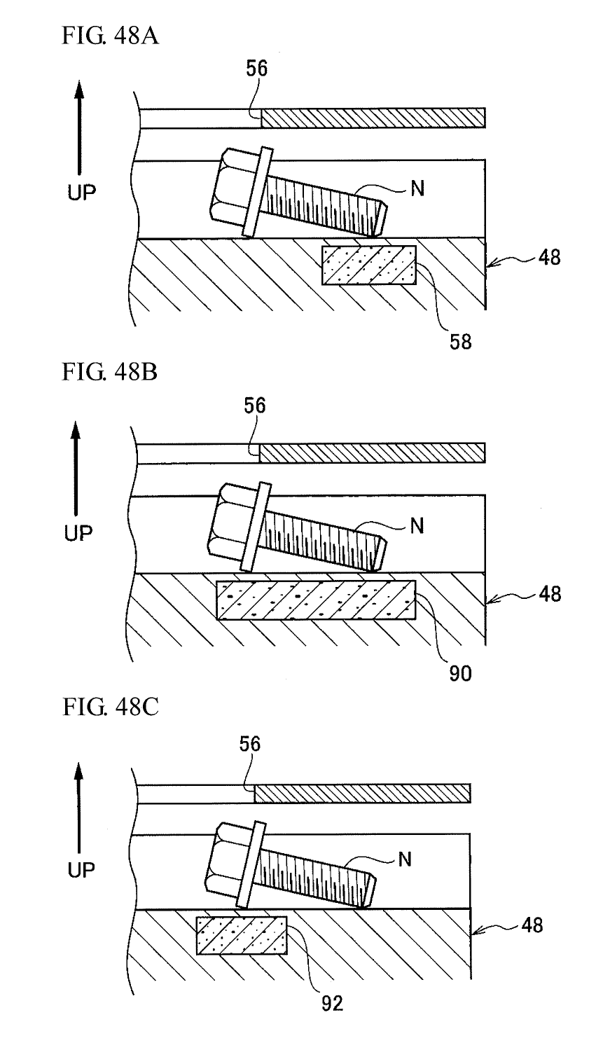

Meanwhile, the invention has been described in detail with reference to the specific exemplary embodiments. However, the invention is not limited to the exemplary embodiments and it is apparent to those skilled in the art that the invention may have various other exemplary embodiments without departing from the scope of the invention. For example, in the first exemplary embodiment, the magnet 58 has been disposed below the screw portion of the male screw N, which is supplied to the supply target member 48, in the vertical direction as shown in FIG. 48A. However, the invention is not limited thereto, and a magnet 90 may be disposed below the entire male screw N, which is supplied to the supply target member 48, in the vertical direction as shown in FIG. 48B. Alternatively, a magnet 92 may be disposed below the head portion of the male screw N, which is supplied to the supply target member 48, in the vertical direction as shown in FIG. 48C.

Meanwhile, a structure where the female screw M is provided in the first member has been described by way of example in the above-mentioned exemplary embodiments. However, burring may be provided instead of the female screw M and a female screw may be formed on the end face of the prepared hole.

Meanwhile, in the above-mentioned exemplary embodiments, the motions of the respective members have been described whenever the positions of the respective members are changed. However, these motions are performed in a series of operations.

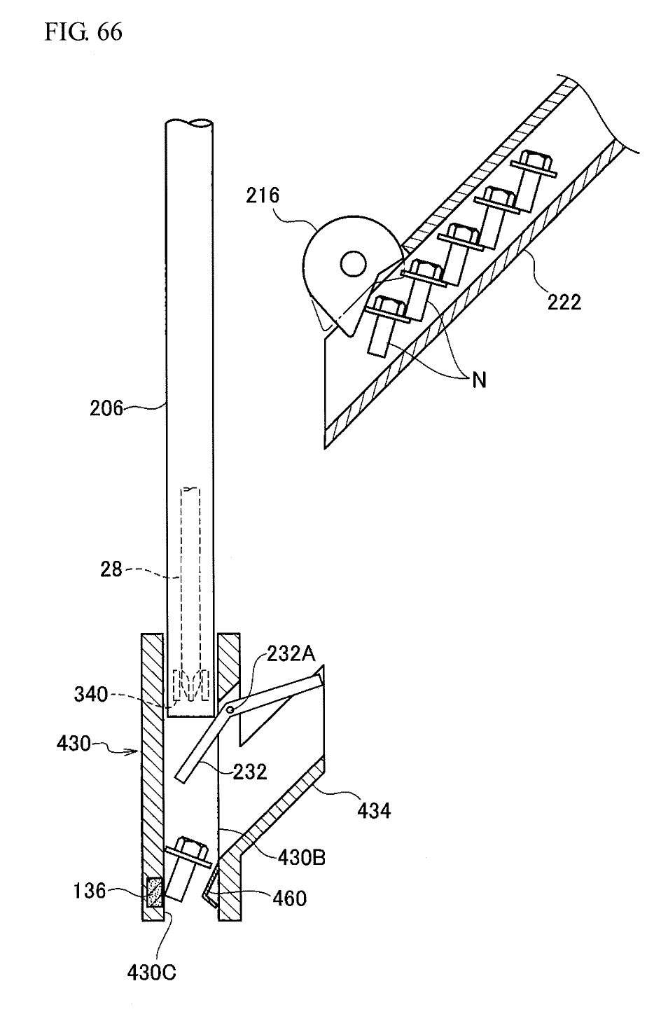

Meanwhile, the magnet 432 has been used in the fifth exemplary embodiment to make the position of the head portion of the male screw N, which is supplied to the cavity portion 430A, stable. However, the magnet 432 dose not need to be particularly used, and a part of the cavity portion 430A may be narrowed by an elastically deformable leaf spring 460 as shown in FIG. 66 in order to make the position of the head portion of the male screw N stable. Further, as described above, the magnet 432 or the leaf spring 460 may be used in the screw fastening devices according to the second and third exemplary embodiments.

What is claimed is:

1. A screw fastening device comprising:
a supply target member which extends in one direction and to which male screws are to be supplied;
a first magnet that positions the male screw supplied to the supply target member by a magnetic force so that the male screw extends in the one direction and makes a head portion of the male screw face one side;
a holding member that is movable relative to the supply target member in the one direction, comprises a second magnet applying a magnetic force, which is larger than a magnetic force of the first magnet, to the male screw that is supplied to the supply target member and disposed so as to extend in the one direction when the holding member moves relative to the supply target member in the one direction so as to be close to the male screw, and holds the male screw by coming into contact with the head portion of the male screw, which is attracted by the magnetic force of the second magnet, while moving relative to the supply target member; and
an applying member that applies torque to the male screw held by the holding member.

2. The screw fastening device according to claim 1, further comprising:
a grip portion that supports the holding member and is to be held by a worker; and
an operating member that is disposed at a base end portion of the applying member and makes the supply target member move relative to the holding member in the one direction by being operated.

3. The screw fastening device according to claim 1, wherein the operating member is to be operated with a hand that holds the grip portion.

4. The screw fastening device according to claim 2, wherein the operating member is to be operated with a hand that holds the grip portion.

5. The screw fastening device according to claim 1, wherein the supply target member is provided with a receiving portion that receives the male screw supplied in a direction oblique to the one direction, and the first magnet is disposed in a wall portion of the supply target member facing the receiving portion.

6. The screw fastening device according to claim 2, wherein the supply target member is provided with a receiving portion that receives the male screw supplied in a direction oblique to the one direction, and the first magnet is disposed in a wall portion of the supply target member facing the receiving portion.

7. The screw fastening device according to claim 5, further comprising: a guide member that guides the male screws toward the receiving portion of the supply target member and is formed to obliquely extend toward the receiving portion,
wherein a lower portion of the cross-section of a guide passage of the guide member, which crosses a longitudinal direction of the guide member, in a vertical direction is narrower than an upper portion of the cross-section of the guide passage in the vertical direction.

8. The screw fastening device according to claim 6, further comprising: a guide member that guides the male screws toward the receiving portion of the supply target member and is formed to obliquely extend toward the receiving portion,
wherein a lower portion of the cross-section of a guide passage of the guide member, which crosses a longitudinal direction of the guide member, in a vertical direction is narrower than an upper portion of the cross-section of the guide passage in the vertical direction.

9. The screw fastening device according to claim 7, wherein the guide member is provided with a moving member that sequentially supplies the male screws to the supply target member by being alternately moved to a first position where the supply of the male screws, which are guided by the guide member through the movement of the holding member relative to the supply target member, to the supply target member is stopped and a second position where the male screws guided by the guide member are supplied to the supply target member.

10. The screw fastening device according to claim 8, wherein the guide member is provided with a moving member that sequentially supplies the male screws to the supply target member by being alternately moved to a first position where the supply of the male screws, which are guided by the guide member through the movement of the holding member relative to the supply target member, to the supply target member is stopped and a second position where the male screws guided by the guide member are supplied to the supply target member.

11. The screw fastening device according to claim 1, wherein a flange, which protrudes in a radial direction of the male screw, is formed at the head portion of the male screw supplied to the supply target member, and
the holding member has a cylindrical shape, and an annular end face of the cylindrical holding member and the flange come into contact with each other.

12. The screw fastening device according to claim 2, wherein a flange, which protrudes in a radial direction of the male screw, is formed at the head portion of the male screw supplied to the supply target member, and
the holding member has a cylindrical shape, and an annular end face of the cylindrical holding member and the flange come into contact with each other.

13. A method of manufacturing a screw-fastened object, the method comprising:
positioning a plate-like second member in which a through hole is formed and a plate-like first member where a female screw is provided so that the through hole of the second member overlaps the female screw of the first member; and
fastening the first member to the second member by screwing a male screw into the female screw through the through hole with the screw fastening device according to claim 1.
